(19) United States
(12) Patent Application Publication
(10) Pub. No.: US 2018/0270815 A1
(43) Pub. Date: Sep. 20, 2018

(54) DYNAMIC PARAMETER ADJUSTMENT FOR LTE COEXISTENCE

(71) Applicant: InterDigital Patent Holdings, Inc., Wilmington, DE (US)

(72) Inventors: Erdem Bala, East Meadow, NY (US); Mihaela C. Beluri, Jericho, NY (US); Debashish Purkayastha, Collegeville, PA (US); Scott Laughlin, Montreal (CA); Martino M. Freda, Laval (CA); Rocco Di Girolamo, Laval (CA); Jean-Louis Gauvreau, La Prairie (CA); Athmane Touag, Chomedey Laval (CA); Joseph M. Murray, Schwenksville, PA (US); David S. Bass, Great Neck, NY (US)

(73) Assignee: InterDigital Patent Holdings, Inc., Wilmington, DE (US)

(21) Appl. No.: 15/920,022

(22) Filed: Mar. 13, 2018

Related U.S. Application Data
(63) Continuation of application No. 13/751,755, filed on Jan. 28, 2013, now abandoned.
(60) Provisional application No. 61/591,250, filed on Jan. 26, 2012.
(60) Provisional application No. 61/603,434, filed on Feb. 27, 2012.
(60) Provisional application No. 61/614,469, filed on Mar. 22, 2012.
(60) Provisional application No. 61/687,947, filed on May 4, 2012.

(51) Int. Cl. H04W 72/04; H04W 16/14; H04J 3/16; H04W 72/12; H04W 52/38

(52) U.S. Cl. CPC H04W 72/0446; H04W 16/14; H04W 52/38; H04W 72/1215; H04J 3/1694

(57) ABSTRACT

Coexistence gaps may permit one radio access technology (RAT) to coexists with another RAT by providing period in which one RAT may be silent and another may transmit. Methods may account for the RAT traffic and for the presence of other secondary users in a channel. Methods may be provided to dynamically change the parameters of a coexistence gap pattern, such as the duty cycle, to adapt to both the RAT traffic and the presence of other secondary users. Methods may include PHY methods, such as synchronization signal (PSS/SSS) based, MIB based, and PDCCH based, MAC CE based methods, and RRC Methods. Measurements may be provided to detect the presence of secondary users, and may include reporting of interference measured during ON and OFF durations, and detection of secondary users based on interference and RSRP/RSRQ measurements.

### CROSS REFERENCE TO RELATED APPLICATIONS

This application claims the benefit of U.S. Provisional Patent Application No. 61/591,250, filed Jan. 26, 2012; U.S. Provisional Patent Application No. 61/603,434, filed Feb. 27, 2012; U.S. Provisional Patent Application No. 61/614,469, filed Mar. 22, 2012 and U.S. Provisional Patent Application No. 61/687,947, filed May 4, 2012 the contents of which are hereby incorporated by reference herein.

### BACKGROUND

Wireless communication systems, such as long-term evolution (LTE) systems may operate in dynamic shared spectrum bands, such as the industrial, scientific, and medical (ISM) radio band or television white space (TVWS). Supplementary Component Carrier (SuppCC) or Supplementary Cell (SuppCell) in the dynamic shared spectrum bands may be used opportunistically to provide wireless coverage and/or wireless traffic offload. For example, a macro cell may provide service continuity, and a small cell, such as a pico cell, femto cell, or remote radio head (RRH) cell may aggregate the licensed and dynamic shared spectrum bands to provide increased bandwidth for a location.

Some dynamic shared spectrum bands may not be able to utilize carrier aggregation procedures, which may prevent wireless communication technologies, such as LTE, from operating in the dynamic shared spectrum bands. This may be due to, for example, the availability of channels, coexistence requirements with other secondary users of the dynamic shared spectrum bands, regulatory rules imposed for operation on dynamic shared spectrum bands where primary users have priority access, or the like.

### SUMMARY OF THE INVENTION

Described herein are methods and apparatus that may enable a wireless communication system, such as long-term evolution (LTE), that may be operating in an dynamic shared spectrum, such as the industrial, scientific, and medical (ISM) radio band or television white space (TVWS), to coexist with other secondary users that may access the dynamic shared spectrum bands.

A method for using a shared channel in a dynamic shared spectrum may be provided. A coexistence pattern may be determined. The coexistence pattern may include a coexistence gap that may enable a first radio access technology (RAT) and a second RAT to operate in a channel of a dynamic shared spectrum. A signal may be sent in the channel via the first RAT based on the coexistence pattern.

A method for using a shared channel in a dynamic shared spectrum may be provided. It may be determined whether a channel may be available during a coexistence gap. The coexistence gap may enables a first RAT and a second RAT to operate in a channel of a dynamic shared spectrum. A packet duration to minimize interference to the first RAT may be determined. A packet based on the packet duration may be sent in the channel using the second RAT when the channel may available.

A method for adjusting a coexistence pattern may be provided. A traffic load in a channel of a dynamic shared spectrum band for a first RAT may be determined. An operational mode indicating whether the second RAT is operating on the channel may be determined. A coexistence gap pattern that may enable the first RAT and a second RAT to operate in the channel of a dynamic shared spectrum band may be determined. A duty cycle for the coexistence gap pattern may be set using at least one of the traffic load, the operational mode, or the coexistence gap.

A method for using a shared channel in a dynamic shared spectrum may be provided. A coexistence pattern may be determined. The coexistence pattern may include a coexistence gap that enables a first RAT and a second RAT to operate in a channel of a dynamic shared spectrum band may be determined. The coexistence pattern may be sent to a wireless transmit/receive unit (WTRU). A signal may be sent in the channel via the first RAT during a time period outside of the coexistence gap.

A method for using a shared channel in a dynamic shared spectrum may be provided. A time-division duplex uplink/downlink (TDD UL/DL) configuration may be selected. One or more multicast/broadcast single frequency network (MBSFN) subframes may be determined from downlink (DL) subframes of the TDD UL/DL configuration. One or more non-scheduled uplink (UL) subframes may be determined from the uplink (UL) subframes of the TDD UL/DL configuration. A coexistence gap may be generated using the one or more non-scheduled UL subframes and the MBSFN subframes. The coexistence gap may enable a first RAT and a second RAT to coexist in a channel of a dynamic shared spectrum.

A wireless transmit/receive unit (WTRU) for sharing a channel in a dynamic shared spectrum band may be provided. The WTRU may include a processor that may be configured to receive a coexistence pattern, the coexistence pattern may include a coexistence gap that enables a first RAT a second RAT to operate in a channel of a dynamic shared spectrum band, and send a signal in the channel via the first RAT based on the coexistence pattern.

An access point for using a shared channel in a dynamic shared spectrum may be provided. The access point may include a processor that may be configured to determine whether a channel may be available during a coexistence gap that enables a first RAT and a second RAT to operate in a channel of a dynamic shared spectrum. The processor may be configured to determine a packet duration to minimize interference to the first RAT. The processor may be configured to send a packet based on the packet duration in the channel using the second RAT when the channel is available.

An enhanced node-B (eNode-B) for adjusting a coexistence pattern may be provided. The eNode-B may include a processor. The eNode-B may determine traffic load in a channel of a dynamic shared spectrum band for a first RAT. The eNode-B may determine an operational mode indicating whether the second RAT is operating on the channel. The eNode-B may determine a coexistence gap pattern that enables the first RAT and a second RAT to operate in the channel of a dynamic shared spectrum band. The eNode-B may set a duty cycle for the coexistence gap pattern using at least one of the traffic load, the operational mode, or the coexistence gap.

A WTRU may be provided for using a shared channel in a dynamic shared. The WTRU may include a processor that may be configured to receive a coexistence pattern. The coexistence pattern may include a coexistence gap that may enable a first RAT and a second RAT to operate in a channel of a dynamic shared spectrum band. The processor may be configured to send a signal in the channel via the first RAT during a time period outside of the coexistence gap.

A WTRU for using a shared channel in a dynamic shared spectrum may be provided. The WTRU may include a processor. The processor may be configured to receive a duty cycle, and select a time-division duplex uplink/downlink (TDD UL/DL) configuration using the duty cycle. The processor may be configured to determine one or more multicast/broadcast single frequency network (MBSFN) subframes from downlink (DL) subframes of the TDD UL/DL configuration, and determine one or more non-scheduled uplink (UL) subframes from the uplink (UL) subframes of the TDD UL/DL configuration. The processor may be configured to determine a coexistence gap using the one or more non-scheduled UL subframes and the MBSFN subframes that may enable a first RAT and a second RAT to coexist in a channel of a dynamic shared spectrum.

### BRIEF DESCRIPTION OF THE DRAWINGS

A more detailed understanding may be had from the following description, given by way of example in conjunction with the accompanying drawings.

FIG. 1A is a system diagram of an example communications system in which one or more disclosed embodiments may be implemented.

FIG. 1B is a system diagram of an example wireless transmit/receive unit (WTRU) that may be used within the communications system illustrated in FIG. 1A.

FIG. 1C is a system diagram of an example radio access network and an example core network that may be used within the communications system illustrated in FIG. 1A.

FIG. 1D is a system diagram of another example radio access network and another example core network that may be used within the communications system illustrated in FIG. 1A.

FIG. 1E is a system diagram of another example radio access network and another example core network that may be used within the communications system illustrated in FIG. 1A.

FIG. 2 depicts an example of coexistence interference within a wireless transmit/receive unit (WTRU).

FIG. 3 depicts an example of discontinuous reception (DRX) that may be configured by an eNB to enable time division multiplexing (TDM).

FIG. 4 depicts an example of handling a Wi-Fi beacon.

FIG. 5 depicts an example of a periodic gap pattern that may be used for secondary user coexistence.

FIG. 6 depicts an example periodic gap pattern that may be used for a downlink (DL) mode of operation in a dynamic shared spectrum band.

FIG. 7 depicts an example periodic gap pattern for a downlink (DL)/uplink (UL) mode of operation in a dynamic shared spectrum band.

FIG. 8 depicts examples of coexistence gaps that may be used for LTE/Wi-Fi coexistence.

FIG. 9 depicts simulation of LTE and Wi-Fi throughputs vs. gap duration.

FIG. 10 depicts an example block diagram of a coexistence pattern control device.

FIG. 11 depicts an example flow diagram for duty cycle adjustment where Wi-Fi load estimation may not be available.

FIG. 12 depicts an example flow diagram for a duty cycle adjustment where Wi-Fi load estimation may be available.

FIG. 13 depicts an example of eNode-B (eNB)/home eNB (HeNB) Duty Cycle Signaling.

FIG. 14 depicts example primary synchronization signal (PSS)/secondary synchronization signal (SSS) permutations for signaling a duty cycle.

FIG. 15 depicts example duty cycle signaling using PSS and SSS.

FIG. 16 depicts a duty cycle change example using a machine access control (MAC) control element (CE).

FIG. 17 depicts a duty cycle change example using radio resource control (RRC) reconfiguration messaging.

FIG. 18 depicts an example of interference levels during the LTE ON and OFF periods.

FIG. 19 depicts a simulation model.

FIG. 20 depicts an example graph of the cumulative distribution function (CDF) of the interference.

FIG. 21 shows an example of secondary user coexistence with two cooperating LTE transmitters.

FIG. 22 depicts an example detection of a secondary network.

FIG. 23 depicts an example flow chart of a secondary user (SU) detection.

FIG. 24 is an example of a SU detection embodiment.

FIG. 25 depicts example packet transmissions for various traffic types.

FIG. 26 depicts an example of an averaged interference level for different traffic types.

FIG. 27 depicts an example use of an RRC reconfiguration message.

FIG. 28 depicts an example downlink (DL)/uplink (UL)/coexistence gap (CG) pattern that may be with listen before talk (LBT).

FIG. 29 depicts an example DL to UL switch that may without LBT.

FIG. 30 depicts an example UL to DL switch that may be without LBT.

FIG. 31 depicts an example dynamic aperiodic coexistence pattern for frequency division duplex (FDD) DL.

FIG. 32 depicts an example scenario with CG inserted after a UL burst and before a DL burst.

FIG. 33 depicts an example state machine for (H)eNB processing.

FIG. 34 depicts example flow charts of processing while in a DL transmission state.

FIG. 35 depicts example flow charts of processing while in a UL transmission state.

FIG. 36 depicts example flow charts of processing while in a clear channel assessment (CCA) state.

FIG. 37 depicts an example decision of transmission mode.

FIG. 38 depicts example measurements that may be based on a channel access mechanism.

FIG. 39 depicts an example flow diagram for measurements that may be based on channel access.

FIG. 40 depicts a number of carrier aggregation types.

FIG. 41 depicts a diagram illustrating a representative frequency division dupSlex (FDD) frame format.

FIG. 42 depicts a diagram illustrating representative time division duplex (TDD) frame format.

FIG. 43 depicts an example of physical hybrid ARQ Indicator Chanel (PHICH) group modulation and mapping.

FIG. 44 depicts a coexistence gap that may be used to replace a TDD GP.

FIG. 45 depicts a TDD UL/DL configuration 4 that may use an extended special subframe.

FIG. 46 depicts a coexistence frame where a coexistence gap may be configured over multiple frames.

FIG. 47 depicts a coexistence gap pattern for a 90% duty cycle.

FIG. 48 depicts a coexistence gap pattern for a 80% duty cycle.

FIG. 49 depicts a coexistence gap pattern for a 50% duty cycle.

FIG. 50 depicts a coexistence gap pattern for a 40% duty cycle.

FIG. 51 depicts a high duty cycle gap pattern for TDD UL/DL Configuration 1.

FIG. 52 depicts a medium duty cycle gap pattern for TDD UL/DL Configuration 1.

FIG. 53 depicts a high duty cycle gap pattern for TDD UL/DL Configuration 2.

FIG. 54 depicts a medium duty cycle gap pattern for TDD UL/DL Configuration 2.

FIG. 55 depicts a high duty cycle gap pattern for TDD UL/DL Configuration 3.

FIG. 56 depicts a medium duty cycle gap pattern for TDD UL/DL Configuration 3.

FIG. 57 depicts a high duty cycle gap pattern for TDD UL/DL Configuration 4.

FIG. 58 depicts a medium duty cycle gap pattern for TDD UL/DL Configuration 4.

FIG. 59 depicts a high duty cycle gap pattern for TDD UL/DL Configuration 5.

FIG. 60 depicts a medium duty cycle gap pattern for TDD UL/DL Configuration 5.

FIG. 61 depicts a high duty cycle gap pattern for TDD UL/DL Configuration 0.

FIG. 62 depicts a medium duty cycle gap pattern for TDD UL/DL Configuration 0.

FIG. 63 depicts another medium duty cycle gap pattern for TDD UL/DL Configuration 0.

FIG. 64 depicts another medium duty cycle gap pattern for TDD UL/DL Configuration 0.

FIG. 65 depicts a medium duty cycle gap pattern for TDD UL/DL Configuration 0 where there may not be a change in DL HARQ timing.

FIG. 66 depicts a medium duty cycle gap pattern for TDD UL/DL Configuration 0 where DL HARQ timing may be frame dependent.

FIG. 67 depicts a high duty cycle gap pattern for TDD UL/DL Configuration 6.

FIG. 68 depicts a medium duty cycle gap pattern for TDD UL/DL Configuration 6 where there may not be a change in DL HARQ timing.

FIG. 69 depicts another medium duty cycle gap pattern for TTD UL/DL Configuration 6.

FIG. 70 depicts a medium duty cycle configuration for TDD UL/DL Configuration 6 where there may not be a change in DL HARQ timing.

FIG. 71 depicts a medium duty cycle configuration for TDD UL/DL Configuration 6 where DL HARQ timing may be frame dependent.

FIG. 72 depicts interference on a control channel from Wi-Fi.

FIG. 73 depicts coded PHICH that may be repeated over two PHICH groups.

FIG. 74 depicts increase coding of PHICH, which may use a 24-symbol scrambling code.

FIG. 75 depicts increasing PHICH robustness using two orthogonal codes per UE.

FIG. 76 depicts a preconfigured PDCCH that may be used for a TDD UL/DL configuration.

FIG. 77 depicts a reference signal that may be used to force Wi-Fi off a channel.

FIG. 78 depicts an example block diagram of a Wi-Fi OFDM physical (PHY) transceiver and receiver.

FIG. 79 depicts an example flow diagram for interleaver configuration.

FIG. 80 depicts another example flow diagram for interleaver configurations.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

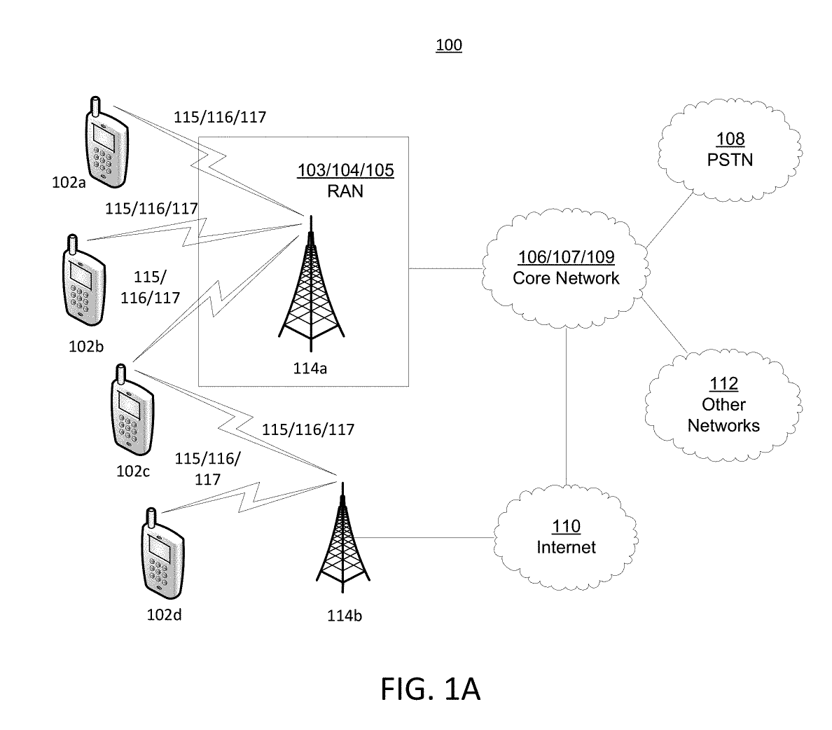

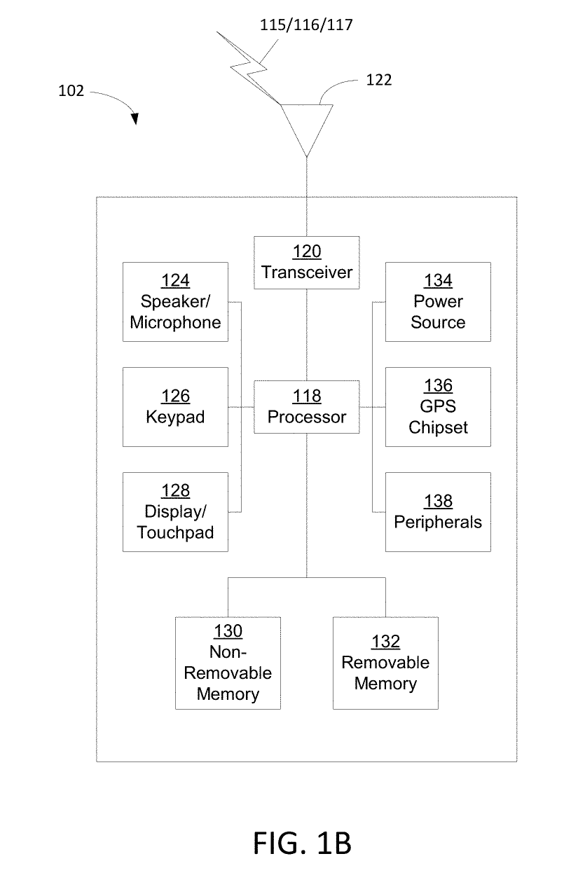

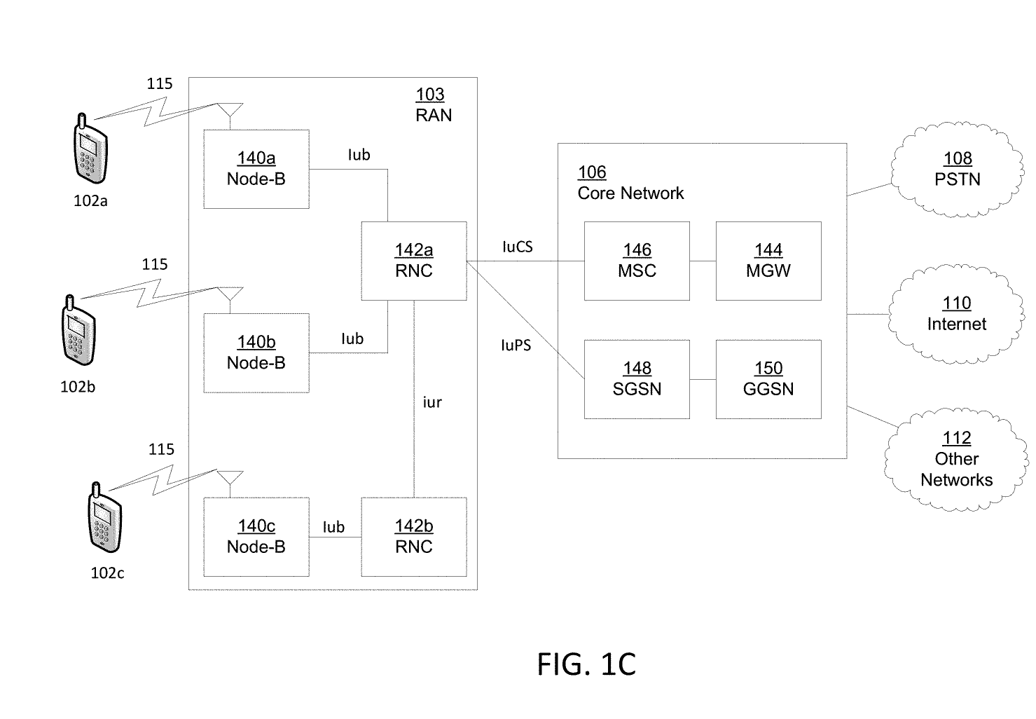

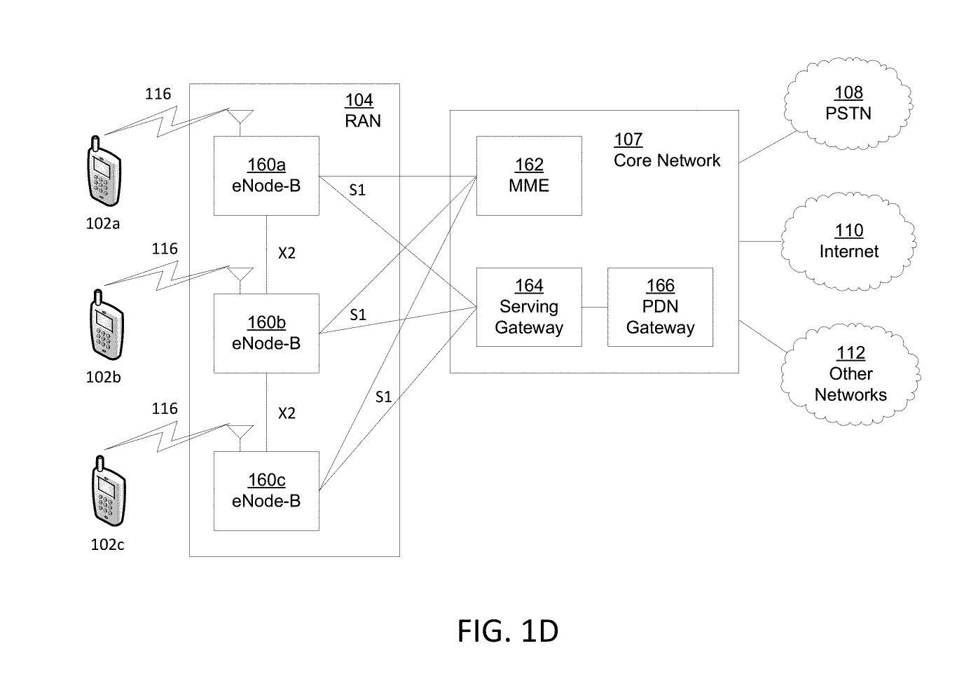

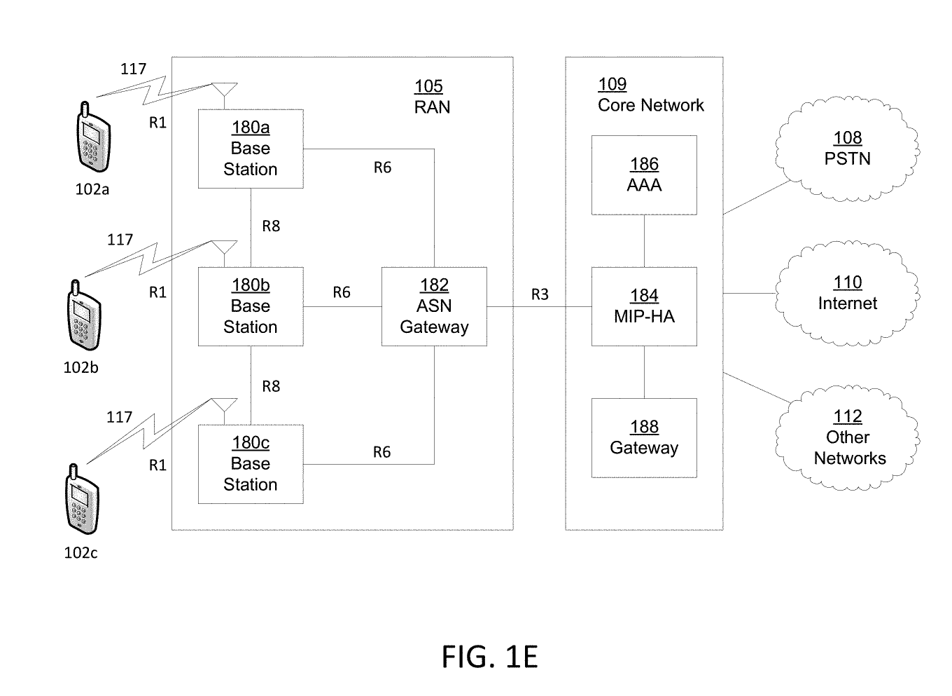

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining includeent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining includeent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 1C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining includeent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining includeent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 1D, the eNode-Bs 160a, 160b, 160c may communicate with one another over an X2 interface.

The core network 107 shown in FIG. 1D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 1E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 1E, the RAN 105 may include base stations 180a, 180b, 180c, and an ASN gateway 182, though it will be appreciated that the RAN 105 may include any number of base stations and ASN gateways while remaining includeent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 1E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 1E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks

A component carrier may operate in a dynamic shared spectrum. For example, a Supplementary Component Carrier (SuppCC) or Supplementary Cell (SuppCell) may operate in a dynamic shared spectrum band. A SuppCC may be used opportunistically in a dynamic shared spectrum band to provide wireless coverage and/or wireless traffic offload. The network architecture may include of a macro cell providing service continuity, and a pico cell, femotocell, remote radio head (RRH) cell, or the like that may aggregate the licensed and dynamic shared spectrum band to provide additional bandwidth for a location.

Carrier aggregation (CA) may accommodate the properties of a dynamic shared spectrum band. For example, LTE operations may change according to the availability of channels in a dynamic shared spectrum band, secondary users of the dynamic shared spectrum bands, regulatory rules imposed for operation on the dynamic shared spectrum band where primary users may have priority access, or the like. To accommodate the properties of a dynamic shared spectrum band, a supplementary component carrier (SuppCC) or supplementary cell (SuppCell) may operate in the dynamic shared spectrum band. The SuppCC or the SuppCell may provide support similar to that of a secondary cell in LTE for a set of channels, features, functionality, or the like.

Supplementary component carriers that may make up a supplementary cell may differ from a secondary component carrier. A SuppCC may operate on channels in dynamic shared spectrum bands. Availability of the channels in the dynamic shared spectrum band may be random. Quality of the channels may not be guaranteed as other secondary users may also be present on this band and these secondary users may be using a different radio access technology. The cells may be used by the SuppCC may not be Release 10 (R10) backward compatible and UEs may not be requested to camp on the supplementary cell. A supplementary cell may be available in B MHz slices. For example, in North America, the TVWS channel may be 6 MHz, which may allow support of a 5 MHz LTE carrier per channel such that B may be 5 MHz. Frequency separation between component carriers in aggregated supplementary cells may be random, may be low, and may depend on a number of factors such as availability of TVWS channels, capabilities of devices, sharing policies between neighbor systems, or the like.

Wireless communications systems may coexist with secondary users, which may be other wireless communication systems such as Wi-Fi systems. When an LTE system operates in a dynamic shared spectrum band, the same spectrum may be shared with other secondary users, which may use a different radio access technology. For example, embodiments described herein, may enable LTE to operate in a dynamic shared spectrum band and coexist with a different radio access technology, such as Wi-Fi.

The 802.11 MAC may supports two modes of operation: the point coordination function (PCF), which may not be used widely in commercial products, and the distributed coordination function (DCF). The PCF may provide contention-free access, whereas the DCF may use carrier sense multiple access with a collision avoidance (CSMA/CA) mechanism for contention-based access. The CSMA may employ clear channel assessment (CCA) techniques for channel access. The CSMA may use a preamble detection to detect other Wi-Fi transmissions, and if the preamble portion was missed, it may use energy measurement to assess channel availability. For example, for a 20 MHz channel bandwidth, CCA may use a threshold of −82 dBm for midamble detection (i.e. Wi-Fi detection) and a threshold of −62 dBm for non-Wi-Fi detection.

In infrastructure networks, access points may periodically send beacons. The beacon may be set to an interval, such as 100 ms. In ad hoc networks, one of the peer stations may assume the responsibility for sending the beacon. After receiving a beacon frame, a station may wait for the beacon interval and may send a beacon if another station does not do so after a time delay. A beacon frame may be fifty bytes long and about half of that may be a for a common frame header and a cyclic redundancy checking (CRC) field. There may not be reservations for sending beacons and the beacons may be sent using the 802.11 CSMA/CA algorithm. The time between beacons may be longer than the beacon interval; however, stations may compensate for this by utilizing a timestamp found within the beacon.

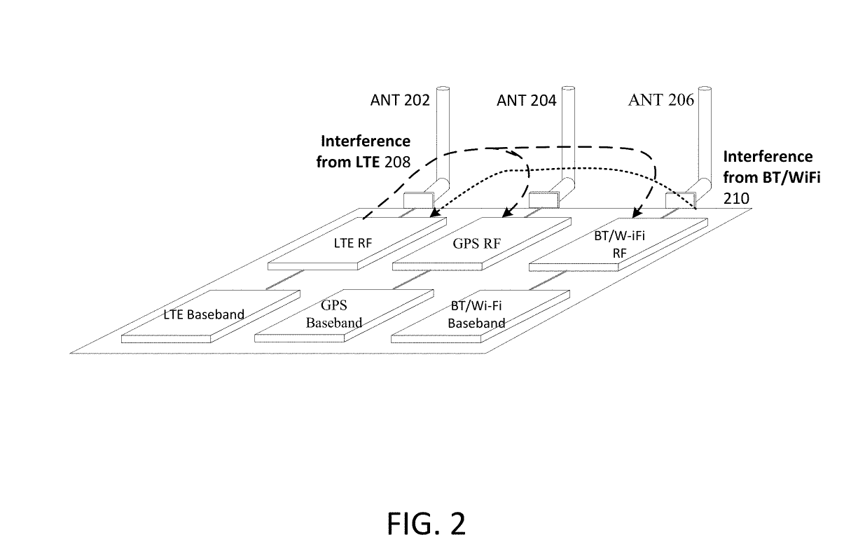

In-device coexistence (IDC) may be provided. FIG. 2 depicts an example of coexistence interference within a wireless transmit/receive unit (WTRU). As shown in FIG. 2, interference may occur when supporting multiple radio transceivers, such as ANT 202, ANT 204, and ANT 206, that may be in the same UE. For example, a UE may be equipped with LTE, Bluetooth (BT), and Wi-Fi transceivers. When operating, a transmitter, such as ANT 202, may create interference to one or more receivers, such as ANT 204 and ANT 206, that may be operating in other technologies. This may occur even though the filter rejection for the individual transceivers may meet the requirements, the requirements may not account for the transceivers that may be collocated on the same device.

As shown in FIG. 2, a number of coexistence scenarios may occur. For example, an LTE Band 40 radio Tx may cause interference to ISM radio Rx, an ISM radio Tx may cause interference to LTE Band 40 radio Rx, an LTE Band 7 radio Tx may cause interference to ISM radio Rx, a LTE Band 7/13/14 radio Tx may cause interference to GNSS radio Rx, or the like.

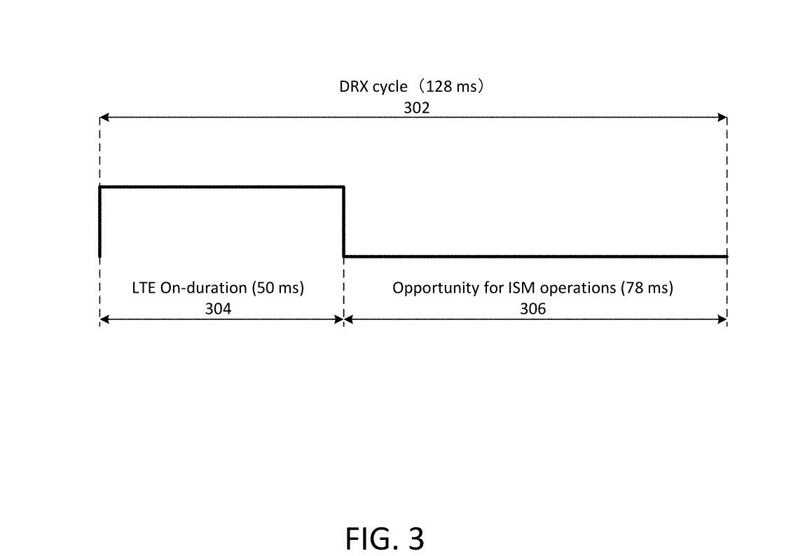

FIG. 3 depicts an example of discontinuous reception (DRX) that may be configured by an eNB to enable time division multiplexing (TDM). Discontinuous reception (DRX) may be used to address self-interference by enabling time division multiplexing (TDM) between radio access technologies. As shown in FIG. 3, for a DRX cycle 302, at 304, LTE may be on for a period, and at 306, LTE may be off for a period to provide an opportunity for another radio access technology, such as ISMs. The on and off cycles may vary in length. For example, LTE may be on for 50 ms at 304, and ISM operations may occur for 78 ms at 306.

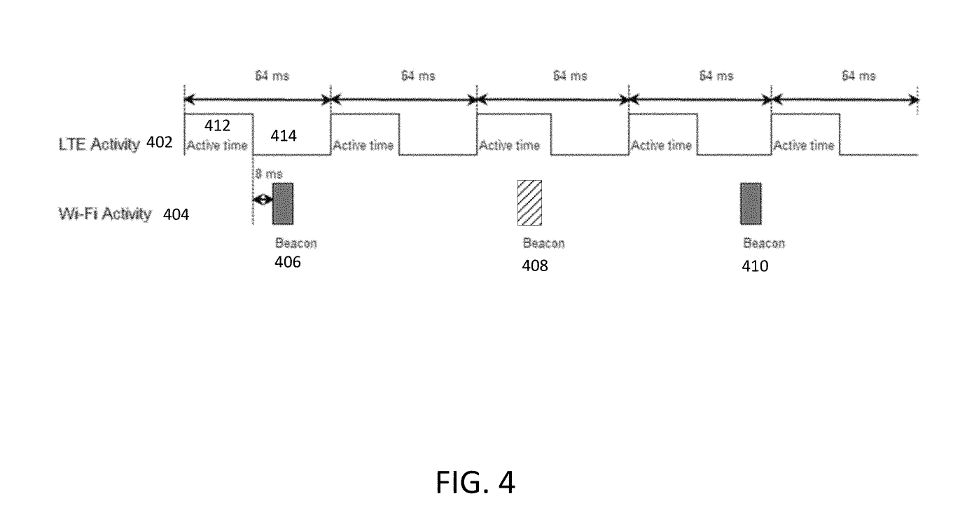

FIG. 4 depicts an example of handling a Wi-Fi beacon. As shown in FIG. 4, a UE based DRX type patterns may be used to enable a UE to receive a Wi-Fi beacon. For example, LTE activity 402 may have an active time, such as at 412, and a non-active time, such as 414. During a non-active time, Wi-Fi activity 404 may occur. For example, beacon 406, beacon 408, and/or beacon 410 may occur during a non-active time.

LTE measurements may be provided. For example, measurements such as reference signal received power (RSRP), reference signal received quality (RSRQ), and received signal strength indicator (RSSI) may be provided. RSRP may be the linear average over the power contributions (in [W]) of the resource elements that may carry cell-specific reference signals within a considered measurement frequency bandwidth. RSRQ may be a ratio N×RSRP/(E-UTRA carrier RSSI), where N may be the number of RB's of the E-UTRA carrier RSSI measurement bandwidth. The measurements in the numerator and denominator may be made over the same set of resource blocks. E-UTRA Carrier RSSI may include a linear average of a total received power (in [W]) observed in orthogonal frequency division multiplex (OFDM) symbols that may include reference symbols for antenna port 0, in the measurement bandwidth, over N number of resource blocks by the UE from sources, including co-channel serving and non-serving cells, adjacent channel interference, thermal noise, or the like. If higher-layer signalling indicates subframes may be used for performing RSRQ measurements, then RSSI may be measured over OFDM symbols in the indicated subframes.

RSRP and RSRQ may be done at the UE and may be reported back to the base station at a reporting interval, such as an interval in the order of 100s of milliseconds. The period over which the measurements may be performed may be set according to a UE. Many measurements may be done over one or more subframes and these results may be filtered before computing the RSRP and RSRQ. The RSRP and RSRQ may be reported by the UE using an information element, such as a MeasResults information element.

RSRP and RSRQ may be used for interference estimation. From RSRP and RSRQ, the Home eNodeB may compute the interference that may be observed at the UE that may have reported the measurements. For example, for a Home eNodeB and a Wi-Fi transmitter that may be coexisting, RSRQ may be as follows:

RSRQ=N×RSRP/RSSI
RSSI that may be measured during an ON period may be as follows:

RSSI_{femtoUE}=2N×P̅rs_{LTE}+12N×P̅_{WiFi}+10N×Pdata_{LTE}+12N×(P̅ₙₒᵢₛₑ)[w]

where, N may be the number of resource blocks of the E-UTRA carrier RSSI measurement bandwidth and P̅rs_{LTE}, P̅_{WiFi}, P̅data_{LTE}, may be an average power in a resource element (RE) of the LTE cell-specific reference signal, Wi-Fi interference, and data, respectively. The power of data REs may be equal to the power of reference signal REs or may be offset by a value. From the RSRQ and RSRP values, the Home eNodeB may compute the interference that may be due to other secondary transmitters as follows:

Pᵢₙₜ=12N×P̅_{WiFi}+12N×(P̅noise)[w]

However, in a deployment there may be other LTE transmitters in the same band that may create interference. In such a situation, RSSI and the interference power may be as follows:

RSSI_{femtoUE}=2N×P̅rs_{LTE}+12N×P̅_{WiFi}+10N×P̅data_{LTE}+12N×(P̅noise+P̅interference)[w]

Pᵢₙₜ=12N×P̅_{WiFi}+12N×(P̅noise+P̅interference)[w]

As described herein, UEs may be configured to report RSRP and RSRQ for a serving Home eNodeB, and for the close LTE neighbors to detect non-LTE secondary transmitters even interference created by other LTE transmitters may be present. Interference created by the LTE transmitters may be estimated and compensated for.

RSRP and RSRQ may be used for handover. As described herein, measurement reporting may be triggered if one of several conditions or events may apply to RSRP and RSRQ measurements. For example, event A2, which is further described herein, may occur when serving becomes worse than a configured threshold. Events and related procedures are also described herein. The quality of the carrier as experienced by a UE may be monitored by one or more base stations using the RSRP/RSRQ reports.

Licensed exempt bands may be open to secondary users such as 802.11 based transmitters, cellular transmitters, or the like. Nodes belonging to different radio access technologies may coexist. To enable different radio access technologies to coexist, coexistence gaps may be introduced in transmissions so that other secondary users may use these gaps for their own transmission. Disclosed herein are structures of these gaps; adaptation of coexistence pattern duty cycles, which may be based on secondary user existence and traffic; and signaling of duty cycle parameters.

To enable adaptation of a coexistence pattern duty cycle, measurements may be taken during a transmission and/or during gaps. Existing LTE Rel-10 RSRP and RSRQ measurements may be made when a Home eNodeB is transmitting, such as during the LTE ON duration, and may not detect secondary users that may not be transmitting during the LTE on periods. For example, the secondary users may cease transmission during the LTE ON periods due to CSMA and preexisting methods of measurement may not capture information about those transmitters. Disclosed herein are measurements that provide secondary user detection functionality.

Methods described herein may be used to dynamically change the parameters of a coexistence pattern to account for traffic in a first radio access technology and to account for the presence of other secondary users that may be in another radio access technology. For example, methods described herein may be used to adjust the parameters of a coexistence pattern to account for LTE traffic and for the presence of other secondary users in a channel.

To enable the dynamic change of the coexistence pattern parameters, measurements may be used to detect the presence of other secondary users (SU). Additionally, methods described herein may be used to signal parameter changes to the UEs.

A coexistence gap pattern may be used to enable the LTE-Wi-Fi coexistence in dynamic shared spectrum bands. Methods may be used to dynamically change the parameters of the gap pattern, such as the duty cycle, to adapt to both the LTE traffic and the presence of other secondary users.

Methods may be used to signal a duty cycle change to the UEs that may be connected to the (H)eNB. For example, PHY methods, such as primary synchronization signal (PSS), secondary synchronization signal (SSS) based, management information based (MIB) based, physical downlink control channel (PDCCH) based, or the like, may be used to signal a duty cycle change. As another example, MAC CE based methods may be used to signal a duty cycle change.

Measurements may be used to enable SU detection. For example, the measurements may be used to report interference that may be measured during ON and OFF durations. As another example, the detection of secondary users may be based on interference and RSRP/RSRQ measurements.

Methods may be used to coordinate a Listen Before Talk (LBT) mechanism with a coexistence gaps, which may be tailored for a number of situations. For example, a LBT mechanism may be used for DL and UL that may be operating in a TDM fashion in the same dynamic shared spectrum channel. As another example, a LBT mechanism may be used for DL operation in a dynamic shared spectrum channel. Methods may be used to dynamically schedule coexistence gaps and set the gap duration to achieve a target channel usage ratio.

Coexistence gap patterns may be provided to permit multiple radio access technologies, such as LTE and Wi-Fi, to coexist in the same band. For example, methods described herein may be used to enable a LTE system to coexist with other secondary users, such as Wi-Fi or LTE, that may be operating in the same dynamic shared spectrum band.

Gaps in transmission for a radio access technology transmission, such as a LTE transmission, may be used to provide opportunities for other secondary networks to operate in the same band. For example, during the gaps, an LTE node may be silent and may not transmit any data, control, or reference symbols. The silent gaps may be referred to as “coexistence gaps.” At the end of a coexistence gap, the LTE node may resumes transmission and may not attempt to assess the channel availability.

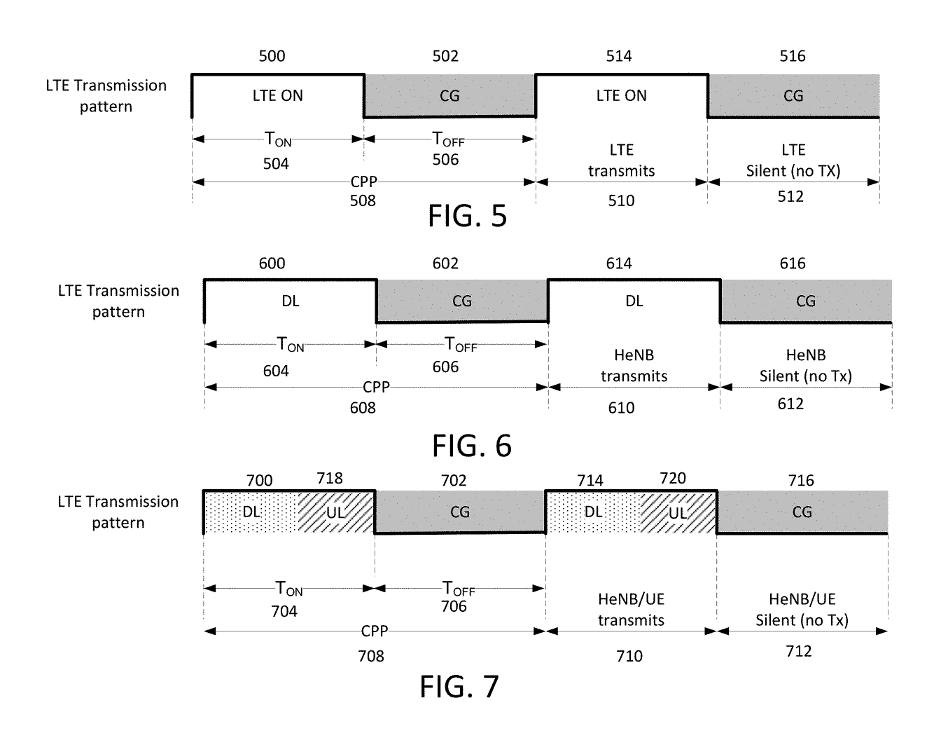

FIG. 5 depicts an example of a periodic gap pattern than may be used for secondary user coexistence. For example, the periodic gap pattern may be used by a first RAT, such as LTE, to coexist with another RAT by allowing the first RAT to transmit during an ON period and allowing the first RAT to be silent during a coexistence gap or OFF period. Another secondary user, which may be a second RAT, may use the OFF period to access the channel. As shown in FIG. 5, a coexistence pattern may include periodic ON or OFF transmissions. At 500, a RAT, such as LTE may, transmit for a Tₒₙ period at 504. At 502, a coexistence gap may be used and LTE may not transmit for a T_{off} period at 506. A period of the coexistence pattern (CPP) 508 may include Tₒₙ at 504 and T_{off} at 506. At 514, LTE may be ON and LTE may transmit at 510. At 516, a coexistence gap (CG) may be used and at 512 LTE may be silent and there may not be a transmission.

Embodiments described herein may enable coexistence of multiple RATs. This may be done in a manner that may be different from methods that may be used to provide the in-device coexistence (IDC). For example, methods to enable IDC may use UE DRX to provide the time division multiplexing (TDM) of RATs in the same device and may avoid the self-interference. Methods that may enable the coexistence of multiple RATs in the same cell may silence a cell (e.g. uses per cell DTX) to provide TDM of RATs in a given cell.

FIG. 6 depicts an example periodic gap pattern that may be used for a downlink (DL) mode of operation in a dynamic shared spectrum band. A first RAT, such as long-term evolution (LTE), may use coexistence gaps (CGs) to coexist with another RAT, such as Wi-Fi. For example, the periodic gap pattern may be used by the first RAT to coexist with another RAT by allowing the first RAT to transmit during an ON period and allowing the first RAT to be silent during a coexistence gap or OFF period. Other secondary users, which may be a second RAT, may access the channel during the OFF period.

A SU coexistence gap pattern may be used for a DL transmission in the dynamic shared spectrum band, where the (H)eNB may transmit during the LTE ON. As shown in FIG. 6, at 600, a RAT, such as LTE, may transmit in DL for a Tₒₙ period at 604. At 602, a coexistence gap may be used and LTE may not transmit in DL for a T_{off} period at 606. A period of the coexistence pattern (CPP) 608 may include Tₒₙ at 604 and T_{off} at 606. At 614, LTE may be ON and a (H)eNB may transmit in DL at 610. At 616, a CG may be used and at 612 the (H)eNB may be silent and there may not be a DL transmission.

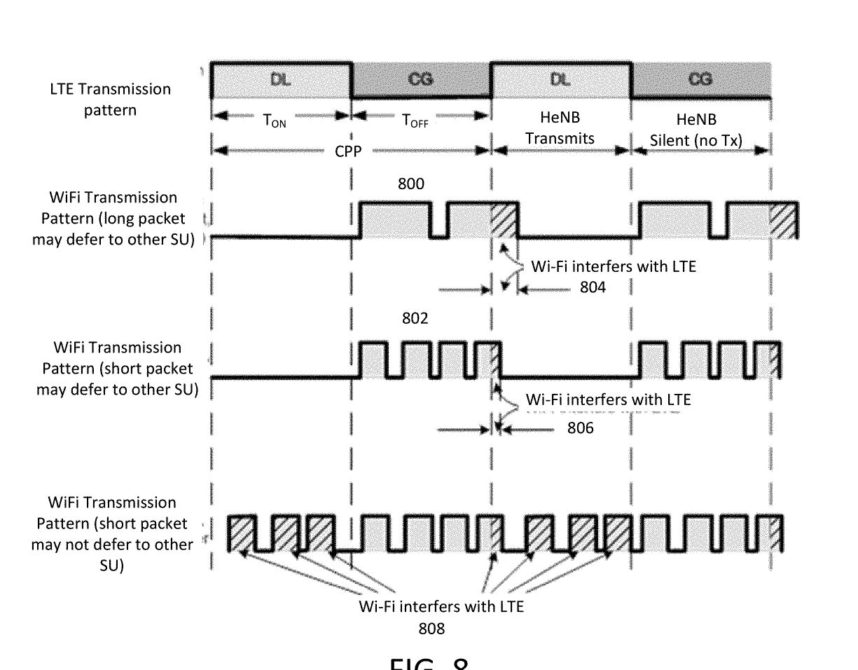

FIG. 7 depicts an example periodic gap pattern for a downlink (DL)/uplink (UL) mode of operation in a dynamic shared spectrum band. For example, the periodic gap pattern may be used by a first RAT, such as LTE, to coexist with another RAT by allowing the first RAT to transmit during an ON period and allowing the first RAT to be silent during a coexistence gap or OFF period. As shown in FIG. 7, a coexistence pattern may include periodic ON or OFF transmissions. When there may be uplink transmission as well as downlink transmission, a ON duration or period may be shared between DL and UL. For example, subframes may be allocated to DL and subframes may be allocated to UL. As shown in FIG. 7, at 700, a RAT, such as LTE, may transmit in DL for a part of a Tₒₙ period at 704. At 718, LTE may transmit in UL for a part of a Tₒₙ period at 704. At 702, a coexistence gap may be used and LTE may not transmit in DL and/or UL for a T_{off} period at 706. A period of the coexistence pattern (CPP) 708 may include Tₒₙ at 704 and T_{off} at 706. At 714, LTE may be ON and, at 710, a (H)eNB may transmit in DL and/or a UE may transmit in UL. At 716, a CG may be used and, at 712, the (H)eNB and/or UE may be silent and there may not be a DL and/or UL transmission.

Although example embodiments described herein may be described with respect to a DL mode of operation in the SuppCC, the embodiments should not be limited as such; the example embodiments may also be applicable to DL, UL, DL/UL, or any combination thereof. Additionally, even though the example embodiments may be described with respect to LTE for simplicity; however, the example embodiments may be applicable to any RAT, such as HSPA+, Wi-Fi, WIMAX, or the like.

A period of a coexistence pattern may be denoted by CPP, and may be as follows:

CPP=T_{ON}+T_{OFF}

A duty cycle of the coexistence pattern may be as follows:

$$CPDC = \frac{{T}_{ON}}{{T}_{ON} + {T}_{OFF}}$$

The period of the coexistence pattern (CPP) may be parameter that may be configured at the time the SuppCC may be set-up. The coexistence pattern duty cycle (CPDC) may be a parameter that may change as a function of the traffic and presence of other secondary users.

FIG. 8 depicts examples of coexistence gaps that may be used for LTE/Wi-Fi coexistence. In some deployment scenarios, nodes may experience the same interference, and the hidden node problem may not occur. During the coexistence gaps, such as when the LTE (H)eNB may be silent, the Wi-Fi nodes may detect that the channel available and may start transmitting packets. For example, at 800, Wi-Fi nodes may detect the LTE (H)eNB may be silent and that the channel may be available and may start transmitting packets for a long Wi-Fi packet duration. As another example, at 802, Wi-Fi nodes may detect the LTE (H)eNB may be silent and that the channel may be available and may start transmitting packets for a short Wi-Fi packet duration. As shown at 804 and at 802, the last Wi-Fi packet transmitted during the LTE gap may overlap on the next LTE DL transmission, which may create interference. The longer the Wi-Fi packets may be, the longer the potential duration of the LTE-Wi-Fi interference at the beginning of the LTE “ON” cycle may be.

In other deployment scenarios, the interference between the nodes may be localized and a hidden node problem may occur. For example, at 808, Wi-Fi nodes may not detect or defer to a LTE transmission, and may transmit during the LTE coexistence gap and the LTE “ON” duration. This may occur, for example, when Wi-Fi may use a high threshold for detection of non-Wi-Fi systems, such as −62 dBm for 20 MHz transmission BW, such that LTE transmission below the threshold at the Wi-Fi node may not be detected.

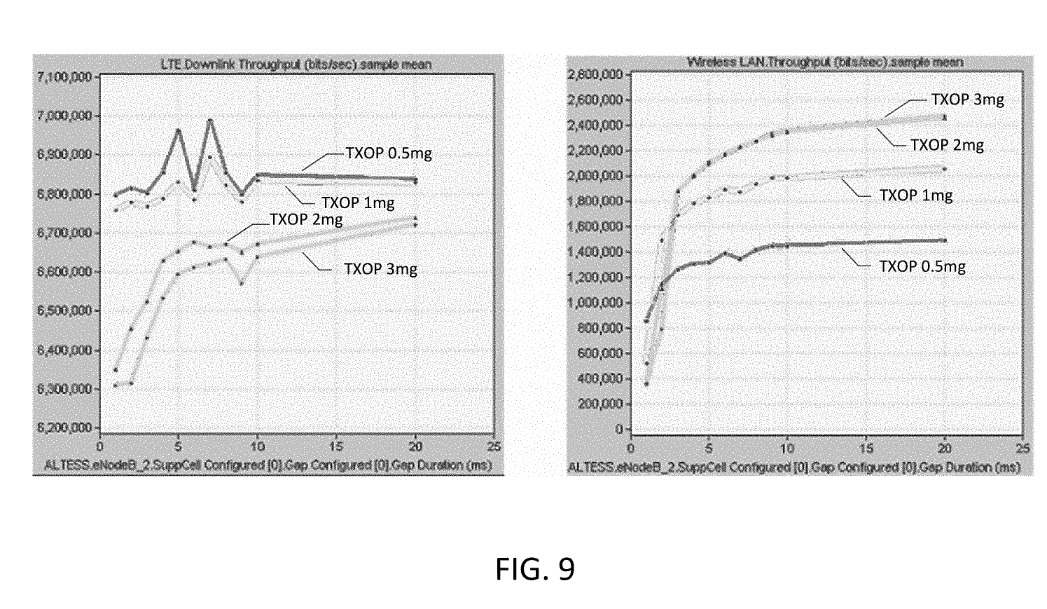

FIG. 9 depicts simulations of LTE and Wi-Fi throughputs vs. gap duration. For example, FIG. 9 may depicts simulations of LTE/Wi-Fi coexistence performance when coexistence gaps may be used. A 50% duty cycle may be used and a range of values for the coexistence pattern period may be simulated. Both LTE and Wi-Fi traffic may be full buffer and the packet length of Wi-Fi may be varied from 0.5 ms to 3 ms. The throughput of LTE and Wi-Fi may be seen in FIG. 9. Throughput of both LTE and Wi-Fi may converge for coexistence pattern periods of 10 ms or larger.

Coexistence pattern duty cycles may be adapted dynamically. For example, a method may be used to adapt a duty cycle of a coexistence pattern to account for LTE traffic, to account for the presence and traffic of Wi-Fi users, and to enable coexistence with other secondary users.

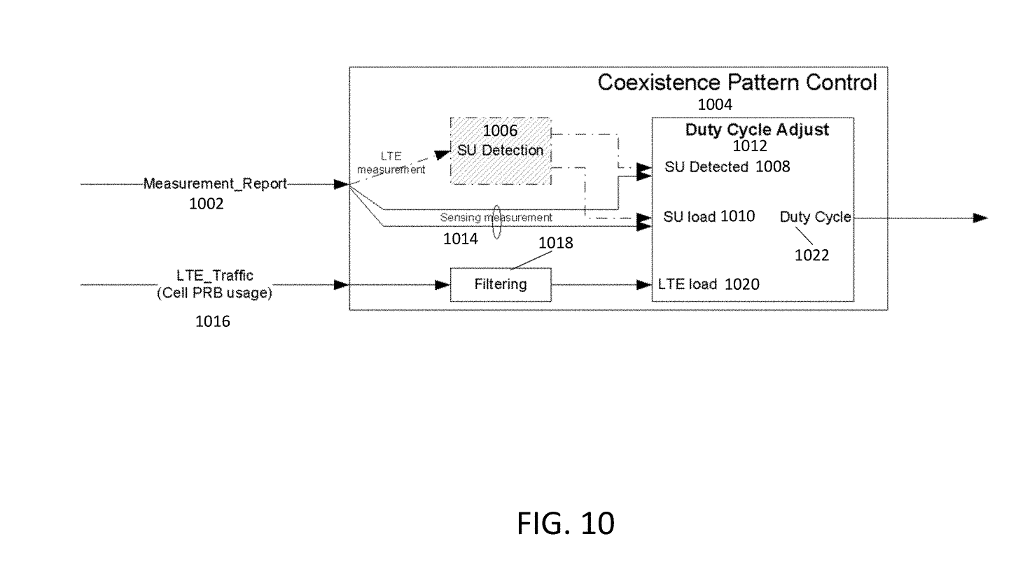

FIG. 10 depicts an example block diagram of a coexistence pattern control device. SU detection and SU traffic load, such as Wi-Fi feature detection and Wi-Fi traffic load, may be provided by a sensing engine, and made available through a Measurement Report signal at 1002. The Measurement Report signal may be input to the coexistence pattern control block 1004. If a sensing toolbox may not support SU feature detection, Coexistence Pattern Control block 1004 may use LTE measurement to perform SU detection at 1006, may generate an SU detect, such as an Wi-Fi detect, at 1008, and may generate SU load signals at 1010. The SU detects and the SU load signals may be requested by the Duty Cycle Adjust block 1012. The SU detect may be used at 1008 to detect secondary users. The SU load may be used at 1010 to detect secondary user load. The SU Detection block 1006 may be used if the sensing toolbox may not support SU feature detection.

At 1016, Coexistence Pattern Control 1004 may receive LTE_Traffic, which may include information regarding LTE traffic and may include cell PRB usage. At 1018, filtering may take place, which may be used to generate a LTE load. At 1020, a LTE load may be received by Duty Cycle Adjust 1012. Duty Cycle Adjust 1012 may generate a duty cycle at 1022, using SU detected 1008, SU load 1010, and/or LTE load 1020.

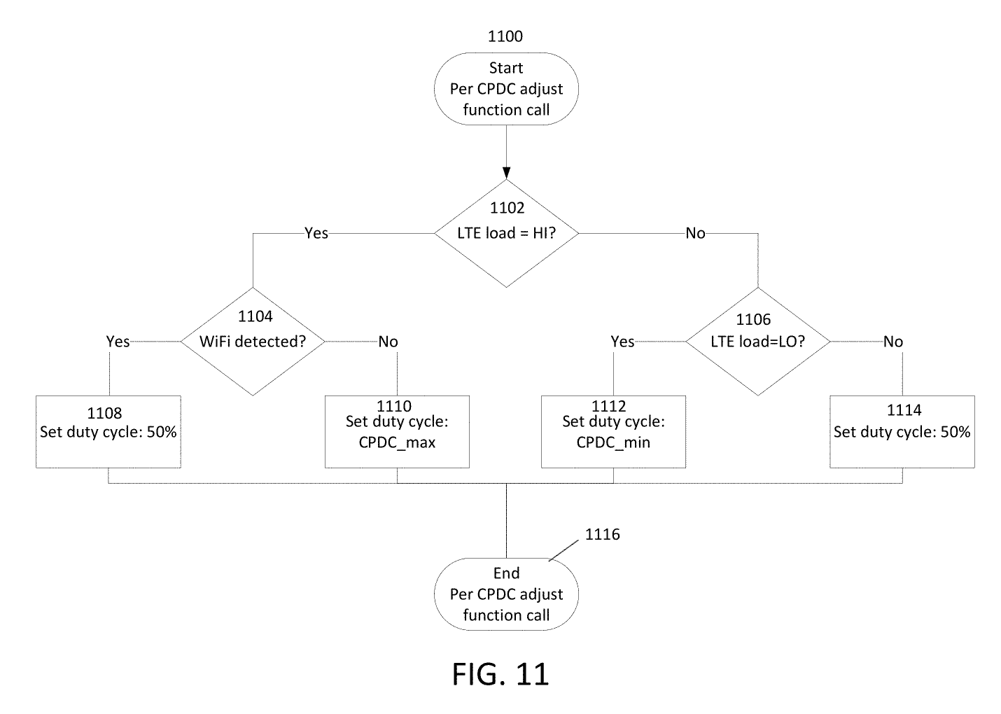

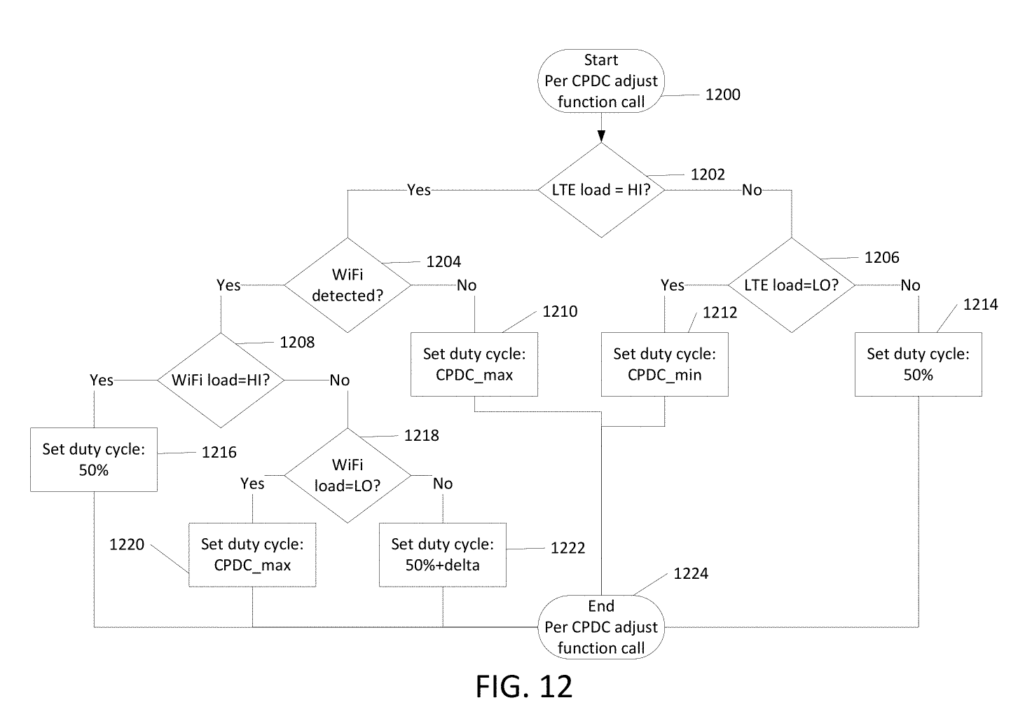

FIG. 11 depicts an example flow diagram for duty cycle adjustment where Wi-Fi load estimation may not be available. For example, FIG. 11 depicts a method that may be used to adjust a duty cycle using LTE traffic and a capability to detect Wi-Fi users. The method may be performed periodically or aperiodically. The method may not require knowledge of a Wi-Fi traffic load.

At 1100, a per CPDC adjust function call may be made to, for example, request that a duty cycle be adjusted. At 1102, it may be determined whether a LTE load may be high. If the LTE load may be high, it may be determined if Wi-Fi may be detected at 1104. If the LTE may not be high, at 1106 it may be determined if the LTE load may be low. If Wi-Fi is detected at 1104, the duty cycle may be set to 50% at 1108. If Wi-Fi is not detected at 1104, the duty cycle may be set to a value such as CPDC_max, which may be a CPDC maximum value. If the LTE load may be low, at 1112, the duty cycle may be set to a value such as CPDC_min, which may be a CPDC minimum value. If the LTE load may not be low and may not be high, at 1114 the duty cycle may be set to 50%. At 1116, the per CPDC adjust function call may end.

As described herein, Wi-Fi may not be detected at 1104 for a number of reasons. For example, there may not be a Wi-Fi transmitter in the vicinity of the LTE network. A possible Wi-Fi transmitter may be out of a certain range and may not back off when LTE may be in transmission. As another example, there may be an aggressive, non-cooperative secondary user that may cause high levels of interference.

FIG. 12 depicts an example flow diagram for a duty cycle adjustment where Wi-Fi load estimation may be available. At 1200, a per CPDC adjust function call may be made. At 1202, it may be determined whether a LTE load may be high. If the LTE load may not be high, it may be determined if the LTE load is low at 1206. At 1214, the duty cycle may be set to 50% when the LTE load may not be low. At 1212, the set duty cycle may be set to a value, such as CPD_min when the LTE load may be low.

At 1204, it may be determined if Wi-Fi may be detected when the LTE load may be high. If Wi-Fi may not be detected, at 1210, the duty cycle may be set to value, such as CPDC_max. At 1208, it may be determined if a Wi-Fi load is high when Wi-Fi is detected. If the Wi-Fi load is high, the duty cycle may be set to 50% at 1216. If the Wi-Fi load is not high, it may be determined if the Wi-Fi load is low at 1218. If the Wi-Fi load is low, the duty cycle may be set to 50% plus a delta. If the Wi-Fi load is not low, the duty cycle may be set to a value, such as CPDC_max. At 1223, the per CPDC adjust function call may end.

Duty cycle signaling may be provided. The UEs connected to a (H)eNB may request to know when the (H)eNB may enters a DTX cycle, such as a periodic coexistence gap. Knowledge of a DTX cycle may, for example, allow the UE to save power as the UE may enter a DRX period to save power since it may not be requested to monitor the (H)eNB. As another example, knowledge of a DTX cycle may allow the UEs to avoid performing channel estimation on default cell specific reference (CRS) locations, since CRS symbols may not be transmitted by the (H)eNB during the LTE OFF duration. Using noisy RE for channel estimation may result in a degradation of the channel estimate, and may cause potential performance degradation.

Existing Rel-8/10 framework does not have signaling for a periodic DTX gap since this gap does not exist for primary cells. Disclosed herein are semi-static and dynamic methods that may be used to signal a duty cycle to a UE.

Disclosed herein PHY, MAC and RRC methods for that may be used for signaling the duty cycle. As shown in Table 1, a number of physical (PHY) layer methods may be used to signal a duty cycle:

TABLE 1
PHY methods that may signal a duty cycle

| Control Entity | PHY | | |
|---|---|---|---|
| Method | PSS/SSS | MIB | Blind Detection of RSs |
| Reliability | Very | Very | Good |
| eNB/HeNB Control | <10 ms | 40 ms | <1 ms |
| Delay | | | |
| UE processing delay | <1 ms | 40 ms | ~1-2 ms |
| | Robust signaling | Robust signaling | may not require any |
| | Short delay between | Delay between | signaling |
| | eNB/HeNB decision and | eNB/HeNB decision and | |
| | signaling | signaling | |
| | Quick response from UE | Quick response from | |
| | duty cycle may change in | UE, duty cycle can be | |
| | the same sub-frame as | changed within the | |
| | signal | same frame of receiving | |
| | Duty cycle may be | signal. | |
| | known by UEs during | slow eNB/HeNB | |
| | inter-frequency | control delay | |
| | measurements | | |
| | | | UE may to continue |
| | | | listening to reference |
| | | | symbols for some |
| | | | period after the LTE |
| | | | cycle has ended |

As shown in Table 2, a number of MAC and/or RRC methods may be used to signal a duty cycle:

TABLE 2
MAC and RRC methods that may signal a duty cycle

| | Control Entity | | |
|---|---|---|---|
| | PHY | MAC | RRC |
| Method | PDCCH | MAC CE | RRC config |
| Reliability | Good | Good | Very |
| eNB/HeNB | 1 ms | 1 ms | Long |
| Control Delay | | | |
| UE processing | 1 ms | 8 ms | 15 ms |
| delay | | | |
| | fast control (<1 ms) | Short eNB/HeNB | Reliable |
| | May signal within the | control delay | |
| | same frame as making | Short UE pro- | |
| | a decision | cessing | |
| | PDCCH may be | Unicast messages | Static |
| | encongested and room | Requires an | Operation |
| | may not exist. | acknowledgement | |
| | Redundant information | | |
| | since PDCCH may be | | |
| | used for a sub-frame | | |

A number of PHY methods, such as PSS and SS based methods, may be used to signal a duty cycle. For example, a duty cycle may be signaled on a frame-by-frame basis. The PSS/SSS may be modified for supplementary cells for signaling since there may not be a request for accelerated cell search on supplementary cells. Uniquely decodable permutations of SSS and PSS positioning may be exploited for signaling.

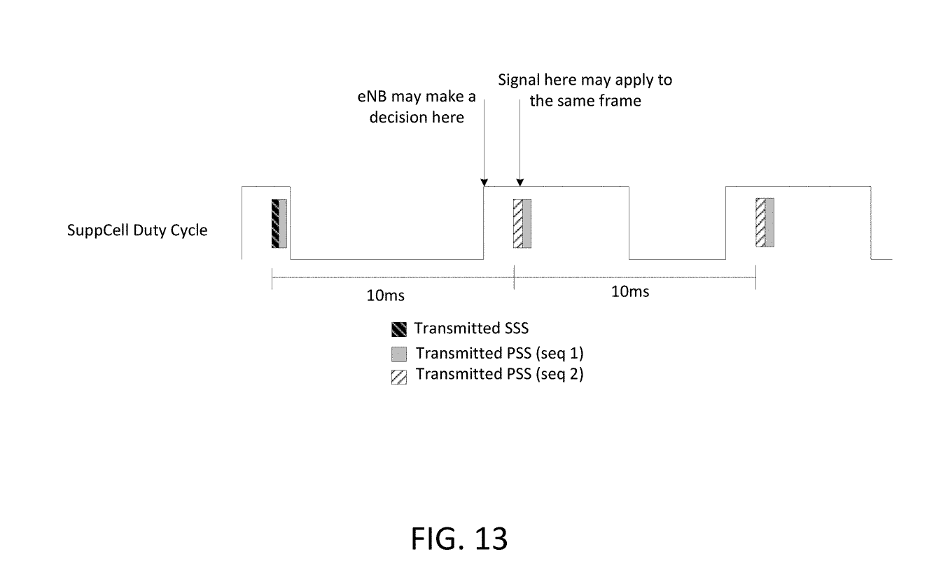

FIG. 13 depicts an example of eNode-B (eNB)/home eNB (HeNB) Duty Cycle Signaling. The duty cycle signaling may provide low latency signaling and may be useful for applications such as VOIP that may have QoS requirements that may accept low amount of delay and jitter. As shown in FIG. 13, at the beginning of a sub-frame, the scheduler or the radio resource management (RRM) at the (H)eNB may make a decision about the duty cycle and may signal the UEs using the PSS and SSS for that frame. For example, for SuppCell Duty Cycle 1306, a (H)eNB may make a decision at 1302 about SuppCell Duty Cycle 1306 and may signal a UE at 1304 using a frame.

There may not be a request for accelerated cell search on a supplementary cell since the UE may connect on a primary cell. The PSS/SSS may be transmitted once per LTE frame to signal the beginning of the frame, for example at a 10 ms interval. Since the sequence type of the SSS may not be used to distinguish sub-frame 0 from sub-frame 5, this may be used for supplementary cell signaling. The position of the SSS relative to the PSS may be used to distinguish between TDD and FDD. The relative position of the SSS may be used for supplementary cell signaling. A UE may determine the duty cycle of the cell by the relative location of the SSS and its sequence type. The PSS/SSS may be mapped in any place that may not conflict with reference symbols or other symbols.

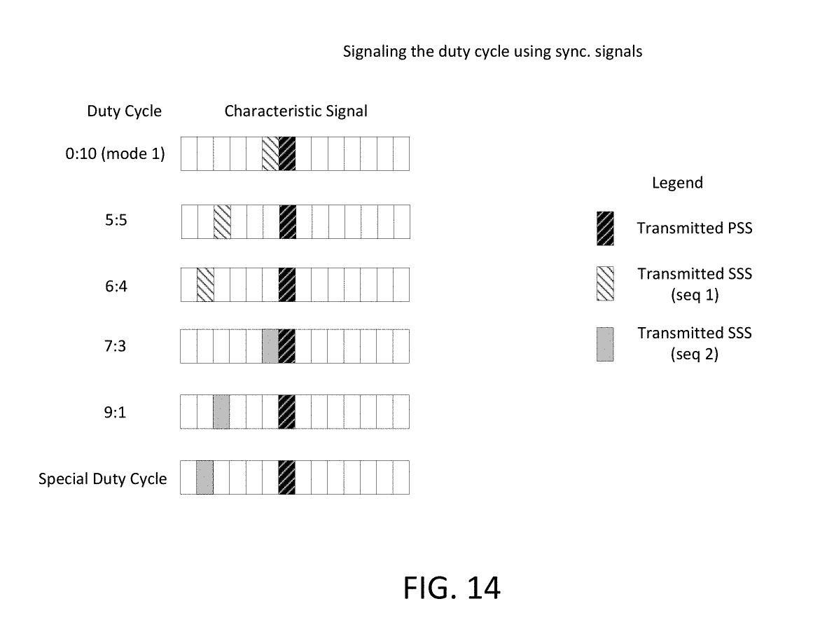

FIG. 14 depicts example PSS/SSS permutations for signaling a duty cycle. The meaning of permutations may be modified. For example 0:10 may be replaced by 2:8 if that may be the minimum possible duty cycle in an implementation.

When TDD may be developed for supplementary carriers, a duty cycle permutations may be used to signal the TDD mode of operation. If TDD may be configured elsewhere, such as through a RRC connection, the PSS/SSS permutations may be signaling for other purposes.

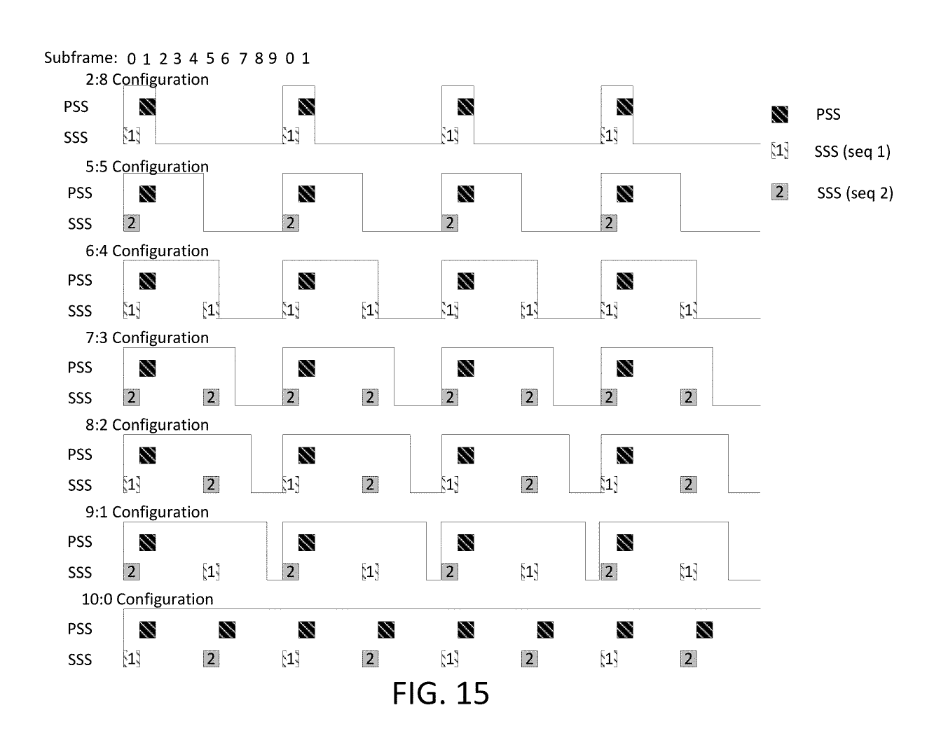

FIG. 15 depicts example duty cycle signaling using PSS and SSS. PSS/SSS combinations may be used to signal a duty cycle by placing the PSS and SSS in different sub-frames. The SSS may reside in the last symbol of sub-frames 0 and 5, while the PSS may reside in the third symbol of sub-frames 1 and 6. FIG. 15 shows a number of configurations that may be used for duty cycle signaling. The duty cycle using these configurations may apply to the next sub-frame since the UE may decode the PSS/SSS at the beginning and the end of a frame to decode the configuration.

Master information base (MIB) signaling of a duty cycle may be provided. The MIB may be used to signal the Duty Cycle change. The MIB may be a robust signal and may be repeated over an interval, such as 10 ms over a 40 ms period. The duty cycle bits may replace MIB information that may be not needed for supplementary cells. For example, since frame timing may be obtained from a primary cell, duty cycle information may replace the bits that may be used for the SFN.

PDCCH signaling may be used to signal a duty cycle. For example, PDCCH may be used to signal the gap on a sub-frame basis. A single Duty Cycle Bit may be used on the PDCCH to signal the beginning of a gap. The UE may know that the gap period is about to begin when the UE may decode this bit. For example, the UE may decode the Duty Cycle Bit to be 0, which may indicate the beginning of the gap. The gap period may begin, for example, on the same sub-frame as the Duty Cycle Bit, on the next sub-frame, or the like. The Gap Period may last a configured amount of time or may end at a fixed time, such as the beginning of the next frame.

A number of bits may be used to encode a duty cycle configuration. For example, 2 to 4 bits may be used to encode a duty cycle configuration. The number of duty cycle bits may depend on the number of configurations supported and the duty cycle timing may be relative to the frame timing. A UE that decodes the configuration on a sub-frame may know the location of the PSS/SSS when the gap may occur.

PDCCH signaling method may be used on the Primary Cell PDCCH, the Supplementary Cell PDCCH, or the like. Primary Cell signaling may be more reliable since an operator may not contend with secondary users. In a Primary PDCCH scenario, a duty cycle bit may be used to signal a duty cycle and a cell may be identified to which the duty cycle applies. As in the case of cross-carrier scheduling, this may require additional bits. If cross-carrier scheduling may be used, the duty cycle bit(s) may be piggybacked on an existing mechanism to identify cells by adding the duty cycle bits to the existing format.

MAC CE signaling may be used to signal a duty cycle. Upon deciding to change the duty cycle, the (H)eNB may send a MAC CE to a UE. The contents of the MAC CE may include an ID, the new value of the duty cycle, and timing information that may indicate when the change may apply. An example of the message contents may include a LCID, a new duty cycle, frame timing information, a combination thereof, or the like. An LCID (which may be a 5 bit message ID), may include a MAC header element and may use reserved LCID values 01011 to 11010 (or any other unused message ID). A new duty cycle may be a field that may be 2 to 4 bits depending on the number of supported duty cycles. A frame timing information may be two bit such that 00 may apply to the current frame n, 01 may apply to the next frame n+1, 10 may apply to the next frame n+2, and/or 11 may indicate that a change may have already occurred (possible in the case of retransmissions).

The (H)eNB may schedule a UE individually and may allow enough time for a message to be processed and acknowledged before changing the duty cycle. Some rules may be used to ensure that the (H)eNB may not schedule a UE that may not be prepared to receive data.

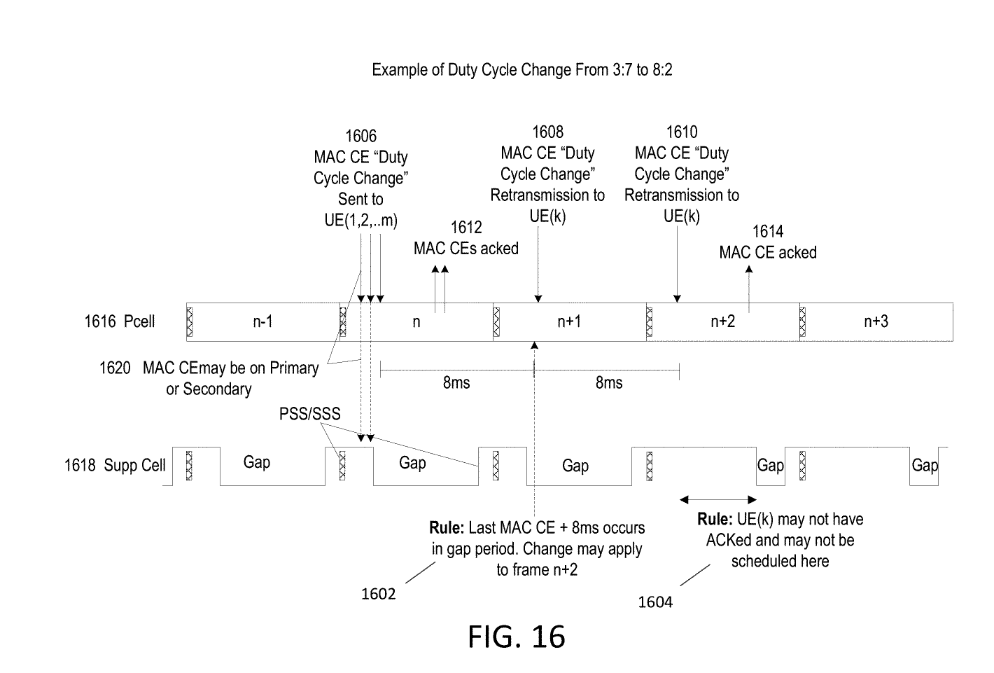

FIG. 16 depicts a Duty Cycle Change example using a medium access control (MAC) control element (CE). A primary cell (Pcell), such as Pcell at 1616, and a SuppCell, such as SuppCell at 1680, may be in coexistence. At 1606, a MAC CE may be used to indicate a duty cycle change and may be sent to a UE. As shown at 1620, the MAC CE may be on a primary or secondary cell. At 1612, the MAC CE may be acknowledged. At 1602, a rule may be applied to, for example, determine if the last MAC CE+a time, such as 8 ms, may occur within a gap period. If the last MAC CE may fall within a gap period, then the duty cycle change may apply to frame n+2. At 1608, the MAC CE that may be used to indicate a duty cycle change may be retransmitted to a UE. At 1610, the MAC CE that may be used to indicate a duty cycle change may be retransmitted to a UE. At 1604, a rule may be applied to, for example, if a UE may not have acknowledged the MAC CE that may indicate a duty cycle change. At 1614, a MAC CE may be acknowledged.

As shown in FIG. 16, rules, such as rules at 1602 and at 1604, may be used for sending MAC CEs to its UEs. For example, a rule that may be applied at 1062 may be as follows:
When changing a duty cycle, if the last UE to be scheduled for the MAC CE indicates a duty cycle change is done so in sub-frame n, then the duty cycle change may not apply before sub-frame n+8. If sub-frame n+8 may fall in the gap of the old duty cycle of frame k, then the duty cycle may apply to frame k+1.

As another example, a rule that may be applied at 1604 may be as follows: When increasing a duty cycle (for example from 3:7 to 8:2) a (H)eNB may schedule UEs which may have ACKed the MAC CE. This may apply to LTE sub-frames that may be added by the change in duty cycle (the UE may be awake for sub-frames 1, 2 and 3 even if NACKed in the example).

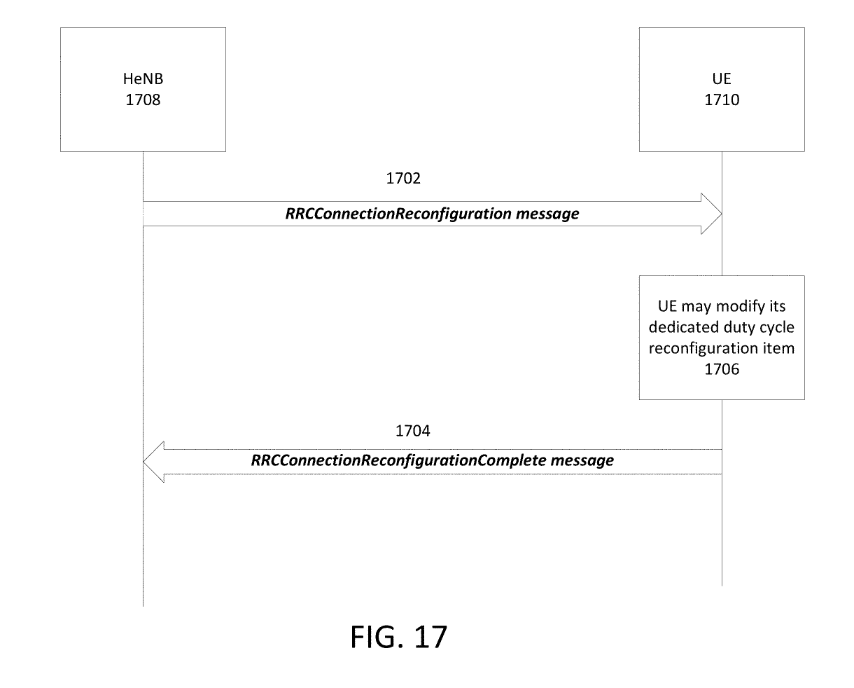

RRC signaling may be used to signal a duty change cycle. FIG. 17 depicts a Duty Cycle Change example using radio resource control (RRC) reconfiguration messaging. RRC signalling may be used to add, modify and release cells. SuppCell configuration items may be added to SCell PDUs such that the SCell add, modify and release cell messages may apply to SuppCells. In the list of configuration items, Dedicated Configuration items may be modified while Common Configuration items may not be modified. The duty cycle may be added as a dedicated configuration item.

PDUs may be provided for SuppCells using the same information as SCells with some additional fields. In the list of configuration items, Dedicated Configuration items may be modified while Common Configuration items may not be modified. The duty cycle may be added as a dedicated configuration item in the PDUs. This may enable a cell modification message to change the RRC configuration item.

As shown in FIG. 17, at 1702, HeNB 1708 may send an RRCConnectionReconfiguration message to UE 1710. UE 1710 may modify its dedicated duty cycle reconfirmation item at 1706. At 1704, UE 1710 may respond with an RRCConection ReconfigurationComplete message.

LTE measurements may be used for SU detection. For example, enhancements may be made to Release 10 LTE measurements. UE measurements may be used for SU detection.

RSRP and RSRQ may be made when a home eNodeB may transmitting, e.g., during the ON duration. However, secondary users may simply cease transmission during the ON periods due to CSMA and RSRP and RSRQ may not capture information about those transmitters.

A UE may make measurements during both the ON and OFF periods. These measurements may be a RSSI or another measurement of interference. A RSSI may include a desired signal and may be processed before being used. A RSSI may request cell specific reference signals, but cell-specific signals may be removed on some component carriers. In those cases, an estimation of interference may be provided if cell reference signals may not exist. Interference may be estimated by measuring the received power on certain REs on which the Home eNodeB may not transmit.

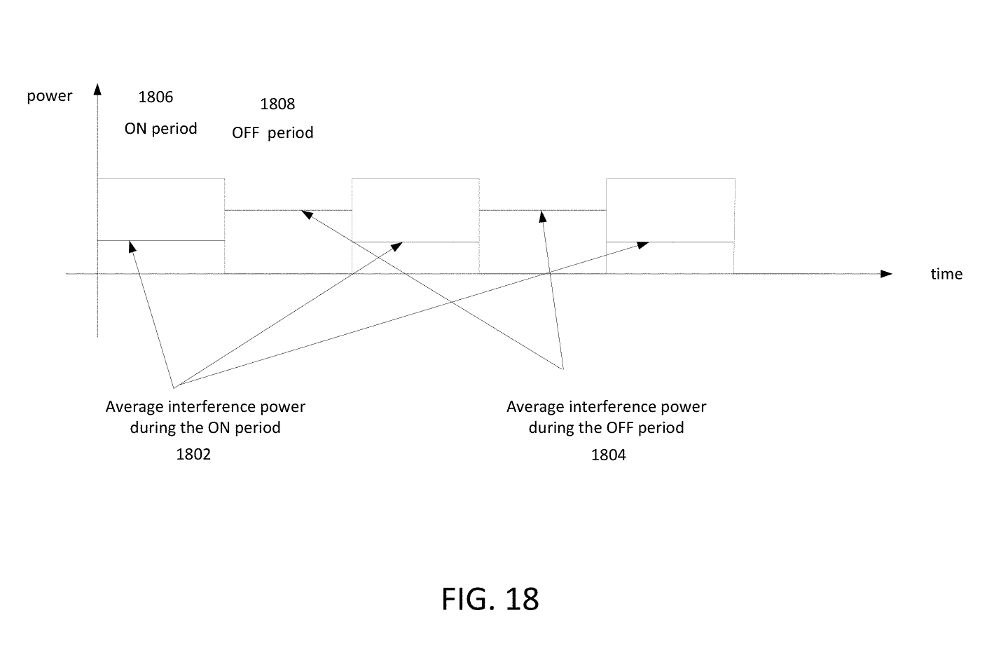

FIG. 18 depicts an example of interference levels during the LTE ON and OFF periods. As shown in FIG. 18, if a secondary user defers transmission during an ON period, such as 1806, and resumes during a OFF period, such as at 1808, then the interference power over these two periods may be different. Average interference power during the ON period may be seen at 1802. Average interference power during the OFF period may be seen at 1804. The difference in the received interference power during the ON and OFF durations may be denoted as Δ=P_{OFF}^{int}−P_{ON}^{int}. With this measurement, the UE may report back to the Home eNodeB one of the following quantities or a combination of them:

Δ=P_{OFF}^{int}−P_{ON}^{int} (or −Δ).

P_{ON}^{int} and P_{OFF}^{int}

Δ may be computed at the Home eNodeB. The reporting periods for these reports may be different and may depend on the signaling overhead that may be caused. For example, Δ may be represented by several bits and may be reported more than interference values P_{ON}^{int} and P_{OFF}^{int}.

These values (Δ and/or P_{ON}^{int} and P_{OFF}^{int}) may be filtered at the UE and/or at the Home eNodeB before deciding whether a secondary transmitter may or may not exist.

Measurements may be used for SU detection in a number of coexistence scenarios, such as when Wi-Fi may detect LTE and may back off; when Wi-Fi may detect LTE and may not back off; when Wi-Fi may detect LTE and may back off, and LTE-to-LTE coordination may be possible; when LTE-to-LTE coordination may not be possible; or the like.

Measurements may be used for SU detection when Wi-Fi may detect LTE and may back off. There may be a 802.11 based secondary network where the nodes of this network may detect a LTE transmitter, for example, via the CSMA/CA mechanism, and may back off while the Home eNodeB may be in transmission. Secondary network data transmissions may resume when the Home eNodeB may cease its own transmission and may enter the OFF period. The level of the interference experienced at the UE over the ON and OFF durations may be different.

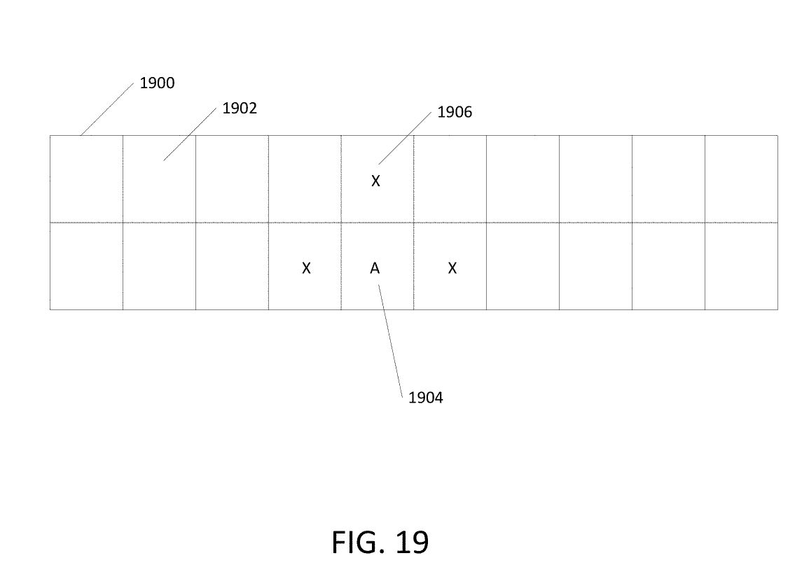

FIG. 19 depicts a simulation model. A numerical analysis for a representative scenario may show that measurements and a detection algorithm may be used to detect secondary users. FIG. 19 may depict eight block of apartments with two floors. Block 1900 may as include two rows of apartments on an floor. The size of an apartment, such as apartment 1902, may be 10 m by 10 m. A path loss may be as follows:

$$PL ( dB ) = 20 {log}_{10} ( \frac{4 π f}{c} ) + 20 {log}_{10} d + 0.7 {d}_{2 D , indoor} + {Fn}^{( ( n + 2 ) / ( n + 1 ) - 0.46 )} + {qL}_{iw}$$

where R and d2D, indoor may be in m, n may be the number of penetrated floors, F may be the floor loss, which may be 18.3 dB, q may be the number of walls separating apartments between UE and HeNB, and Liw may be the penetration loss of the wall separating apartments, which may be 5 dB. The path loss numbers may be computed for a 2 GHz carrier frequency but the trends shown below may be valid for lower frequencies as well.

The interference power on a receiver located in apartment A, at 1904, may be computed. The transmitter in one of the adjacent apartments, such as 1906, shown as X, may be turned on or off. Other transmitters in the remaining apartments may be turned on or off with a probability “activity factor.”

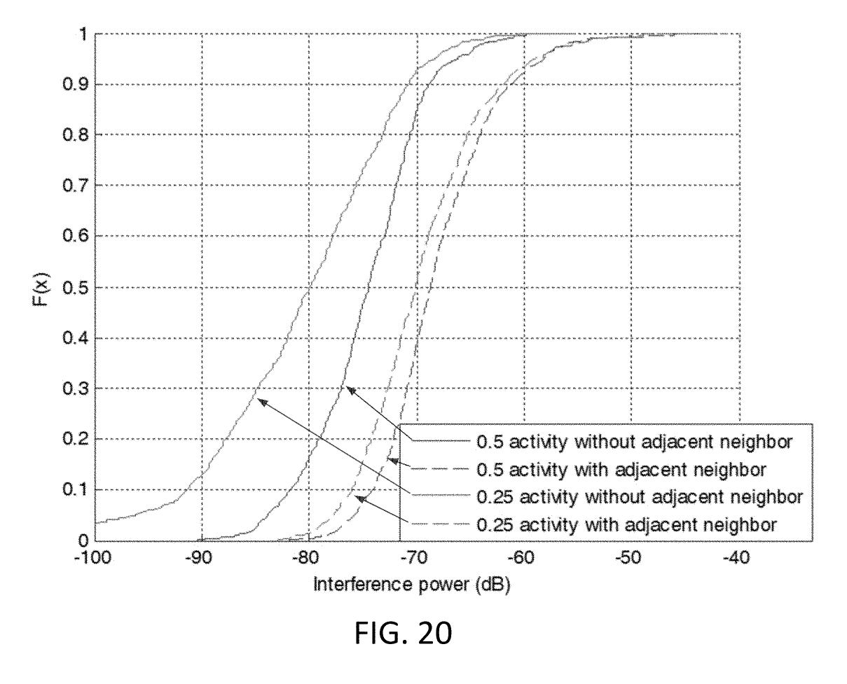

FIG. 20 depicts an example graph of the cumulative distribution function (CDF) of the interference. Cumulative distribution functions of the interference for a number of cases may be seen in FIG. 20. When the activity factor may be 0.5, the difference in received power at the receiver in apartment A, when one of the neighbor transmitters may be turned on or off, may be about 6 dB. When the activity factor may be 0.25, the difference may be more than 10 dB. This difference may be Δ.

Δ may be used to detect a secondary transmitter that may be capable of detecting the HeNB and may back off during the LTE-ON durations, and may transmit during the LTE-OFF durations.

A UE may report the P_{ON}^{int} and P_{OFF}^{int}. In this case, the Home eNodeB may compute the A. To reduce the signaling overhead, P_{ON}^{int} and P_{OFF}^{int} may be reported ever k-CPP (coexistence pattern periods) instead of every CPP. In this case, the interference power may be averaged over the k-periods.

Measurements may be used for SU detection when Wi-Fi may detect LTE and may not back off. There may be an 802.11 based secondary network where the nodes of this network may not back off when the LTE transmitter may be active. The secondary transmitters may not defer transmission because they may be far enough from the Home eNodeB, which may result in the received interference power being smaller than the CCA threshold.

As an example, −72 dBm may be a CCA threshold and the table below may provide probabilities of sensing a channel as busy for a number of cases. When there may be an adjacent neighbor active, the secondary transmitter may sense the channel as busy. If an adjacent neighbor may not be active, then the channel may be sensed as idle.

| | Probability of channel |
|---|---|
| | busy (approximate |
| Case | values) |
| 0.25 activity factor with no adjacent neighbor | 15% |
| 0.5 activity factor with no adjacent neighbor | 30% |
| 0.25 activity factor with adjacent neighbor | 70% |
| 0.5 activity factor with adjacent neighbor | 80% |

Given an activity factor, if none of the adjacent neighbors may be active, turning on or off the transmitter in the two-adjacent apartment may not affect the SINR distribution of the secondary network receiver. The Home eNodeB may increase its utilization of the channel if the secondary network may be far enough and may not back off during the ON duration.

Measurements may be used for SU detection when Wi-Fi may detect LTE, may back off, and LTE-to-LTE coordination may be possible. If LTE transmitters may be close enough so that interference may occur, interference may be controlled by coordination mechanisms. The mechanisms may be applied by a central controller or in a distributed manner. As a result of interference coordination, interfering transmitters may end up using orthogonal resources in time and/or frequency domain.

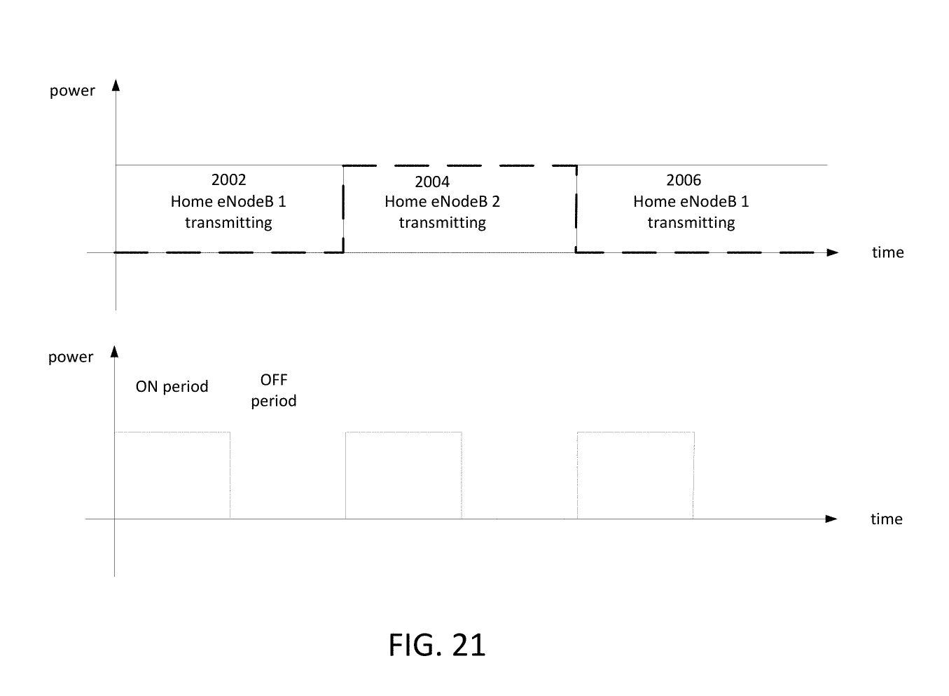

FIG. 21 shows an example of secondary user coexistence with two cooperating LTE transmitters. As shown in FIG. 21, at 2002, 2004, and 2006, two interfering Home eNodeB's may be transmitting in orthogonal time periods. A Home eNodeB may use detection/coexistence methods while transmitting on the resources allocated to itself.

Measurements may be used for SU detection when Wi-Fi may detect LTE, may back off, and LTE-to-LTE coordination may not be possible. There may be an LTE transmitter that may cause interference and may not cooperate for interference coordination. In this case, the channel utilization may be increased to maximum value, such as 100%, or the channel may be vacated or deactivated until the interference may return to acceptable levels.

RSRP/RSRQ and/or the interference measurements may be used to assess the level of interference. If the cell ID of the aggressor LTE transmitter may be known, interference caused by this transmitter may be computed by measuring its RSRP. If the cell ID of the aggressor may not be known, RSRQ and/or the interference measurement may give an idea of the interference level in the channel.

Secondary users may be detected. For example, secondary users may be detected by using interference measurements, such as A described herein. A number of procedures may be used for secondary user detection. For example, a UE may estimate the average interference during the ON duration. The interference power may be computed on specified REs in one or more subframes and may be averaged over the subframes during the ON period. This average interference may be denoted P_{ON}^{int}.

As another example, a UE may estimate the average interference during the OFF duration. The interference power may be computed on a specified REs in one or more subframes and may be averaged over the subframes during the OFF period. This average interference may be denoted P_{OFF}^{int}.

As another example, at the end of the CPP, Δ=P_{OFF}^{int}−P_{ON}^{int} may be computed.

As another example, if the reporting period may be a CPP, Δ may be reported at the CPP. Else, if the reporting period may be k-CPPs, k Δs may be collected, the k Δs may be filtered (for example, by averaging) and may be reported k-CPP.

As another example, the most recent N Δs may be filtered by the Home eNodeB to compute a single final Δ_{final} per UE.

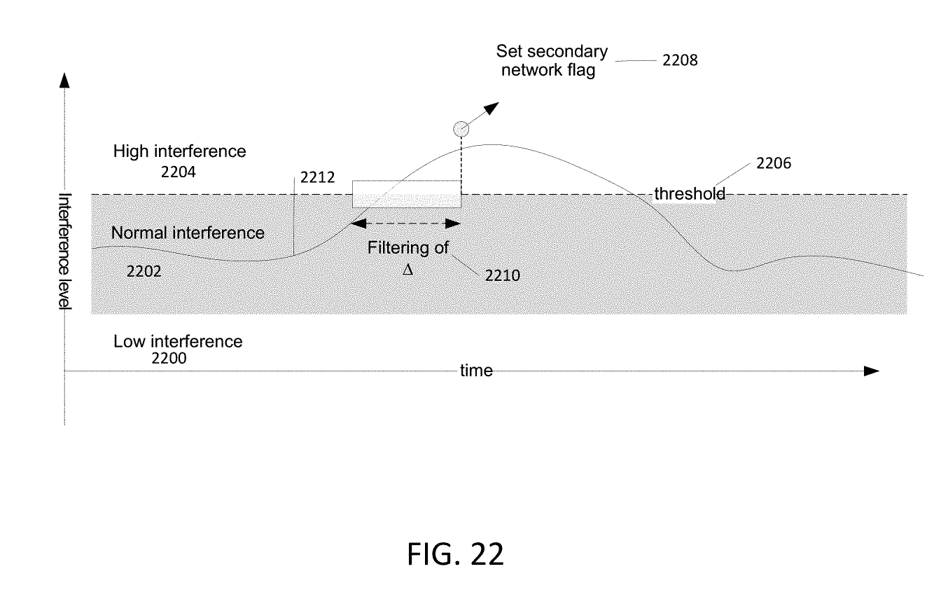

FIG. 22 depicts an example detection of a secondary network. There may be different levels of interference, such as a low interference level at 2200, a normal interference level at 2202, and a high interference level at 2204. A transmission may occur at 2212. Filtering of A may occur at 2210. A high threshold may be set at 2206.

If Δ_{final}>Δ_{high threshold}, the Home eNodeB may decide that there may be a secondary network detected. This may occur, for example, at 2208 where a secondary network flag may be set. If Δ_{final}<Δ_{high threshold}, the Home eNodeB may decide that there may be a secondary network that may not be detected. This may be due to the absence of a SU, or for a secondary user/network that may be located further away from the own network, which may create relatively low levels of interference.

Δ reports may be combined from multiple UEs. Δ reports from different UEs may not reflect the same information. The information from several sources may be combined to get to determine whether a secondary networks may exist. A number of approaches may be used to combine the information. For example, for a node making a measurement, a decision (SU_detect: TRUE or FALSE) may be made and these decisions may be combined. A method to combine the decisions may be to XOR the decisions from the sources such that SU nonexistence during a period may be decided if a measurement may confirm this. For example, when the decisions Δk>Δhigh threshold, where k may the UE index at the Home eNodeB, the combined decision may be computed as XOR(Δk>Δ_{high threshold}).

Another approach to combine the information from a number of A reports may be to combine the measurements from one or more nodes and base the combined decision on the combined measurement. In this approach, the measurements from different UEs may be filtered (for example be averaging) and the filtered result may be compared to the threshold. An example may be ΣΔₖ>>Δ_{high threshold}.

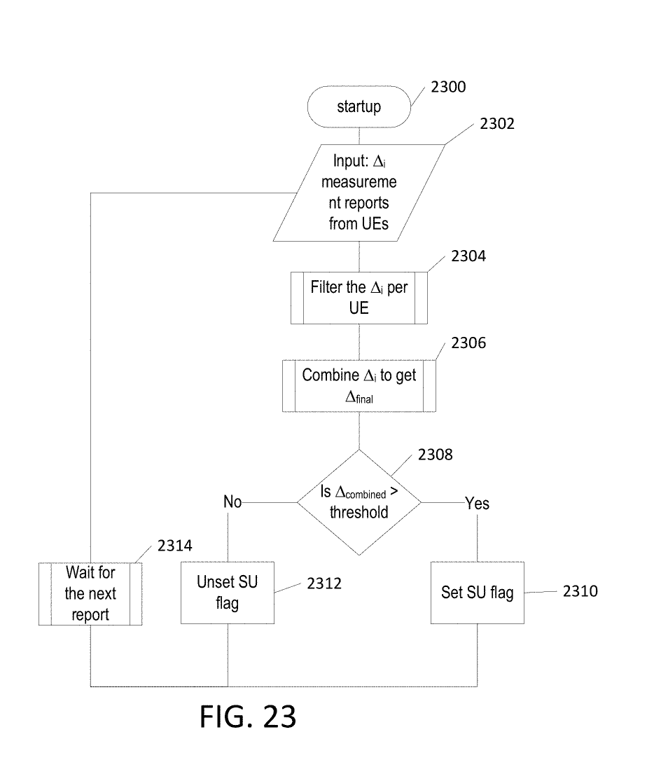

FIG. 23 depicts an example flow chart of a secondary user (SU) detection. Detection may begin at 2300. At 2301, input, that may include Δᵢ measurement reports may be received from one or more UEs. At 2304, the Δᵢ may be filtered per UE. At 2306, Δᵢ may be combined to produce Δ_{final}. At 2308, it may be determined whether Δ_{final} may be greater than a threshold. At 2310, a SU flag may be set Δ_{final} may be greater than a threshold. At 2312, a SU flag may be unset Δ_{final} may not be greater than a threshold. At 2314, the method may wait for another report.

Detection of a secondary user may occur using nominal interference measurements. A UE may report the nominal interference values P_{ON}^{int} and P_{OFF}^{int} instead of Δ. The (H)eNodeB may compute A from the interference measurements. A procedure may be used for secondary user detection. For example, a UE may estimate the average interference during the ON duration. The interference power may be computed on the specified REs in one or more subframes and may be averaged over the subframes during the ON period (P_{ON}^{int}).

A UE may estimate the average interference during the OFF duration. The interference power may be computed on the REs in a subframe and may be averaged over the subframes during the OFF period (P_{OFF}^{int}). If the reporting period may be CPP, P_{ON}^{int} and P_{OFF}^{int} may be reported CPP. If the reporting period may be k-CPPs, P_{ON}^{int} and P_{OFF}^{int} may be collected for k CPPs, one set of P_{ON}^{int} and P_{OFF}^{int} for a CPP, the k sets of P_{ON}^{int} and P_{OFF}^{int} may be filtered (for example, by averaging) and may be reported on a k-CPP.

When P_{ON}^{int} and P_{OFF}^{int} are reported a number of procedures may be performed. For example, the most recent N sets of P_{ON}^{int} and P_{OFF}^{int} may be filtered by the Home eNodeB to compute a value for an interference term per UE, P_{ON}^{int}^{_}^{final} and P_{OFF}^{int}^{_}^{final}. Δ=P_{OFF}^{int}^{_}^{final}−P_{ON}^{int}^{_}^{final} may be computed by the Home eNodeB. If Δ>Δ_{high} threshold, the Home eNodeB may decide that there may be a secondary network detected. If Δ<Δ_{high threshold}, the Home eNodeB may decide that there may be a secondary network that may not be detected. This may occur due to the absence of a SU, or for a secondary user/network that may be located further away from the network, which may create low levels of interference.

As another example, Δ=P_{ON}^{int} and P_{OFF}^{int} may be computed. The most recent N Δs may be filtered by the Home eNodeB to compute a Δ_{final} per UE. If Δ_{final}>Δ_{high threshold}, the Home eNodeB may decide that there may be a secondary network detected. If Δ_{final}<Δ_{high threshold}, the Home eNodeB may decide that there may be a secondary network that may not be detected. This may occur due to the absence of a SU, or for a secondary user/network that may be located further away from the network, which may create low levels of interference.

Nominal interference reports may be combined from multiple UEs. Reports from different UEs may not reflect the same information. There may be a number of approaches to combine the multiple reports. For example, for a node making a measurement, a Δ may be computed for one or more UEs and these Δs may be combined as disclosed herein. As another example, interference measurements from nodes may be combined and a decision may be based on the combined interference measurement. As an example, ΣₖP_{ON}^{int}^{_}^{final} and, ΣₖP_{OFF}^{int}^{_}^{final} may be used to compute the final Δ, where k may be the UE index.

RSRP/RSRQ and/or interference measurements may be used to detect secondary users. Δ may not indicate the existence of a secondary user, such as an aggressive non-cooperative LTE transmitter. Under such circumstances, the RSRP/RSRQ and/or other interference measurements may be used to determine how bad the interference from the secondary transmitter may be. If RSRP/RSRQ may not be available, then the interference measurement (not the Δ but the nominal interference during the ON periods, i.e, P_{ON}^{int}) may be used for this purpose. If the interference level may be above an acceptable level, the carrier may be deactivated or evacuated until the conditions improve.

A mechanism similar, such as a mechanism for an A2 event in LTE, may be used to determine if conditions may have improved. For example, the mechanism for an A2 event may be used to assess the channel quality and deactivate/evacuate a channel if the quality may be unacceptable.

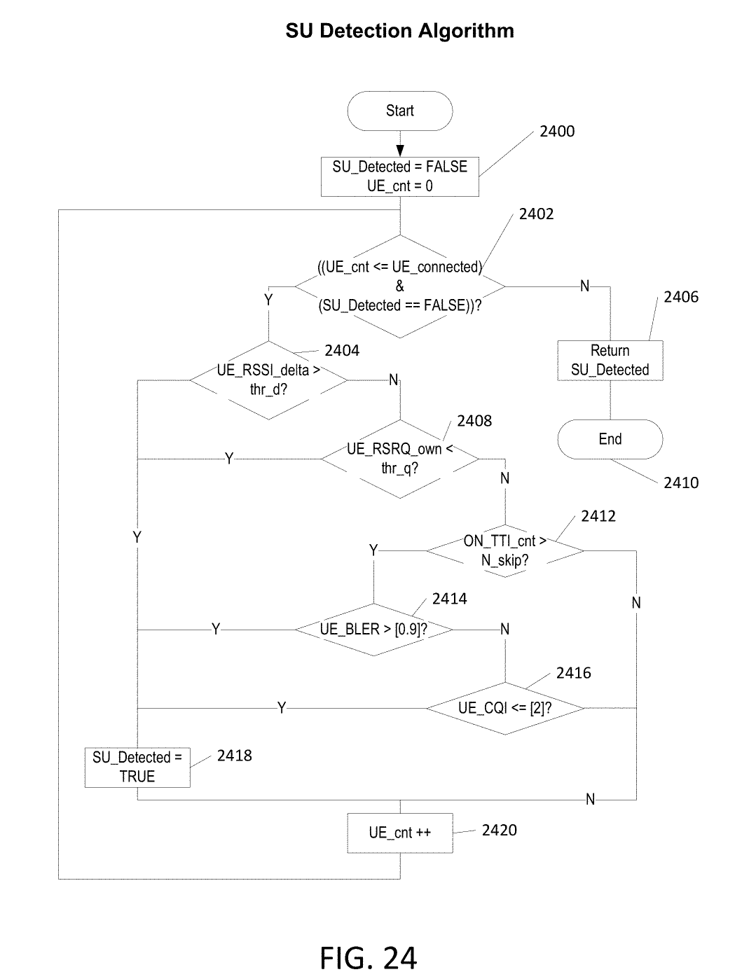

FIG. 24 is an example of a SU detection embodiment. Detection based on Δ and RSRP/RSRQ or other interference measurements from connected UEs may be combined for use in a detection algorithm. At 2404, Δ may be used to detect a secondary user. If Δ may not provide information about secondary users, for example Δ may be less than a threshold, then channel quality may be assessed using RSRQ and/or interference measurement reports from the UEs at 2408. If RSRQ may be below a threshold (or interference may be above a threshold), then a secondary user detect flag may be set at 2418. If, RSRQ may not be below the threshold (or interference may not be above the threshold), then BLER and CQI reports from the UEs may be analyzed at 2412, 2414, and at 2416. If BLER may be greater than 0.9 (or some other level) and/or CQI may be less than or equal to 2 (or some other level), then a secondary user detect flag may be set at 2418. The SU detect flag may be set if conditions that may indicate a secondary user may be satisfied for at least one UE. The loop at 2402 may exit when a UE may signal the SU detect flag, or when all connected UEs may have been polled. At 2420, a UE counter, such as UE_cnt, may be incremented.

SU channel utilization may be estimated using measurements, such as Δ. A number of possible traffic patterns of the secondary network may be considered such as light continuous traffic (video streaming, etc.), heavy traffic, voice over IP (VoIP), HTTP/FTP, or the like.

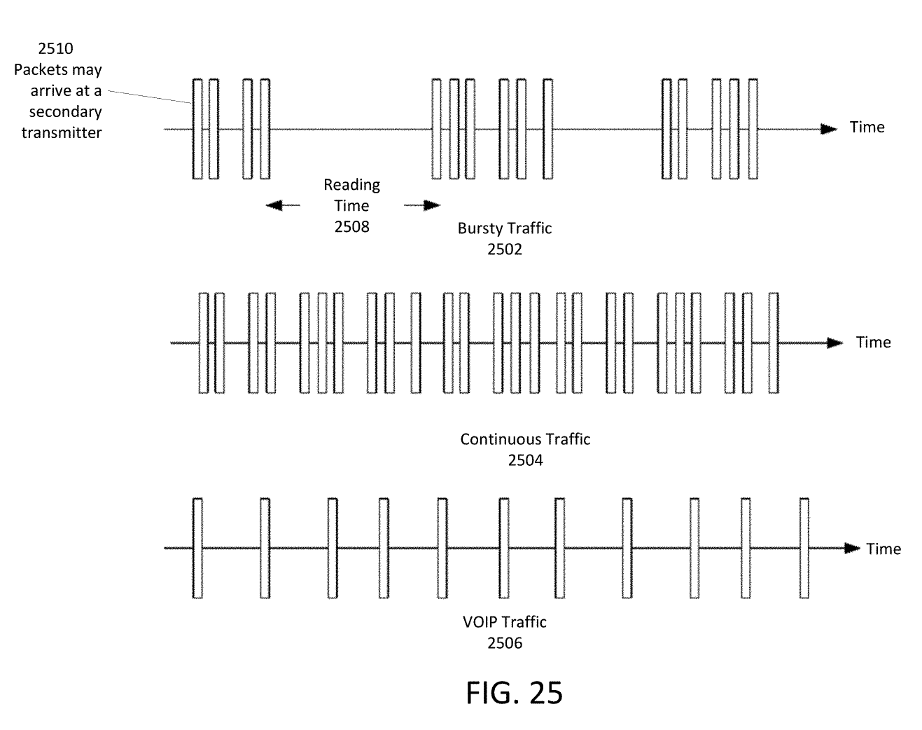

FIG. 25 depicts example packet transmissions for various traffic types, such as bursty traffic at 2502, continuous traffic at 2504, and VoIP traffic at 2506. As shown at 2510, packets may arrive at a secondary transmitter/receiver. In a traffic pattern, the average interference power during the OFF period may vary due to the traffic load. For example, when the load may be high, the secondary transmitter may use the transmission opportunity during the OFF period and the interference may be higher. If the traffic load may be lower, the secondary transmitter may transmit during the OFF period and the average interference may be lower. When the traffic may be HTTP or FTP, long quiet periods, such as periods in the order of seconds, may occur when the interference may be negligible. When the traffic may be VoIP, such as at 2506, the load may be small and the interference during the ON and OFF periods may not be different.

Δ may be used to identify long quiet periods when the secondary transmitter may have HTTP/FTP traffic. During a quiet period, the channel utilization may be increased to the maximum value. If Δ>Δ_{threshold}, the secondary network may have a high load, channel utilization may not be increased beyond and initial level. The threshold may be adjusted depending on the desired aggressiveness. To be conservative, it may be set to a small value. If the secondary network traffic may be VoIP, the channel utilization may not be increased beyond a maximum level. The secondary transmitter may have opportunities to transmit VoIP packets, beacons, or the like.

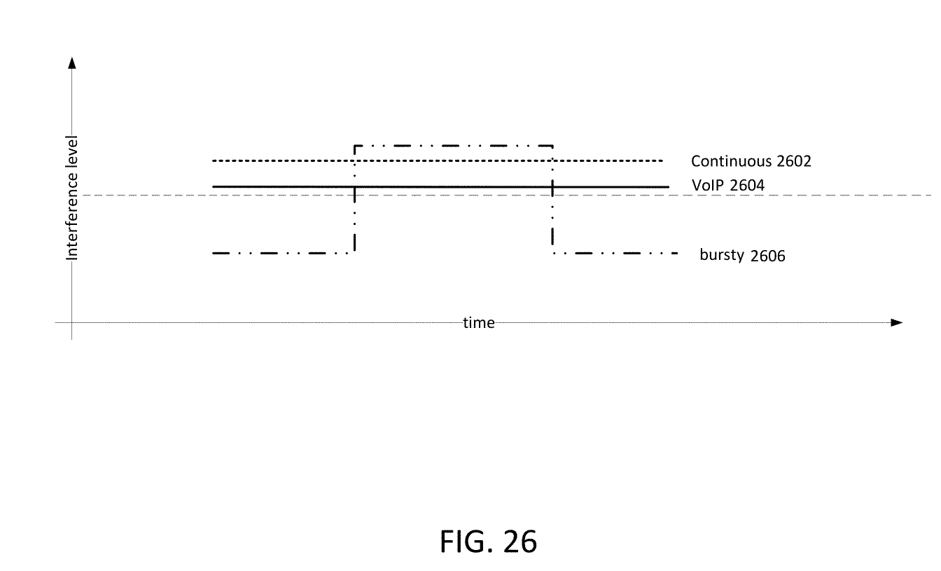

FIG. 26 depicts an example of an averaged interference level for different traffic types. Traffic types may create interference patterns. For example, interference patterns may be seen for continuous traffic at 2602, VoIP traffic at 2604, and bursty traffic at 2606. The utilization of the channel by the secondary network may be estimated from the interference levels as:

Δ>Δ_{high threshold}→High utilization

Δ_{low threshold}<Δ<Δ_{high threshold}→Medium utilization

Δ<Δ_{low threshold}→Low utilization (or secondary user may not be detected)

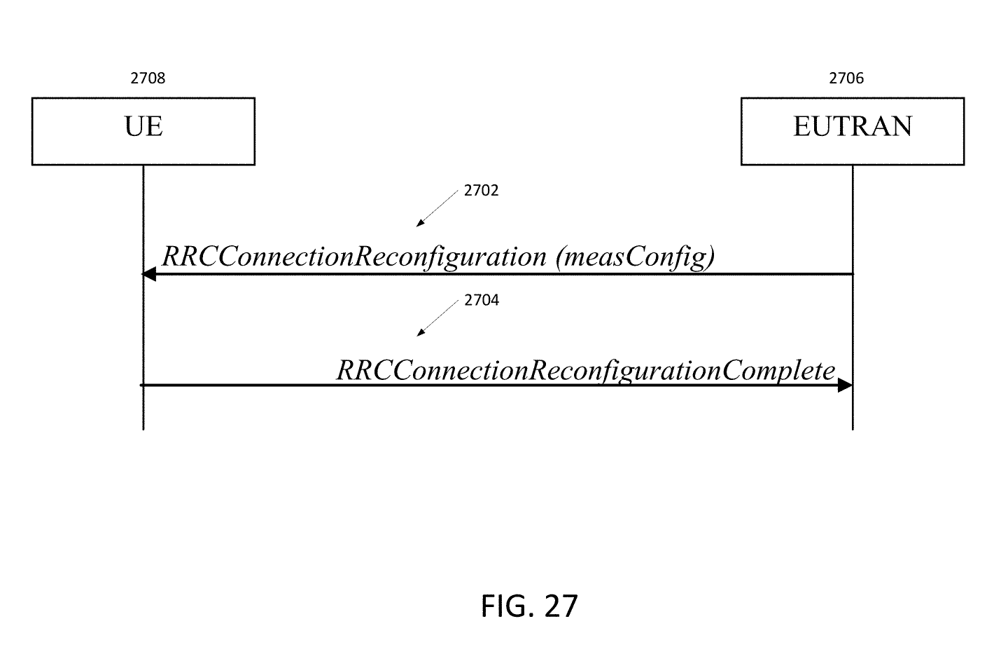

RRC signaling may be used to support measurement configuration and reporting. FIG. 27 depicts an example use of an RRC reconfiguration message. RSSI measurement and reporting may be configured using RRC signaling in a network, such as a 3GPP/LTE network. For example, HeNB may configure measurement by defining “measurement object”, “report config” and a “measurement id”. RRC may start or stop “RSSI” measurement by adding or removing a “measurement id” in an active list of measurements. The “measurement id” may connect a “measurement object” to a “report config.” To add the new measurement configuration, “RRC Connection Reconfiguration” procedure may be used. The reconfiguration procedure may be executed when SuppCells may be added to the “allocated list.” The measurement configuration may be sent when SuppCells may be added. Otherwise, it may be sent through a separate “RRC Connection Reconfiguration” message before or after the SuppCell may be activated.

At 2702, EUTRAN 2706 may transmit an RRCConnectionReconfiguration message to UE 2708. The RRCConnectionReconfiguration message may include an IE “measConfig.” At 2704, UE 2708 may acknowledge the RRCConnectionReconfiguration message by transmitting a RRCConnectionReconfigurationComplete message to EUTRAN 2706.

The IE “measConfig” may include a number of parameters, such as MeasObjectToRemoveList, MeasObjectToAddModList, ReportConfigToRemoveList, ReportConfigToAddModList, MeasIdToRemoveList, MeasIdToAddModList, or the like.

A measurement object may be provided. A measurement object may include the frequency information of the SuppCell. If the object may be present in the UE, then this may not be sent with the measurement configuration. This may occur, for example, when measurement configuration may be sent during supplementary cell activation after the cell may have been added.

A ReportConfig object may be provided. The IE “ReportConfigToAddModList” may be a list of IE “ReportConfigToAddMod,” which may carry “report config” for RSSI measurement. The “report config” may be identified by “ReportConfigId.” An example of ReportConfig may be as follows:

| ReportConfigToAddMod ::= SEQUENCE { | |
|---|---|
| reportConfigId | ReportConfigId, |
| reportConfig | CHOICE { |
| reportConfigEUTRA | ReportConfigEUTRA, |
| reportConfigInterRAT | ReportConfigInterRAT |
| } | |

Details of the report configuration may be included in the “ReportConfigEUTRA” IE. The changes in the IE may include the following:
triggerQuantity: RSSI measurement may be added to the existing list
   “rssi”: rssi measurement during ON or OFF period
   “deltaRssi”: difference between RSSI ON and OFF measurement
reportQuantity: may be left unchanged
For event based reporting, existing events may be reused. New events may be defined and added to the list. To reuse existing events, the definition of the IE “ThresholdEUTRA” may include “threshold-rssi” and “threshold-deltaRssi”.

An example follows:

| | |
|---|---|
| -- ASN1START | |
| ReportConfigEUTRA ::= | SEQUENCE { |
| triggerType | CHOICE { |
| event | SEQUENCE { |
| eventId | CHOICE { |
| eventA1 | SEQUENCE { |
| a1-Threshold | ThresholdEUTRA |
| }, | |
| eventA2 | SEQUENCE { |
| a2-Threshold | ThresholdEUTRA |
| }, | |
| eventA3 | SEQUENCE { |
| a3-Offset | INTEGER (−30..30), |
| reportOnLeave | BOOLEAN |
| }, | |
| eventA4 | SEQUENCE { |
| a4-Threshold | ThresholdEUTRA |
| }, | |
| eventA5 | SEQUENCE { |
| a5-Threshold1 | ThresholdEUTRA, |
| a5-Threshold2 | ThresholdEUTRA |
| }, | |
| ..., | |
| eventA6 | SEQUENCE { |
| a6-Offset | INTEGER (−30..30), |
| a6-ReportOnLeave | BOOLEAN |
| } | |
| }, | |
| hysteresis | Hysteresis, |
| timeToTrigger | TimeToTrigger |
| }, | |
| periodical | SEQUENCE { |
| purpose | ENUMERATED { |
| | reportStrongestCells, reportCGI} |
| } | |
| }, | |
| triggerQuantity | ENUMERATED {rsrp, rsrq, rssi, deltaRssi}, |
| reportQuantity | ENUMERATED {sameAsTriggerQuantity, both}, |
| maxReportCells | INTEGER (1..maxCellReport), |
| reportInterval | ReportInterval, |
| reportAmount | ENUMERATED {r1, r2, r4, r8, r16, r32, r64, infinity}, |
| ..., | |
| [[ si-RequestForHO-r9 | ENUMERATED {setup} OPTIONAL, -- Cond reportCGI |
| ue-RxTxTimeDiffPeriodical-r9 | ENUMERATED {setup} OPTIONAL -- mqy request OR |
| ]], | |
| [[ includeLocationInfo-r10 | ENUMERATED {true} OPTIONAL, -- Cond reportMDT |
| reportAddNeighMeas-r10 | ENUMERATED {setup} OPTIONAL -- may request OR |
| ]] | |
| } | |
| ThresholdEUTRA ::= | CHOICE{ |
| threshold-RSRP | RSRP-Range, |
| threshold-RSRQ | RSRQ-Range, |
| threshold-RSSI | RSSI-Range, |
| threshold-deltaRSSI | deltaRSSI-Range |
| } | |
| -- ASN1STOP | |

A measurement ID object may be provided. The IE “MeasIdToAddMod” may not require any change. The HeNB may create a “measID” and may include “measObjectId” and “reportConfigId” for the SuppCell. An example follows:

| | |
|---|---|
| -- ASN1START | |
| MeasIdToAddModList ::= | SEQUENCE (SIZE (1..maxMeasId)) OF |
| Meas IdToAddMod | |

MeasIdToAddMod ::= SEQUENCE {

| | |
|---|---|
| measId | MeasId, |
| measObjectId | MeasObjectId, |
| reportConfigId | ReportConfigId |
| } | |

Listen before talk (LBT) and coordination with coexistence gaps may be provided. In systems where LBT may be used to assess channel availability before accessing the channel, coordination between LBT and coexistence gaps may be requested. A target channel usage ratio may be provided. The target channel ratio may be a ratio that may allow usage of the available channel bandwidth and enable channel sharing with other secondary users.

LBT and coexistence gaps for TDM systems in dynamic shared spectrum bands may be provided. LBT at the end of a coexistence gap may be provided.

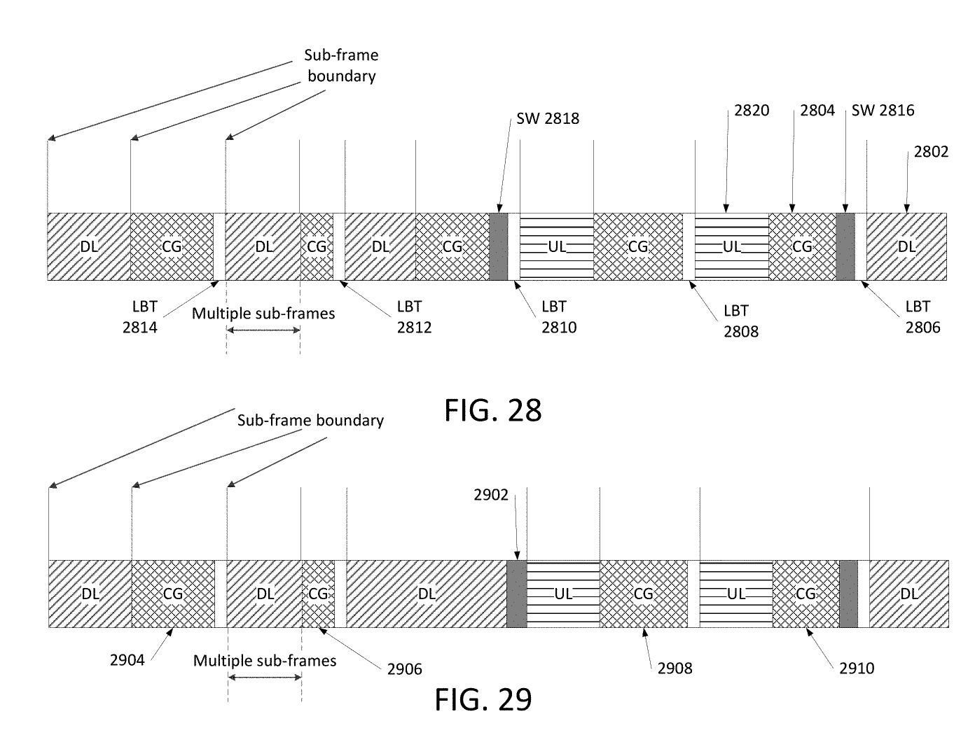

FIG. 28 depicts an example downlink (DL)/uplink (UL)/coexistence gap (CG) pattern that may be with listen before talk (LBT). As shown in FIG. 28, for systems using TDM to switch between UL and DL in the same dynamic shared spectrum channel, a general pattern of DL, UL coexistence gaps (CG) using LBT may be used. The generic pattern may be applicable to TDM systems using, for example, both LTE frame format 1 and frame format 2.

As shown in FIG. 28, a DL, such as DL 2802, may be a sub-frame of a LTE downlink transmission. A CG, such as CG 2804, may be one or more sub-frames of a coexistence gap, where no LTE transmission may take place. A LBT, such as LBT 2806, LBT 2808, LBT, 28010, LBT 2812, and LTB 2814, may be a time to perform an energy detection for LBT, which may be on the order of 1 or 2 OFDM symbols. Radio switch time, SW, such as SW 2816 and 2818, may be a radio switch time for DL to UL transitions, for UL to DL transitions, or the like. A SW may be 10 to 20 us. A UL, such as UL 2820, may be one or more sub-frames of a uplink LTE transmission.

As shown in FIG. 28, coexistence gaps, such as CG 2804, may be inserted during downlink transmission bursts, during uplink transmission bursts, during DL to UL transitions, during UL to DL transitions, or the like. LBT may be performed upon return from a coexistence gap, such as at LBT 2810, to assess channel availability.

FIG. 29 depicts an example DL to UL switch that may without LBT. DL to UL switch without LBT. For femtocell deployments and systems that may be operating TDM in the dynamic shared spectrum band, LBT may not be performed for the DL to UL transition. For example, LBT may not be performed at 2902. Because DL transmit power of the femto/HeNB may be high, other SU in the cell may find the channel busy and may not gain access to the channel. To avoid a request for LBT on the DL to UL transition, a pattern may be used where no coexistence gap may be allocated at the DL to UL transition. A target channel usage ratio may be achieved by scheduling coexistence gaps within the DL transmission bursts, the UL transmission bursts, or both. Coexistence gaps may not be scheduled between a DL and an UL burst. For example, CGs may be scheduled at 2904, 2906, 2908, and 2910.

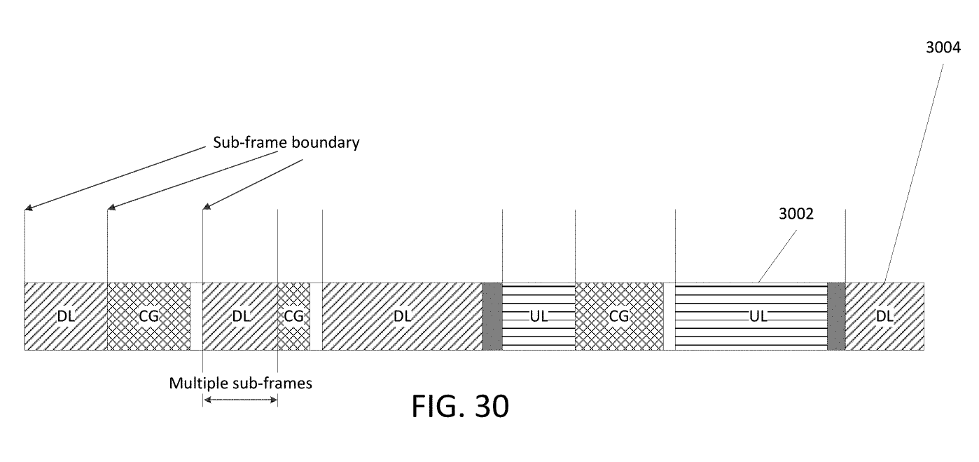

FIG. 30 depicts an example UL to DL switch that may be without LBT. For femtocell deployments and systems that may be operating TDM in the dynamic shared spectrum band, LBT may not be performed during a UL to DL transition. To enable this, a coexistence gap may not be inserted between and UL and a DL transmission burst, such as the transition between UL 3002 and DL 3004. The transition between the UL and DL may be possible without LBT because in a small deployment, such as a femto cell type deployment, localized interference may not occur. UL transmissions by the UEs may keep the channel occupied by the current LTE system and may not allow other SU to access the channel.

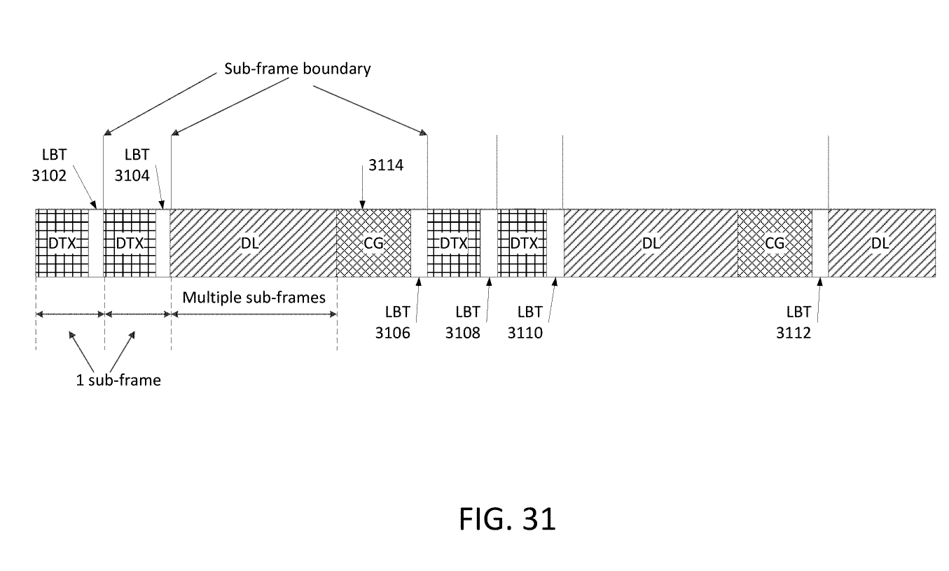

FIG. 31 depicts an example dynamic aperiodic coexistence pattern for frequency division duplex (FDD) DL. LBT and coexistence gaps for FDD DL systems in dynamic shared spectrum bands may be provided, such as LBT 3102, 3104, 3106, 3108, 3110, and 3112. As shown in FIG. 31, LBT may be performed upon return from a coexistence gap. For example, LBT 3106 may be performed after CG 3114. If, upon performing LBT, the channel may be found busy, then no DL transmission may follow, and the following sub-frame may become an extension to the scheduled coexistence gap. The additional sub-frame(s) where no DL transmission occurs (because LBT found the channel busy) may be incorporated in the calculation of the current channel usage ratio as is further described herein and may be accounted for to reach a desired target channel usage ratio. If upon performing LBT, the channel may be found available, then DL transmission may start at the sub-frame boundary.

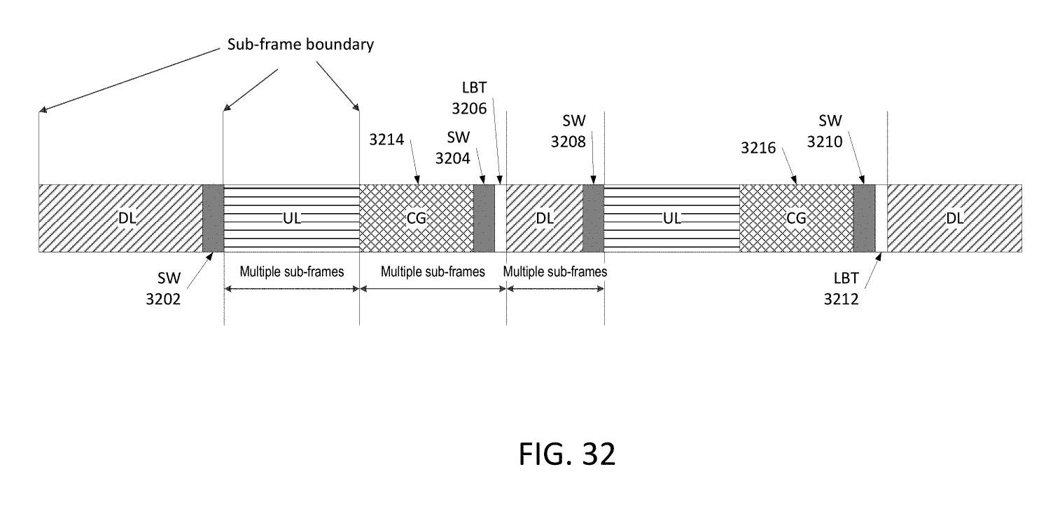

Methods may be used to dynamically schedule coexistence gaps and set gap durations. FIG. 32 depicts an example scenario with CG inserted after a UL burst and before a DL burst. Methods may be used to dynamically schedule coexistence gaps and set the gap durations, for example, to reach the target channel usage ratio. As shown in FIG. 32, coexistence gaps, such as at 3214 and at 3216, may be inserted after an UL burst and before a DL burst.

Although FIG. 32 may depict a scenario where coexistence gaps may be inserted after an UL burst and before a DL burst, it may easily be extended for other scenarios. For example, the method may be extended to a case where the system operates as FDD DL in the dynamic shared spectrum band.

A number of variables and parameters may be used to describe a coexistence gap algorithm, such as CG_len, T_elg, Chan_use_ratio, CCA_counter, LBT_ED_thr, target_chain_use_ratio, CG_delta_t_max, CCA_num_retry, max_ED_thr, or the like. CG_len may be a length of the coexistence gap, in units of sub-frames. The gap length may be larger than an amount of time the Wi-Fi may request to gain access to the channel. Parameter t_elg may be a time elapsed since a last gap, which may be in units of sub-frames and may be measured from the end of the last gap, which may be a gap or DTX. Parameter_chap_use_ratio may be an actual channel usage ratio by the current LTE system. Parameter CCA_counter may be a count of a number of retries when attempting to access the channel using LBT. Parameter LBT_ED_thr may be an energy detection threshold for LBT. If the measured energy may be larger than the LBT_ED_thr threshold, the channel may be deemed busy.

Parameter Target_chan_use_ratio may be a target channel use ratio. This parameter may reflect the percentage of time the eNB/HeNB may occupy the channel, and may reflect how friendly a (H)eNB may be when coexisting with other secondary users. A target channel usage ratio of x % may mean that the LTE system may occupy the channel for x % of the time, and may allow other secondary users to occupy the channel up to (100−x)% of the time.

Parameter CG_delta_t_max may be a maximum time between coexistence gaps, which may be in units of sub-frames. It may be measured from the end one coexistence gap, to the start of the following coexistence gap. To coexist with Wi-Fi, this value may be smaller than the Wi-Fi re-establishment time. Parameter CCA_num_retry may be a number of retries before increasing the LBT energy detection threshold if adaptive LBT ED threshold may be used. Parameter max_ED_thr may be a maximum threshold for energy detection for LBT. If the adaptive energy detection threshold (LBT_ED_thr) may be larger than the maximum (max_ED_thr), then the channel may be deemed busy.

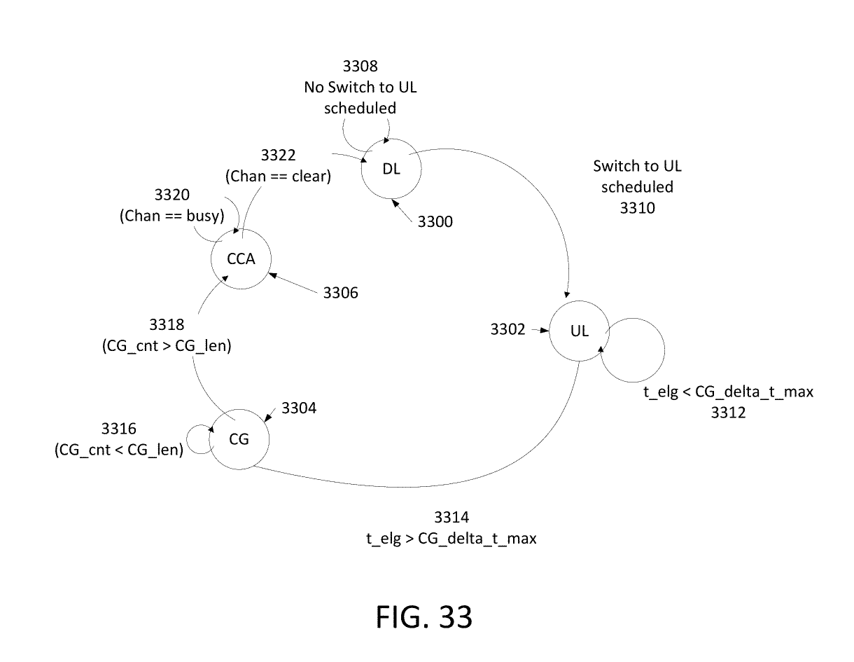

FIG. 33 depicts an example state machine for (H)eNB processing. The example state machine may be used for an algorithm for (H)eNB processing. At 3300, the (H)eNB may be in a DL state. At 3308, if no switch to a UL state may have been scheduled, the (H)eNB may stay in the DL state at 3300. At 3310, a switch to a UL may be scheduled and at 3302, the (H)eNB may be in a UL state. At 3312, if t_elg may be less than CG_delta_t_max, the (H)eNB may stay in the UL state at 3302. At 3314, if t_elg is greater than CG_delta_t_max, the (H)eNB may enter a CG state at 3304. At 3316, if CG_cnt is less than CG_len, the (H)eNB may stay in the CG state at 3304. At 3318, if CG_cnt is greater than CG_len, the (H)eNB may enter the CCA state at 3306. At 3320, if a channel is busy, the (H)eNB may stay in the CCA state 3306. At 3322, if the channel is, the (H)eNB may enter the DL state at 3300.

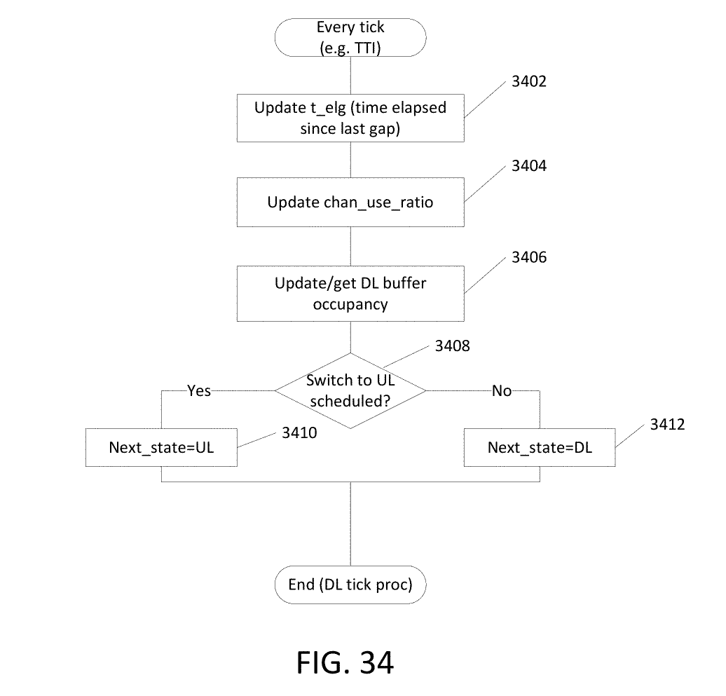

FIG. 34 depicts example flow charts of processing while in a DL transmission state. DL may be a DL transmission burst or state of the (H)eNB state machine. The system may be in the DL mode state until a transition to UL may be scheduled as determined, for example, by the LTE traffic needs.

As shown in FIG. 34, at 3402 it may be determined if a time elapsed since the last gap and parameter t_elg may be updated. At 3404, parameter chan_use_ratio may be updated. At 3406, a DL buffer occupancy may be updated or received. At 3408, it may be determined whether a UL may have been scheduled and whether the (H)eNB may be switched to a UL state. At 3410, the (H)eNB may be set to switch to a UL state by setting next_state to UL. At 3412, the (H)eNB may be set to stay in a DL state by setting next_state to DL.

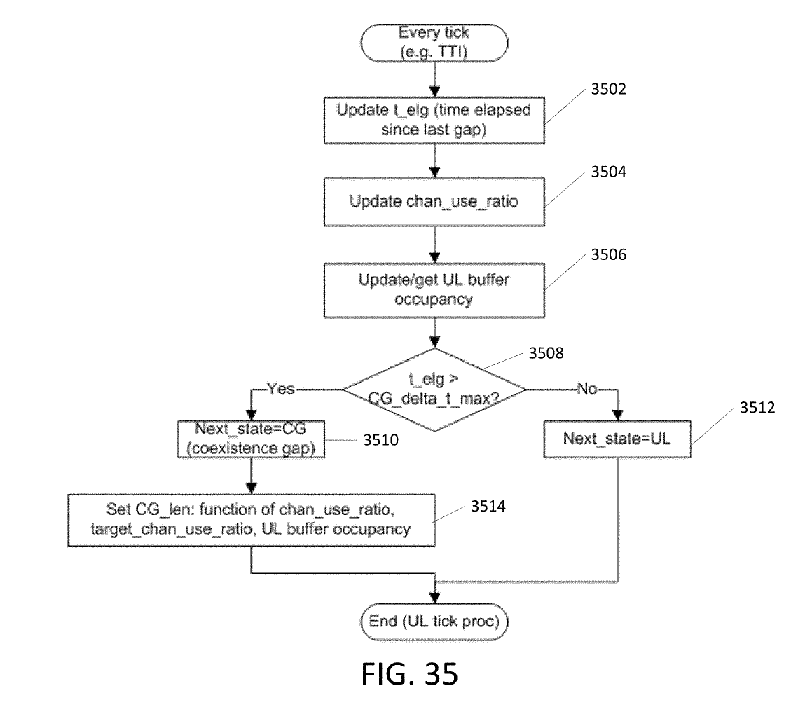

FIG. 35 depicts example flow charts of processing while in a UL transmission state. If the time elapsed since a last gap exceed a predefined threshold, the next state may be set to be the CG state. The length of the coexistence gap (e.g. CG_len) may be determined as a function of the current channel usage ratio Chan_use_ratio, target channel usage ratio (target_chan_use_ratio) and UL buffer occupancy. This may allow longer coexistence gaps and may allow Chan_use_ratio to be larger than the target for a time to alleviate potential UL congestion.

At 3502, a time may have elapsed since the last gap and t_elg may be updated. At 3504, chan_use_ratio may be updated. At 3506, a UL buffer occupancy may be updated or retrieved. At 3508, it may be determined whether t_elg may be greater than CG_delta_t_max. At 3510, if t_elg may be greater than CG_delta_t_max, next_state may be set to CG. At 3512, if t_elg may not be greater than CG_delta_t_max, next_state may be set to UL. At 3513, CG_len may be set as a function of chan_use_ratio, target_chan_use_ratio, and UL buffer occupancy.

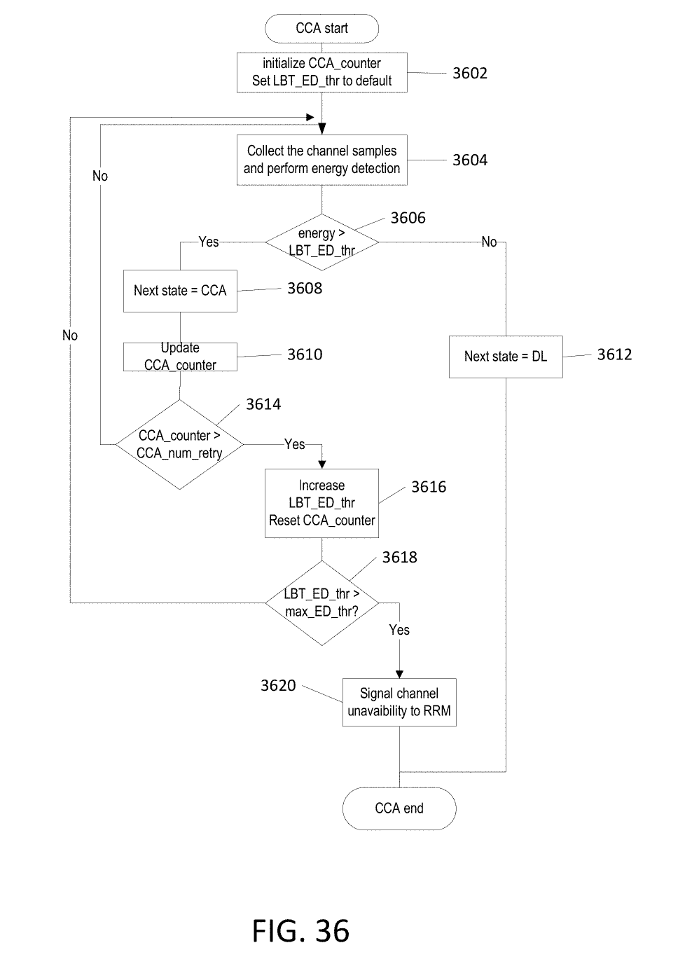

FIG. 36 depicts example flow charts of processing while in a clear channel assessment (CCA) state. Upon return from the CG state, the system may transition to the CCA state (clear channel assessment). To achieve a channel usage ratio, when the LBT finds the channel busy, the next sub-frame may be accounted for as a coexistence gap. The LBT threshold may be increased upon a number of consecutive unsuccessful attempts to access the channel.

At 3602, CCA_counter may be initialized and LBT_ED_thr may be set to a default value. At 3504, channel samples may be collected and an energy detection may be performed. At 3606, it may be determined that the energy may be greater than LBT_ED_thr. At 3612, if the energy may not be greater than LBT_ED_thr, next_state may be set to DL. At 3608, if the energy may be greater than LBT_ED_thr, next_state may be set to CCA. At 3610, a CCA counter may be updated. At 3613, it may be determined whether CCA_counter may be greater than CCA_num_retry. If CCA_counter may not be greater than CCA_num_retry, the method may proceed to 3604. If CCA_counter may be greater than CCA_num_retry, LBT_ED_thr may be increased and CCA_counter may be reset at 2616. At 3618, it may be determined whether LBT_ED_thr may be greater than max_ED_thr. If LBT_ED_thr may not be greater than max_ED_thr, the method may proceed to 3604. If LBT_ED_thr may be greater than max_ED_thr, channel unavailability may be signaled to RRM at 3620.

A hybrid LBT may be provided. In the hybrid LBT method, measurements may be performed periodically to assess the quality of the channel, and the decision to access the channel may be made based on a combination of filtered measurements and reports that may have been generated in the past N sensing periods, and LBT energy detection.

The periodic measurements may provide information about the type of other secondary networks that may be using the same channel and whether these networks may be trying to coexist or not, interference pattern, or the like. When LBT energy detection may be used, the information from the filtered periodic measurements may be used to adapt the LBT parameters, such as the sensing threshold, duration of a transmission burst, length of long coexistence gaps, or the like. In addition, LBT energy detection may be enabled or disabled based on this information. This may be a hybrid approach where LBT energy detection may be used to control the instantaneous channel access, while measurements may provide input to adapt the LBT parameters and choose an appropriate transmission mode.

Based on the sensing output, a number of modes may be provided. For example, the modes may be an exclusive use of the channel, a friendly use of the channel, an aggressive use of the channel or the like. An exclusive use of the channel nay be a mode of transmission where there may not be other secondary nodes operating in the channel. Sensing threshold and duration of transmission bursts may be set to their maximum values. Long coexistence gaps may be disabled or scheduled less frequently. A friendly use of the channel may be a mode where other secondary nodes operating in the same channel may try to coexist. The coexistence parameters may be set so that channel may be shared by these users while performance criteria may be met. Aggressive use of the channel may be a mode where a secondary node that may be aggressively using the channel without attempting to coexist. If the minimum achievable throughput may be above a threshold and there may be no other channel to switch the traffic into, then the transmitter may start using the channel aggressively with the hope that some data may be squeezed through the pipe. If the aggressive node may be the dominant user, the coexistence parameters may be set similar to the exclusive use mode. For example, a high sensing threshold and long burst duration may be set and long coexistence gaps may be disabled. If there may be other secondary users that may be trying to coexist in addition to the aggressive user, long coexistence gaps may be enabled and duration of transmission bursts may be reduced to accommodate these users.

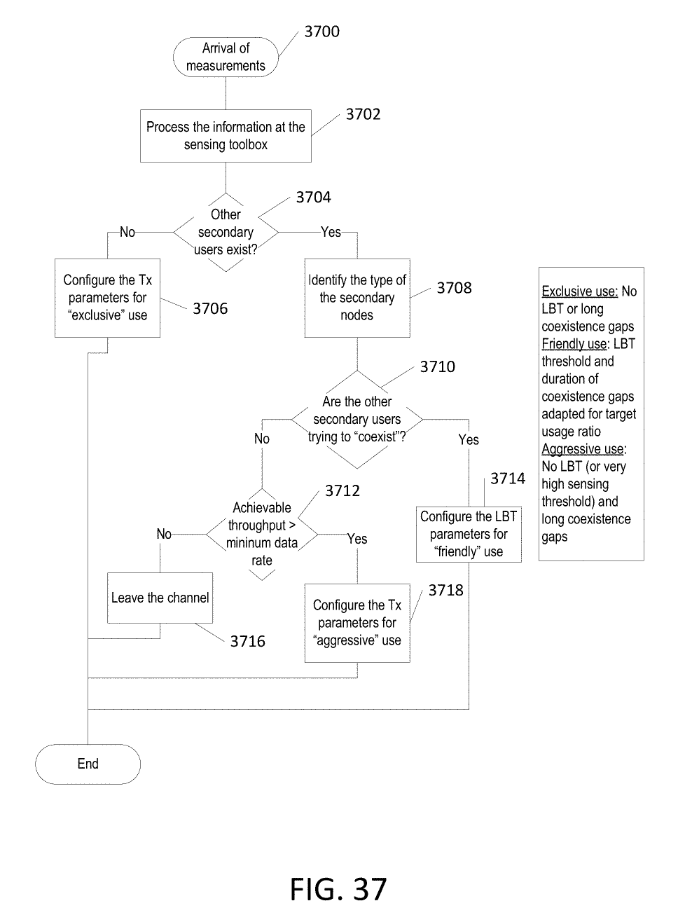

FIG. 37 depicts an example decision of transmission mode. At 3700, measurements may be received. At 3702, information may be processed at the sensing toolbox. At 3704, it may be determined whether other secondary users may exist. At 3706, if other secondary users may not exist, Tx parameters may be configured for exclusive use. At 3708, if other secondary users may exist, the type of secondary nodes may be identified. At 3710, it may be determined whether the other secondary users may be trying to coexist. If the other secondary users may be trying to coexist, then at 3714, the LBT parameters may be configured for friendly use. If the other secondary users may not be trying to coexist, then at 3712, it may be determined whether the achievable throughput may be greater than a minimum data rate. If the achievable throughput may not be greater than a minimum data rate, then the channel may be vacated at 3716. If the achievable throughput may be greater than a minimum data rate, then the Tx parameters may be configured for aggressive use.

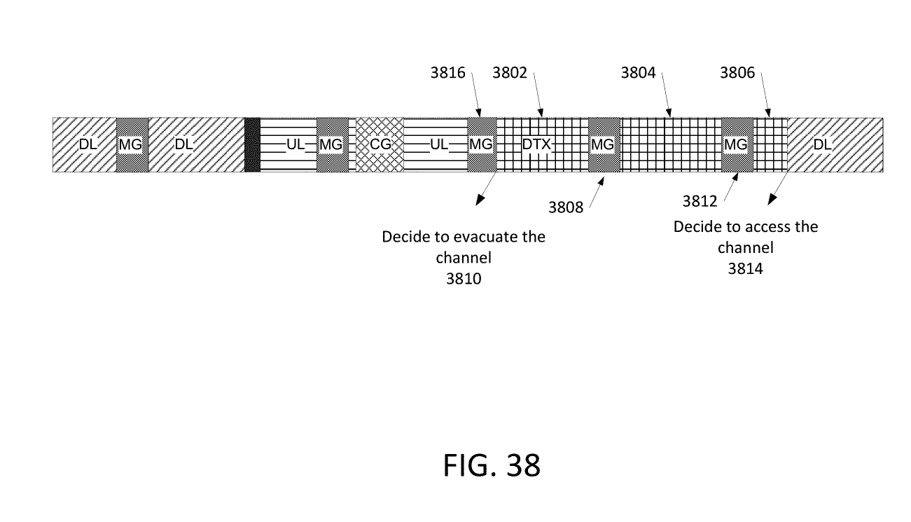

FIG. 38 depicts example measurements that may be based on a channel access mechanism. In a hybrid approach, channel access may depend on periodic measurements, which may be referred to as measurements based channel access. In this approach, periodic measurements may be used to assess the channel quality and decide whether to continue operating on the channel or not. Sensing may be done at the base station and reports from the UEs may be collected. As an example, sensing may be employed for 1 ms over 10-20 ms. The measurements may be reported via a licensed bands, which may have higher reliability.

As shown in FIG. 38, measurement gaps may be scheduled during DL and/or UL transmission bursts. There may not be a transmission during a measurement gap, which may allow the quality of the channel to be assessed. In the example shown, at measurement gap (MG), the channel may be found to be not good enough for transmission and a decision may be made to evacuate the channel at 3810. Transmission may terminate, for example at DTX 3802. During the following phase, such as at 3804 and 3806, measurements may be taken at 3808 and 3812. At 3814, a decision may be made whether the channel may be accessed. If the channel may be found to be suitable for transmission, transmission may resume.

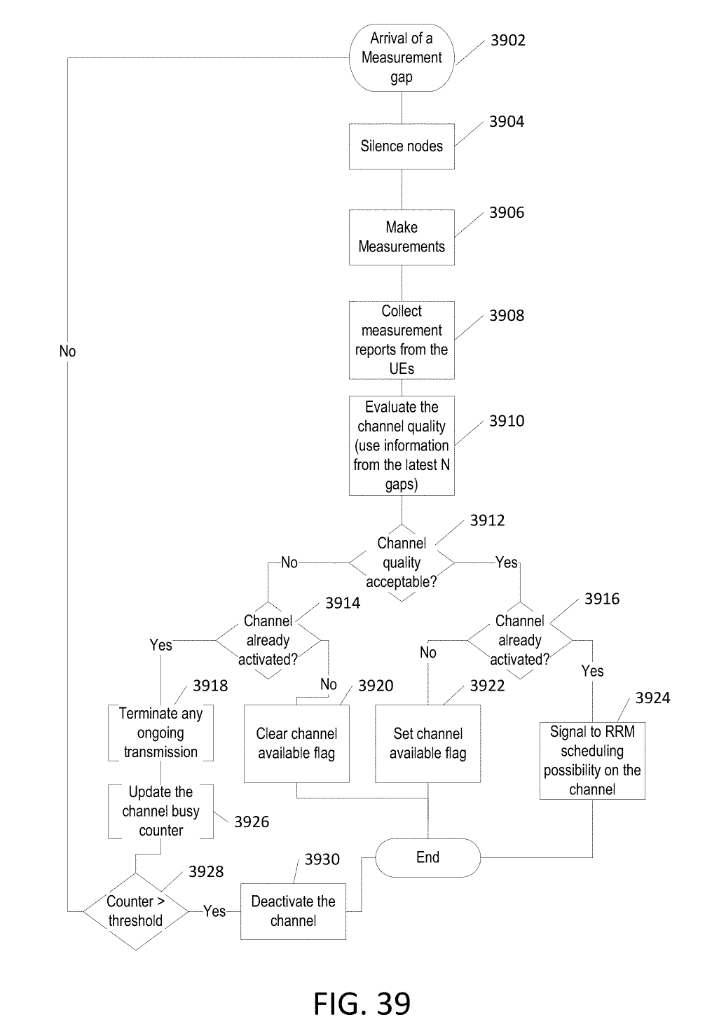

FIG. 39 depicts an example flow diagram for measurements that may be based on channel access. At 3902, it may be determined whether a measurement gap may have arrived. At 3904, if a measurement gap may have arrived, nodes may be silenced. At 3906, measurements may be taken. At 3908, measurement reports may be collected from one or more UEs. At 3910, channel quality may be evaluated using, for example, information from the latest N gaps. At 3912, a determination may be made as to whether the channel quality may be acceptable. If channel quality is acceptable, it may be determined whether the channel may have been activated at 3916. If the channel may have been activated, a signal may be sent to RRM that scheduling may be possible on the channel at 3924. If the channel may not have been activated, a channel available flag may be set at 3922.

If channel quality may not have been determined to be acceptable at 3912, it may be determined whether the channel may have been activated at 3914. If the channel may not have been activated, a clear channel available flag may be set at 3920. If the channel may have been activated, ongoing transmission may be terminated at 3918 and a channel busy counter may be updated at 3926. At 3928, it may be determined whether the channel busy counter may be greater than a threshold. If the channel busy counter may be greater than a threshold, the channel may be deactivated at 3930. If the channel busy counter may not be greater than a threshold, the method may proceed to 3902.

A method may be provided for transmitting an LTE-based signal in a dynamic shared spectrum band that may use a coexistence pattern. Coexistence gaps in the coexistence pattern may provide opportunities for other secondary networks to operate in the same band. The coexistence pattern may provide opportunities for other radio access technologies (RAT) of a multi-RAT UE to operate. This may be done, for example, to permit coexistence of multiple RATs in the same cell.

The coexistence pattern may have a coexistence gap period, may have an ON period, and may have an OFF period. During the coexistence gap period no data, control, or reference symbols may be transmitted. For example, the LTE-based cell may be silent during gaps in the coexistence pattern. LTE-based transmissions may be resumed during the ON period without attempting to assess the channel availability. The coexistence pattern may include periodic ON-OFF transmissions. The on period may be an LTE ON duration of the coexistence pattern and may be shared between downlink and uplink LTE-based transmissions. A Gap Period may last a configured amount of time or a fixed time, such as the beginning of the next frame.

The coexistence pattern may be dynamically adjusted. A period of the coexistence pattern may be denoted by CPP, and may be as follows:

CPP=T_{ON}+T_{OFF}

A duty cycle of the coexistence pattern may be as follows:

$$CPDC = \frac{{T}_{ON}}{{T}_{ON} + {T}_{OFF}}$$

A period parameter of the coexistence pattern may be a static parameter. A coexistence period parameter may be configured during SuppCC set-up. A coexistence pattern duty cycle (CPDC) may be adjusted and may be a semi-static parameter. The CPDC may be altered in response to traffic volume, and/or presence of secondary users. One or more LTE traffic thresholds may be used to determine/adjust the CPDC. A WiFi detection parameter may be used to determine/adjust the CPDC. WiFi detection and/or WiFi traffic load may be determined by a sensing engine.

A duty cycle signal may be transmitted from a base station, Home eNodeB, or eNodeB. The duty cycle signal may be received at a WTRU. A WTRU may enter a DRX period. Channel estimation on default CRS locations may cease. Duty cycle signaling may include one or more of PHY, MAC and RCC methods for signaling the duty cycle. PHY methods may include one or more methods selected from the group of primary synchronization signal (PSS), secondary synchronization signal (SSS). A PSS/SSS signaling may be repeated at least once per frame. Duty cycle signaling may be sent by placing the PSS and SSS in different sub-frames. Duty cycle signaling may include MIB based signaling of the duty cycle, PDCCH based signaling, MAC CE based signaling, or the like.

Duty cycle signaling may be PDCCH based signaling. One or more Duty Cycle Bits on the PDCCH may be used to signal the beginning of a gap. The PDCCH signaling may be present on the Primary Cell PDCCH or the Supplementary Cell PDCCH.

Duty cycle signaling may be MAC CE based signaling. Contents of the MAC CE may include one or more of an ID, a new value of the duty cycle, and timing information indicative of when the change may be effective. The contents of the MAC CE may include an ID, the new value of the duty cycle, and timing information that may indicate when the change may apply. An example of the message contents may include a LCID, a new duty cycle, frame timing information, a combination thereof, or the like. An LCID (which may be a 5 bit message ID), may include a MAC header element and may use reserved LCID values 01011 to 11010 (or any other unused message ID). A new duty cycle may be a field that may be 2 to 4 bits depending on the number of supported duty cycles. A frame timing information may be two bit such that 00 may apply to the current frame n, 01 may apply to the next frame n+1, 10 may apply to the next frame n+2, and/or 11 may indicate that a change may have already occurred (possible in the case of retransmissions).

A method may be provided to obtaining measurements for SU detection. UEs make measurements during both the ON and OFF periods. A UE may transmit a report that may include following values:

Δ=P_{OFF}^{int}−P_{ON}^{int} (or −Δ)

P_{ON}^{int} and P_{OFF}^{int}

A Δ may be reported more often than P_{ON}^{int} and P_{OFF}^{int}. Parameters Δ and/or P_{ON}^{int} and P_{OFF}^{int} may be filtered at the UE and/or at the Home eNodeB.

A method may be provided for transmitting an LTE-based signal in a dynamic shared spectrum band using a coexistence gap or pattern. The transmitter may utilize a Listen Before Talk (LBT) methodology in coordination with the coexistence gaps or patterns. A transceiver may assess the channel availability before using the channel. A target channel usage ratio may be used to access the available channel bandwidth. A current channel usage ratio that may include an additional sub-frame(s) where no DL transmission may occur may be calculated. A TDM channel structure may be used. LBT may be performed at the end of a coexistence gap.

A switch may be made between UL and DL or DL and UL in the same dynamic shared spectrum channel. Pattern coexistence gaps that may use LBT may include coexistence gaps that may be inserted during downlink transmission bursts, during uplink transmission bursts, or the like. LBT may be performed upon return from a coexistence gap to assess channel availability. A DL to UL switch may occur without LBT and a gap pattern may not include a coexistence gap at the DL to UL transition.

Coexistence gaps may be scheduled within a DL transmission bursts, or a UL transmission bursts, or both. Coexistence gaps may not be scheduled between a DL and an UL burst. A UL to DL switch may be performed without LBT where a coexistence gaps may not be inserted between an UL and a DL transmission burst.

A transceiver may be in FDD DL in a dynamic shared spectrum band and may use a coexistence pattern such that LBT may be performed upon return from the coexistence gap. If LBT may be performed when the channel may be busy, then no DL transmission may follow, and the following sub-frame may be, an extension to the scheduled coexistence gap. If LBT may be performed and the channel may be available, DL transmission may start at the sub-frame boundary.

Coexistence gaps may be dynamically scheduled and/or gap durations may be dynamically set. The coexistence gaps and the gap durations may be dynamically scheduled based at least in part on a target channel usage ratio.

A channel structure in an LTE dynamic shared spectrum transmission where coexistence gaps may be inserted after an UL burst and before a DL burst may be used. The channel structure may be part of a FDD DL in the dynamic shared spectrum band.

A method of configuring a device to operate using LTE-based transmissions in a dynamic shared spectrum band may be provided. One or more parameters may be received such as a length of the coexistence gap, a time elapsed since the last gap, an Actual Channel usage ratio by the current LTE system, a number of retries when attempting to access the channel using LBT, an energy detection threshold for LBT, a target channel use ratio, a maximum time between coexistence gaps, a maximum threshold for energy detection for LBT, or the like.

Measurements may be performed to assess the quality of the channel. It may be determined whether to access the channel based filtered measurements, reports generated in the past N sensing periods, LBT energy detection, a combination thereof, or the like. LBT energy detection may be used to control channel access and measurements may be used to adapt the LBT parameters and to choose an appropriate transmission mode. The transmission mode may be an exclusive mode, a friendly mode, or an aggressive mode. An exclusive mode may provide for exclusive use of the channel. A sensing threshold and a duration of transmission bursts may set to large values. Long coexistence gaps may be disabled or scheduled less frequently. A friendly mode may include coexistence parameters that may be set so that channel may be shared by users. In an aggressive mode, coexistence parameters may be set to a high sensing threshold and long burst duration.

A number of methods may be used to provide coexistence for small cells in LE, such as TVWS. Coexistence gaps may be overlapped with a guard period (GP) in a TDD subframe. A coexistence gap pattern may be spread over multiple frames. PDCCH may be used in the DwPTS to signal coexistence gaps to UEs. An absence of uplink grants to a UE may be used to allow coexistence gaps in the case of localized interference. Modifications may be made to almost blank subframes for use as coexistence gaps. Coexistence patterns with low, medium and high duty cycle, may be provided using multicast broadcast over single frequency network (MBSFN) sub-frames. Methods may be provided to reduce interference that may be caused by OFDM symbols of the MBSFN sub-frame, such as the first two OFDM symbols.

Coexistence patterns may be provided for TDD UL/DL configurations that may use a combination of MBSFN sub-frames and non-scheduled UL. DL HARQ timing associated with certain coexistence patterns may be provided. Data may be transmitted in non-efficient subframes, such as DL subframe in which the corresponding UL subframe for ACK may fall in a coexistence gap, where the eNB may assume NACK.

UE procedures may be provided where PCFICH may not be transmitted in control channel interface potential (CCIP) subframes and the UE may assume a fixed control channel length. PCFICH resource elements may be used to increase a number of PHICH resources.

Procedure for CQI measurements may be provided that may compute separate CQI measurements for RSs in CCIP subframes and RSs in non-CCIP subframes. Procedures may be provided where a CQI in a CCIP subframes may be used to measure the amount of Wi-Fi interference/system, determine the duty cycle of the coexistence gap, decide when to change the currently used channel, or the like.

Procedures may be provided to allocate two or more PHICH resources to a single UE for the transmission of ACK/NACK by the eNB. The eNB may transmit the ACK/NACK over multiple PHICH groups to the same UE using the same orthogonal code. The eNB may transmit the ACK/NACK over a single PHICH group to a given UE, but with multiple orthogonal codes.

A method of splitting a PDCCH grant/allocation into two separate PDCCH messages may be provided to, for example, improve robustness of grants/allocations made during CCIP subframes. The first message may be sent in the non-CCIP subframes to pre-configure a subset of parameters for the actual grant/allocation. The grant/allocation that may be sent in the CCIP subframes may use a short (e.g. format 1C) DCI format and may include parameters that may be associated with the grant sent in the first message. A procedure may be provided to account for the case where the second message (e.g. grant/allocation in the CCIP subframe) may be received without having received a pre-configuration (e.g. first) message.

Enhancements may be made to a Wi-Fi interleaver to ignore subcarriers that may fall in the same frequency as the RSs in the LTE system that may coexist on the same channel. A procedure may be provided where the location of the RSs in the LTE system may be received by the Wi-Fi system from a coexistence database or coexistence manager. A procedure may be provided where the location of the RSs in the LTE system may be determined by the Wi-Fi system using sensing. The procedure may be provided where the Wi-Fi system may perform random frequency hopping of the unused subcarriers in the interleaver and may select an interleaver configuration that may generate a low error rate over time. A procedure may be provided where the AP may send the current interleaver configuration in the beacon to the STAs that may be connected to it.

Carrier aggregation (CA) for LTE-advanced may be provided. In LTE-Advanced, two or more (up to 5) component carriers (CCs) may be aggregated to support transmission bandwidths up to 100 MHz. A UE, depending on its capabilities, may receive or transmit on one or more CCs. It may also be capable of aggregating a different number of sized CCs in the uplink (UL) or the downlink (DL). CA may supported for both contiguous and non-contiguous CCs.

CA may increase the data rate achieved by an LTE system by allowing a scalable expansion of the bandwidth delivered to a user by allowing simultaneous utilization of the radio resources in multiple carriers. May allow backward compatibility of the system with Release 8/9 compliant UEs, so that these UEs may function within a system where Release 10 (with CA) may be deployed.

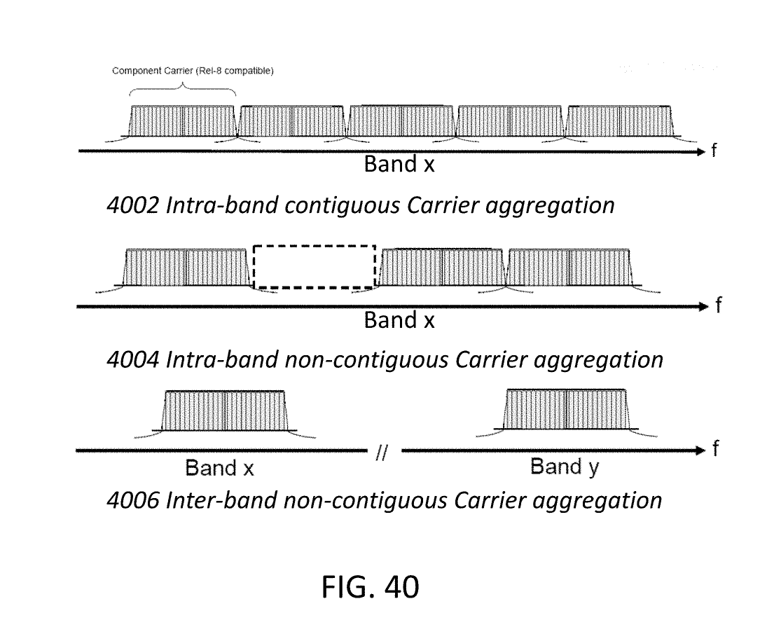

FIG. 40 depicts a number of carrier aggregation types. At 4002, Intra-band contiguous CA may be where multiple adjacent CCs may be aggregated to produce contiguous bandwidth wider than 20 MHz. At 4004, intra-band non-contiguous CA may be where multiple CCs that belong to the same bands (but may not be adjacent to one another) may be aggregated and may be used in a non-contiguous manner. Inter-band non-contiguous CA may be where multiple CCs that may belong to different bands may be aggregated.

As a result of the transition from analogue to digital TV transmissions in the 470-862 MHz frequency band, certain portions of the spectrum may no longer be used for TV transmissions, though the amount and exact frequency of unused spectrum may vary from location to location. These unused portions of spectrum may be referred to as TV White Space (TVWS). The FCC has opened up these TVWS frequencies for a variety of dynamic shared spectrum uses, such as opportunistic use of White Space in the 470-790 MHz bands. These frequencies may be used by secondary users for radio communication if that radio communication may not interfere with other incumbent/primary users. As a result, LTE and other cellular technologies may be used within the TVWS bands. LTE and other cellular technologies may be used in other dynamic shared spectrum bands.

To use the dynamic shared spectrum band for CA, an LTE system may dynamically change the SuppCell from one dynamic shared spectrum frequency channel to another. This may occur, for example, due to the presence of interference and/or primary users in the dynamic shared spectrum bands. For example, interference, such as a microwave or cordless phone, may make a particular channel in the ISM band unusable for data transmission. When dealing with TVWS channels as the dynamic shared spectrum channels, a user of these channels may evacuate the channel upon the arrival of a system such as a TV broadcast, which may have exclusive rights to use that channel. The nature of dynamic shared spectrum bands and the increase in the number of wireless systems that may make use of these bands may cause the quality of channels within the dynamic shared spectrum band to change dynamically. To adjust to this, an LTE system performing CA may be able to change from a SuppCell in an dynamic shared spectrum channel to another, or to reconfigure itself in order to operate on a different frequency.

Cellular technologies may be deployed using small cells and shared and dynamic spectrum, such as TVWS, to allow new entrants such as Google, Microsoft, Apple, Amazon, or the like to deploy their own networks. There are number of motivations for a new entrant to deploy their own networks. For example, operators may be gatekeepers and may block new services. The deployment of such a network in a non-ubiquitous fashion may allow entrants to showcase or introduce these new services to end customers. As another example, these entrants may not have a monthly billing relationship with end customers; the basic connectivity that may be provided by the small cell network may enable these entrants to charge monthly fees to end users. As another example, these players may make devices that may not have cellular connectivity to address market segments where users may not pay monthly fees.

Differences between TDD and FDD modes of operation may be observed in multiple aspects of the PHY, MAC, and RRC. A difference may be in the frame structure, where FDD may use a type 1 frame structure, while TDD may use a type 2 frame structure.

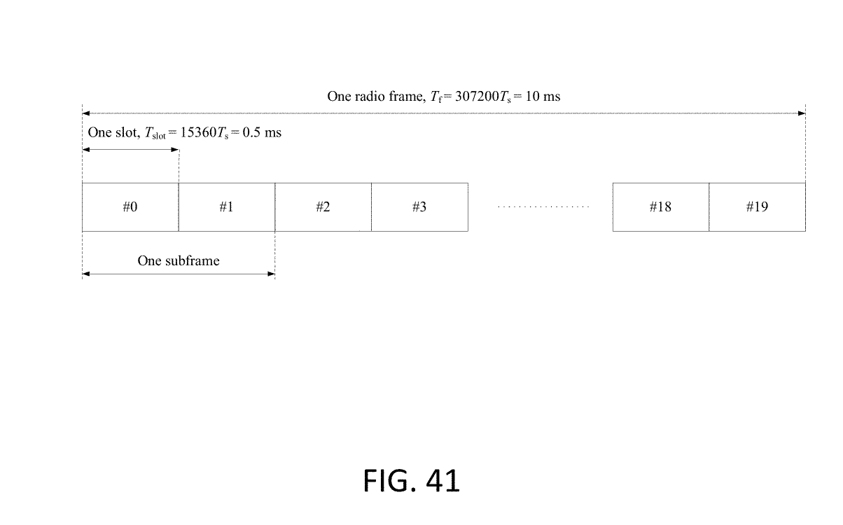

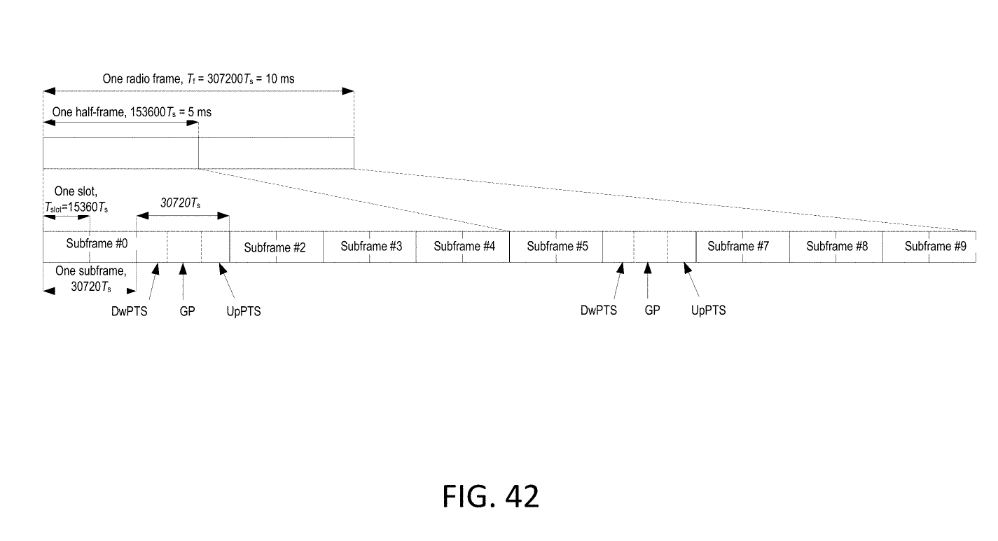

FIG. 41 depicts a diagram illustrating a representative frequency division duplex (FDD) frame format. FIG. 42 depicts a diagram illustrating representative time division duplex (TDD) frame format.

FDD may use frame type 1, where one or more subframes may support both downlink and uplink transmission (on different frequencies). In TDD, a subframe may be an uplink subframe, a downlink subframe, or a special subframe which may have both downlink (DwPTS) and uplink (UpPTS) portions as well as a guard period for the transition from downlink to uplink for interference avoidance. Restrictions may be placed on the types of channels that may be transmitted in the special subframe for Frame Format 2. For example, the special subframe may not have PUCCH mapped to it. Furthermore, TDD allows for 7 possible UL/DL configurations (arrangements of UL, DL and special subframe) which may be statically configured on a per-cell basis. The difference in frame structure may result in a different placement/location of channels and signals, such as reference signals and SCH.

Another difference, which may be the result of the frame format, may be the difference in timing of operations, such as HARQ and UL grants. HARQ operations in FDD may occur in intervals of 4 subframes (Data-to-ACK delay and minimum NACK-retransmission delay), whereas in TDD, these delays may be variable and may depend on the UL/DL configuration. The difference in the HARQ timing, as well as the unavailability of uplink/downlink in a subframe in the case of TDD may result in differences in the DCI formats (size, number of fields), ACK procedures, CQI reporting delay, and size of the PHICH on one or more subframes. For instance, the number of PHICH groups may be fixed on a per-subframe basis in FDD, while it may be variable in TDD.

An LTE system that may in dynamic shared spectrum bands may use FDD or TDD. TDD may be used a dynamic shared spectrum bands for a number of reasons. TDD may request one frequency band, so it may be simpler to find a suitable dynamic shared spectrum frequency channel, as opposed to having to find a pair of separated frequency channels for UL and DL. With two frequency bands used by FDD, there may be more chances to interfere with incumbent users on the channels than TDD and its channel. Detection of incumbent users on a frequency band (TDD) may be easier than for two bands (FDD). Allowing asymmetric DL/UL data connection on a frequency band may fit better with a dynamic spectrum assignment system where channel bandwidth may be optimized.

When an LTE system operates in a dynamic shared spectrum band, the same spectrum may be shared with other secondary users, some of which may use a different radio access technology. For example, LTE may coexist with Wi-Fi.

The Physical Hybrid ARQ Indicator Channel (PHICH) may be used for transmission of Hybrid ARQ acknowledgements (ACK/NACK) in response to UL-SCH transmissions. Since hybrid ARQ may request a reliable transmission for the ACK/NACK, the error rate of the PHICH may be low (0.1% ACK for NACK misdetection).

PHICH may be transmitted by the eNB on resource elements that may be reserved for PHICH transmission. Depending on system information that may be transmitted in the MIB, the PHICH may occupy resource elements such as first OFDM symbol of a subframe (normal PHICH duration), the first 2 or 3 OFDM symbols of a subframe (extended PHICH duration), or the like. The MIB may specify how much of the downlink resources may be reserved for the PHICH through the PHICH-resource parameter.

PHICH may use orthogonal sequences in order to multiplex multiple PHICHs onto the same set of resource elements. 8 PHICHs may be transmitted over the same resource element. These PHICHs may be referred to as a PHICH group, and the separate PHICHs within a group may be distinguished using the orthogonal code that may have been during modulation of the PHICH.

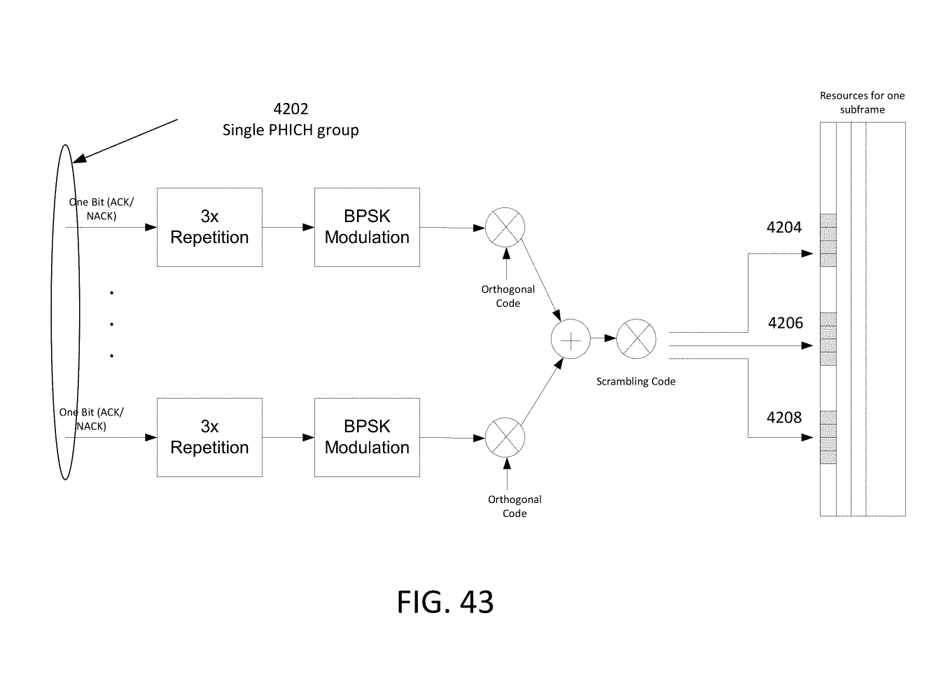

FIG. 43 depicts an example of physical hybrid ARQ Indicator Chanel (PHICH) group modulation and mapping. A PHICH group, such as at 4202, may generate 12 symbols, which may be sent over 3 resource element groupsm such as at 4204, 4206, and 4208, that may be spread in frequency to ensure frequency diversity. The cell ID may be used to distinguish the location of this mapping in the frequency range.

As a result of this mapping, a PHICH resource that may be assigned to sending ACK/NACK to a UE, may be identified by the index pair (n_group, n_seq), where n_group may be the PHICH group number, and n_seq may the orthogonal sequence that may be used to distinguish PHICH resources within a group. The amount of resources assigned to PHICH within a subframe may be determined by the number of PHICH groups. This may depend on whether TDD or FDD may be used. In FDD, the number of PHICH groups may be fixed in a subframe and may be as follows:

$${N}_{PHICH}^{group} = \{ \begin{matrix}⌈ {N}_{g} ( {N}_{RB}^{DL} / 8 ) ⌉ & for normal cyclic prefix \\ 2 \cdot ⌈ {N}_{g} ( {N}_{RB}^{DL} / 8 ) ⌉ & for extended cyclic prefix\end{matrix}$$

where N_{g}∈{⅙, ½, 1, 2} may represent the PHICH-resource parameter in the MIB. In TDD, the above equation for the number of PHICH groups may be further multiplied by a factor m in one or more subframes, where m may be given by the following table:

Multiplication Factor for Number of PHICH Groups in TDD

| Uplink-downlink | Subframe number i | | | | | | | | | |
|---|---|---|---|---|---|---|---|---|---|---|
| configuration | 0 | 1 | 2 | 3 | 4 | 5 | 6 | 7 | 8 | 9 |
| 0 | 2 | 1 | — | — | — | 2 | 1 | — | — | — |
| 1 | 0 | 1 | — | — | 1 | 0 | 1 | — | — | 1 |
| 2 | 0 | 0 | — | 1 | 0 | 0 | 0 | — | 1 | 0 |
| 3 | 1 | 0 | — | — | — | 0 | 0 | 0 | 1 | 1 |
| 4 | 0 | 0 | — | — | 0 | 0 | 0 | 0 | 1 | 1 |
| 5 | 0 | 0 | — | 0 | 0 | 0 | 0 | 0 | 1 | 0 |
| 6 | 1 | 1 | — | — | — | 1 | 1 | — | — | 1 |

For instance, in subframes that may be reserved for uplink, the number of PHICH groups may be zero.

PHICH allocations may be done on a per-UE basis and may be done at the time of UL grant reception, using the following equations:

n_{PHICH}^{group}=(I_{PRB}_{_}_{RA}+n_{DRMS})mod N_{PHICH}^{group}+I_{PHICH}N_{PHICH}^{group}

n_{PHICH}^{seq}=(└I_{PRB}_{_}_{RA}/N_{PHICH}^{group}┘+n_{DMRS})mod 2N_{SF}^{PHICH}

The uplink grant for a subframe may contain the PHICH group number and orthogonal sequence number for the PHICH that may be assigned to a UE, specified by the lowest PRB index of the UL grant (IPRB_RA) and the cyclic shift used when transmitting the Demodulation Reference Signal (DMRS) to distinguish between different users employing MU-MIMO (nDMRS). The PHICH may be located in subframe n+k, where n may be the subframe in which the uplink transmission may be made on the PUSCH. For FDD, k may be fixed at 4 subframes, whereas in TDD, k may depend on the UL/DL configuration and may be given by a table.

The PHICH performance target for LTE may be in the order of 10⁻² for ACK-to-NACK errors and 10⁻⁴ for NACK-to-ACK errors. The reason for the asymmetric error rates may be that a NACK-to-ACK error may result in a loss of MAC transport block, which may require a retransmission at the RLC layer. On the other hand, an ACK-to-NACK error may result in an unnecessary HARQ retransmission, which may have less impact on the system performance. A 10⁻³ ACK-to-NACK error rate may be used for SNR as low as 1.3 dB for a single antenna port TDD.

PDCCH performance may request a miss-detection rate (probability of a missed scheduling grant) of 10⁻² at SNRs as low as −1.6 dB for single antenna port TDD. At low SNR, the probability of a false alarm when decoding PDCCH (i.e. the probability of detecting a PDCCH during blind decoding when none may have been sent to a specific UE) may be on the order of 10⁻⁵.

A number of deployment options may request standalone use of LTE over Dynamic shared spectrum. For instance, entrants may not have access to licensed spectrum and may deploy LTE in shared spectrum such as TVWS or ISM bands. This spectrum may be broad and may include a large numbers of channels that may be occupied by other technologies that may make network discovery challenging. Since channels may be shared with other operators and other RATS, these channels may be polluted with localized (both Controllable and Uncontrollable) interferers. Because the availability of the channels may change over a short period and the LTE system may be reconfigured, bands may be referred to as dynamic shared spectrum. Small cells deployed in dynamic shared spectrum may not be able to anchor the LTE system to a licensed spectrum. The LTE system may support both uplink and downlink.

To operate in dynamic shared spectrum, an LTE system may coexist with other systems such as Wi-Fi. Without coexistence mechanisms, both LTE and Wi-Fi systems may operate inefficiently when trying to utilize the same channel.

A number of methods may be provided herein to create coexistence gaps in a TDD system operating in dynamic shared spectrum band. To avoid multiple UL-DL switchpoints in the TDD frame, the coexistence gap may coincide with the GP in the special subframe. A transition from DL to UL that may be achieved in TDD using the GP may be achieved using a coexistence gap. This may be done, for example, by using TDD UL/DL configurations and replacing one or more subframes in these configurations with a coexistence gap subframe. TDD UL/DL configurations may be provided that may allow flexibility in incorporating coexistence gaps. A GP duration may be lengthened while maintaining the same TDD UL/DL configuration.

A coexistence pattern maybe extended in order for it to occupy multiple frames. Frames may take the role of coexistence frames or non-coexistence frames.

A coexistence gap may be created through the absence of scheduling by the eNB in the uplink, which may create a contiguous gap in the transmission that may serve as a coexistence gap. The coexistence gap may take the form of an almost blank subframe in 3GPP. The coexistence gap may take the form of one or more MBSFN subframes that may be combined with non-scheduled UL subframes.

When using MBSFN subframes or ABS for coexistence gaps, the LTE control channel in some subframes, such as during and after the gap, may experience interference from the non-LTE systems that may be coexisting on the same channel (e.g. Wi-Fi). To combat this interference, various methods and procedures may be provided to enhance robustness of the control channel that may be transmitted in these subframes. For example, use of PCFICH may be avoided in subframes that may experience interference. As another example, multiple PHICH resources may be used for a UE in subframes that may experience interference. As another example, grants/allocations may be preconfigured. The control message may be split into two; pre-configuration may occur on subframes where there may not be interference, and the remainder of the message may include coding.

The use of MBSFN or ABS subframes for coexistence gaps may entail that a Wi-Fi system may suffer interference from RSs that may be transmitted by the LTE system during the gap. The Wi-Fi interleaver may avoid the use of Wi-Fi subcarriers that may coincide with the frequencies where the LTE system may send the RS.

Coexistence gaps may be provided during the TDD GP. A TVWS LTE cell may define its coexistence gaps to coincide with the TDD GP. Since the TDD GP may not be utilized by UL or DL transmission, a Wi-Fi system may sense the channel to be unused if its distributed inter-frame space (DIFS) sensing period may coincide with the GP. The GP may be extended so that it may be longer than requested. The clear time added to the guard period through this lengthening may be used as a coexistence gap.

Coexistence gaps may also be used to extend the GP in the TTD frame format to account for transmissions over large distance on low frequencies (where request UL/DL transmission time may be longer). This may be done, for example, by having the coexistence gap coincide with the location of the GP, and extending this coexistence gap so that it may cover two or more consecutive subframes. The subframes, which may be located in the coexistence gap, may not be used for data transmission.

Coexistence gaps may be provided using UL/DL configurations. Coexistence gaps may be defined in such a way that a frame may define a coexistence gap, but the UL/DL configuration may not change. In this case, some subframes in a frame may be blanked out and may be used as a part of the coexistence gap.

For example, a coexistence gap for UL/DL configurations having a 5 ms switch point may be defined to occur between the current two special subframes. This may allow for a 50% duty cycle for these configurations. To allow other duty cycles for these configurations, the coexistence gap pattern may be spread over multiple subframes as described herein. The coexistence gap for UL/DL configurations having a 10 ms switch point may have a variable duty cycle and may ensure that both DL and UL resources may be available, regardless of the duty cycle chosen. The TDD UL/DL configurations with coexistence gaps may be as follows:

| | DL to UL | | | | | | | | | | |
|---|---|---|---|---|---|---|---|---|---|---|---|
| UL/DL | switch point | Subframe Number | | | | | | | | | |
| Configuration | Periodicity | 0 | 1 | 2 | 3 | 4 | 5 | 6 | 7 | 8 | 9 |
| 0′ | 5 ms | D | S1 | G | G | G | G | S2 | U | U | U |
| 1′ | 5 ms | D | S1 | G | G | G | G | S2 | U | U | D |
| 2′ | 5 ms | D | S1 | G | G | G | G | S2 | U | D | D |
| 3′ | 10 ms | G | S1 | U | U | U | D | D | D/G | D/G | D/G |
| 4′ | 10 ms | G | S1 | U | U | D | D | D | D/G | D/G | D/G |
| 5′ | 10 ms | G | S1 | U | D | D | D | D | D/G | D/G | D/G |
| 6′ | 5 ms | D | S1 | G | G | G | G | S2 | U | U | D |

In the above table, G may represent a subframe that may be a coexistence gap, D/G may indicate that the subframe may be either a downlink subframe or a gap subframe (so long as gap subframes may be consecutive), and S1 and S2 may be configured as one or more of the following:
S1 may be a D subframe, a G subframe, or a special subframe that may include of some DwPTS symbols followed by G.
S2 may be a U subframe, a G subframe, or a special subframe and may include of G followed by a few UpPTS symbols.
The configuration of S1 and S2 according to the above may depend on the duty cycle that may have been chosen for the coexistence gap. Use of a special subframe may depend on the system (the system may decide to use the special subframe when configuring these subframes or configure a special subframe to be one of D/G/U).
   The UL/DL configuration may be signalled in system information to UEs in the cell. A duty cycle parameter may be signalled to the UEs to specify how a special subframe may be used in a configuration when coexistence gaps may be considered. MAC CE may be used for the signalling. A MAC CE that may be sent to the UEs may include a length of the coexistence gap and a configuration of S1, S2 and D/G or U/G. The duty cycle may change more rapidly than the TDD UL/DL configuration.
   TDD UL/DL configurations may be provided. The GP, which may represent the transition from DL to UL, may be used for the coexistence gap. The frame length in LTE may be maintained. A UL/DL configuration may allow for the coexistence gap to occupy multiple subframes and the frame may allow for both UL and DL subframes.
   A number of UL/DL configurations may be as follows:

| UL/DL | DL to UL | | | | | | | | | | |
|---|---|---|---|---|---|---|---|---|---|---|---|
| Con- | switch point | Subframe Number | | | | | | | | | |
| figuration | Periodicity | 0 | 1 | 2 | 3 | 4 | 5 | 6 | 7 | 8 | 9 |
| 7 | 10 ms | D | S1 | S2 | U | D | D | D | D | D | D |
| 8 | 10 ms | D | S1 | G | S2 | U | D | D | D | D | D |
| 9 | 10 ms | D | S1 | G | G | S2 | U | D | D | D | D |
| 10 | 10 ms | D | S1 | G | G | G | S2 | U | D | D | D |
| 11 | 10 ms | D | S1 | G | G | G | S2 | U | U | U | D |
| 12 | 10 ms | D | S1 | G | G | G | S2 | U | U | D | D |

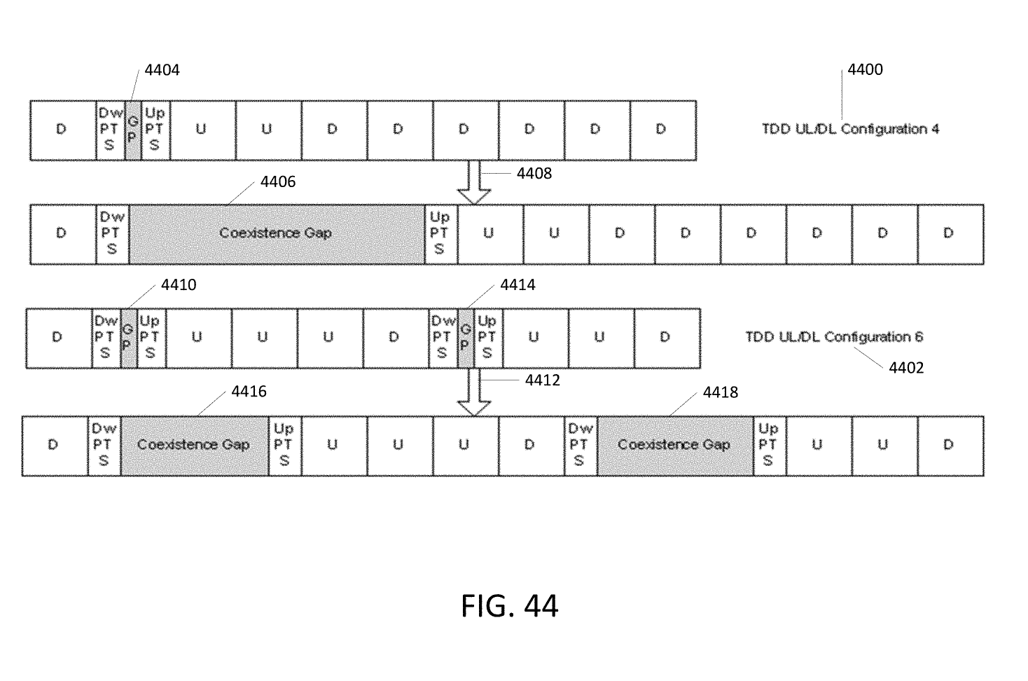

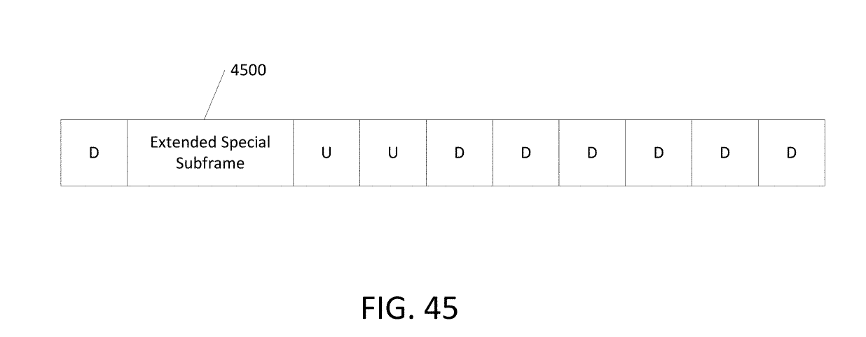

A system may choose to allow a subset of these configurations. In the above table, special subframe S1 may include a DwPTS followed by a GP, while special subframe S2 may include a GP followed by a UpPTS. The lengths of these may be configurable.
The TDD UL/DL configurations may be signalled through system information. The system information that may include the UL/DL configurations, such as one or more of the configurations above.
FIG. 44 depicts a coexistence gap that may be used to replace a TDD GP. TDD frame length may be extended by a coexistence gap. The coexistence gap may coincide with or may replace the GP and may extend the duration of the GP in the system to obtain the length of the coexistence gap which the LTE system decides.
As shown in FIG. 44, a number of TDD UL/DL configurations, such as TDD UL/DL configuration 4 at 4400 and TDD UL/DL configuration 6 at 4402, may be provided. A frame structure may change when a coexistence gap may be introduced. For example, the frame structure may change at 4408 with the introduction of coexistence gap 4406, which may coincide with or may replace GP 4404. Another example, the frame structure may change at 4412 with the introduction of coexistence gap 4416, which may coincide with or may replace GP 4410, in the introduction of coexistence gap 4418, which may coincide with or may replace GP 4414.
Depending on the Wi-Fi traffic, the LTE eNB may configure the UEs connected to it with a length for the coexistence gap. The UEs and the eNB may then use the frame structure that may include the length or the coexistence gap, such as the frame structure shown in FIG. 44.
The length of a coexistence gap may be set by the eNB based on the amount of Wi-Fi traffic and requests to coexist with other Wi-Fi users. The resulting frame length may be extended by the length of the coexistence gap. The length of the coexistence gap may be chosen in such a way that the sum of the lengths of DwPTS, UpPTS, and the coexistence gap that they surround may not add up to an integer number of subframes. The minimum length of the coexistence gap may be configured as the length of the GP for a special subframe configuration that may allow a Wi-Fi beacon to be transmitted. The maximum length of the coexistence gap may be set such that the total time of the DwPTS, UpPTS, and the coexistence gap may add up to N subframes, where N may be chosen by the eNB.
FIG. 45 depicts a TDD UL/DL configuration 4 that may use an extended special subframe. The LTE PHY, MAC, and RRC layers may consider the coexistence gap as the GP with regards to timing of procedures. A special subframe length may have the duration of multiple subframes. For example, at 4500, an extended special subframe may have a duration of multiple subframes. The duration of the multiple subframes may be a duration of a DwPTS, a coexistence Gap, an UpPTS, a combination thereof, or the like. The special subframe may be considered as a single subframe, even though the duration of the special subframe may be longer than a single subframe. For example, the duration of the special subframe may be longer than 1 ms. The special subframe may be referred to as an extended special subframe, as shown at 4500 in FIG. 45.

As an example, the UE HARQ ACK procedure may use the following table to define the value of k for TDD:

| TDD UL/DL | subframe number i | | | | | | | | | |
|---|---|---|---|---|---|---|---|---|---|---|
| Configuration | 0 | 1 | 2 | 3 | 4 | 5 | 6 | 7 | 8 | 9 |
| 0 | 7 | 4 | | | | 7 | 4 | | | |
| 1 | | 4 | | | 6 | | 4 | | | 6 |
| 2 | | | | 6 | | | | | 6 | |
| 3 | 6 | | | | | | | | 6 | 6 |
| 4 | | | | | | | | | 6 | 6 |
| 5 | | | | | | | | | 6 | |
| 6 | 6 | 4 | | | | 7 | 4 | | | 6 |

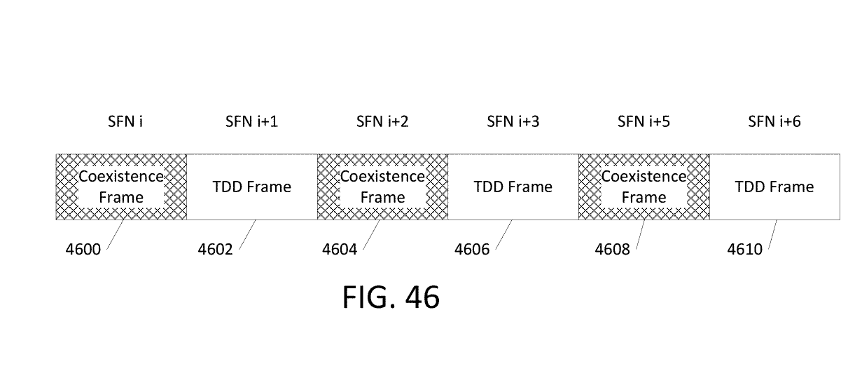

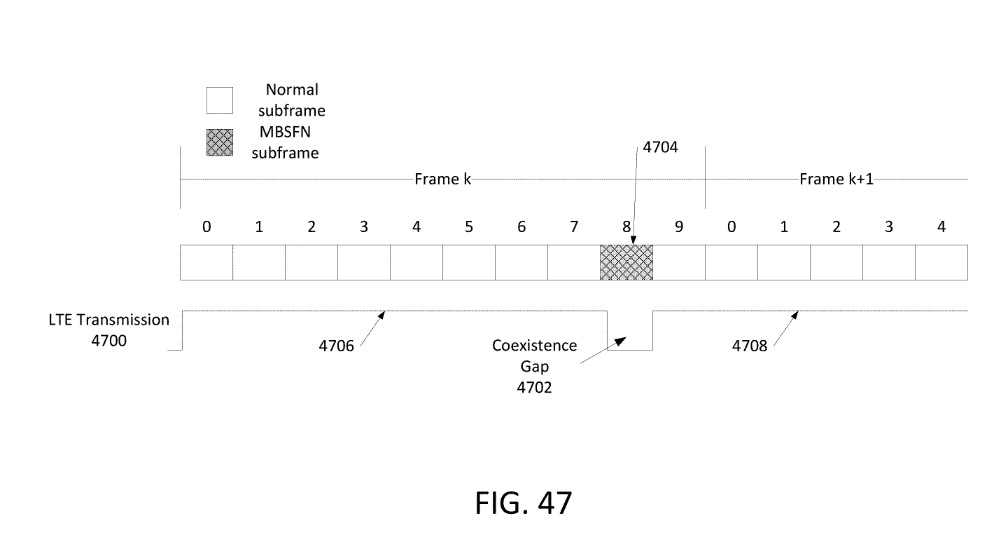

A HARQ-ACK received on the PHICH assigned to a UE in subframe i may be associated with the PUSCH transmission by the UE in subframe i-k as indicated by the table above. Since the extended subframe may be considered a single sub-frame, the above table may not change when applying extended special subframes. Other procedures may assume that the extended special subframe may be a single subframe.
The length (N) of the coexistence gap in subframes may be signalled by the PHY layer to UEs in the cell using the PDCCH. This may be done, for example, by allowing information to be signalled on the DwPTS prior to the start of the coexistence gap. A downlink allocation on the DwPTS in the common search space, which may be encoded with SI-RNTI or a special RNTI, may be used to signal the length of the coexistence gap.
Coexistence gap configurations may span multiple subframes. A coexistence gap pattern may be configured in such a way that the pattern may span over multiple frames rather than a single frame. The system may indicate that some frames may include a coexistence gap, and other may not include a coexistence gap. For example, every other frame (odd or even) may be denoted as a coexistence frame, while other frames would be a normal TDD frame.
FIG. 46 depicts a coexistence frame where a coexistence gap may be configured over multiple frames. As shown in FIG. 46, a coexistent gap may span over multiple frames, such as coexistence frame 4600, coexistence frame 4604, or coexistence frame 4408. When transmitted, coexistence frames may alternate with TTD frames, such as TDD frame 4602, TDD frame 4606, TDD frame 4610. A coexistence frame may include a blank frame, such as 10 subframes that may be indicated as G.
MBSFN subframes may be used. Coexistence gaps may be created by having the eNB schedule MBSFN (Multicast/Broadcast over Single Frequency Network) subframes for this purpose. MBSFN subframes may be used for, among other things, to transmit the Multicast Channel (MCH) and during the transmission of MCH in the MBSFN subframes, the eNB may not transmit other downlink transport channels (SCH, PCH and BCH).
To create coexistence gaps the eNB may schedule MBSFN subframes and may not use them for MCH. These subframes may be empty except for the first two OFDM symbols of PDCCH, which may be used to transmit reference symbols, PCFICH and PHICH. The remainder of the subframe (OFDM symbols 3-14 for normal CP) may be used for Wi-Fi to obtain access to the channel.
To have a large coexistence gap that may allow for Wi-Fi to access the channel and transmit with little or no interference from LTE, the eNB may use multiple consecutive MBSFN subframes and the resulting coexistence gap may include these MBSFN subframes. MBSFN subframes may be used in both FDD and TDD versions of LTE, and this scheme may apply to both of these frame structures.
Gaps in FDD systems may use MBSFN subframes. In an FDD system where DL operation in the DSS bands may be supported, gaps may be created on a component carrier that may be used as downlink. The allowable subframes, which may be used for MBSFN in FDD, may be subframes #1, 2, 3, 6, 7, 8. Depending on the requested duty cycle of the LTE transmission, which may be decided by the load of the LTE system relative to that of other nearby Wi-Fi systems trying to coexist, the eNB may configure a different number of MBSFN subframes in a frame to create a coexistence gap.
FIGS. 47-50 depict examples of coexistence gap patterns for high duty cycles, such as a 80% or 90% duty cycle; medium duty cycles, such as a 50% duty cycle; and low duty cycles, such as a 40% duty cycle. The location and number of MBSFN subframes may be the same as LTE Rel-10, and the minimum duty cycle that may be achieved by the LTE system may be 40%.

FIG. 47 depicts a coexistence gap pattern for a 90% duty cycle. A coexistence gap may be provided at 4702 for LTE transmission 4700. At 4704, the coexistence gap may correspond to frame 8, which may include one or more MBSFN subframes. At 4702, LTE transmission 4700 may not transmit, which may allow other RATs to transmit and/or coexist with LTE transmission 4700. At 4706 and 4708, LTE transmission 4700 may transmit. For example, LTE transmission 4700 may transmit during frames 0, 1, 2, 3, 4, 6, 7, and 9.

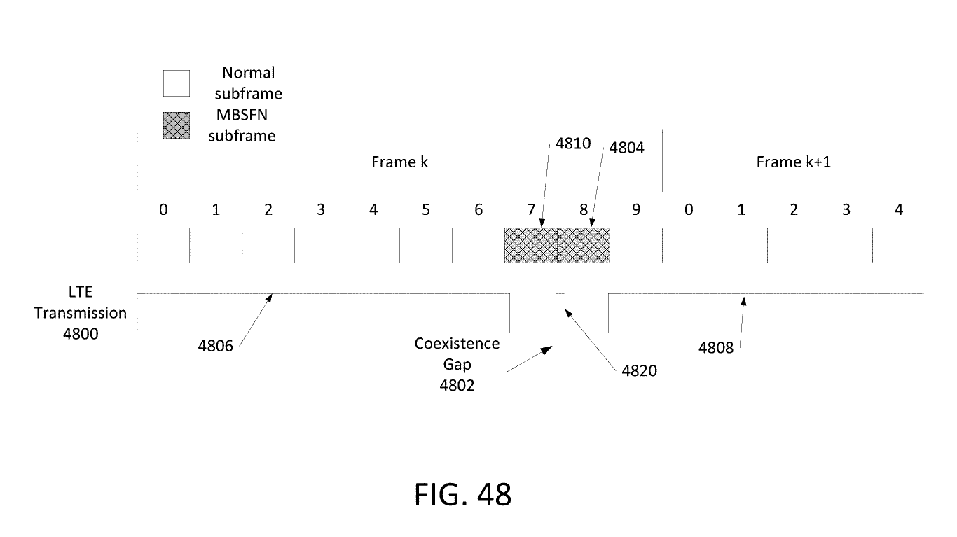

FIG. 48 depicts a coexistence gap pattern for a 80% duty cycle. A coexistence gap may be provided at 4802 for LTE transmission 4800. At 4804, a coexistence gap may correspond to frame 8, which may include one or more MBSFN subframes. At 4810, a coexistence gap may correspond to frame 7, which may include one or more MBSFN subframes. At 4802, LTE transmission 4800 may not transmit, which may allow other RATs to transmit and/or coexist with LTE transmission 4800. At 4806 and 4808, LTE transmission 4800 may transmit. For example, LTE transmission 4800 may transmit during frames 0, 1, 2, 3, 4, and 9.

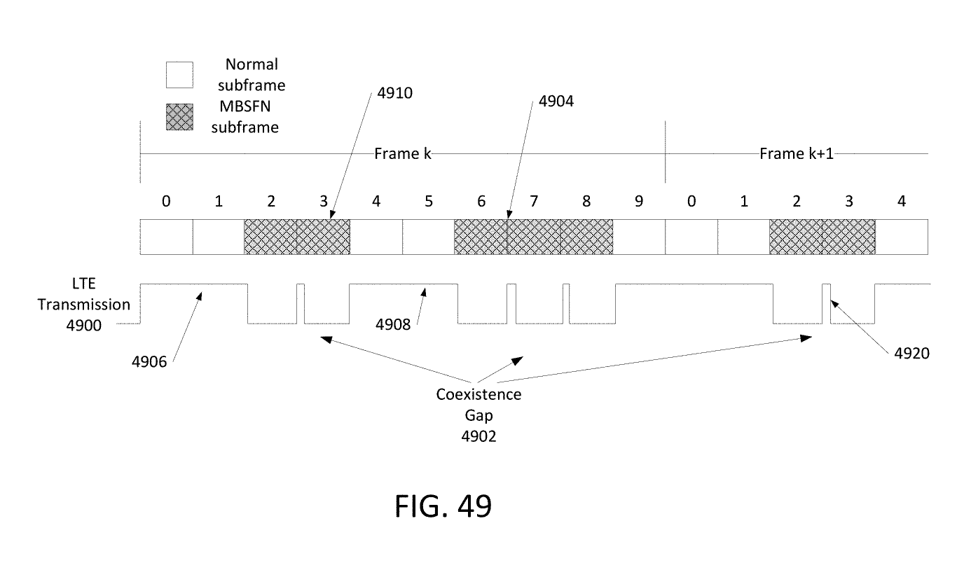

FIG. 49 depicts a coexistence gap pattern for a 50% duty cycle. A coexistence gap may be provided at 4902 for LTE transmission 4900. At 4904, a coexistence gap may correspond to frames 6, 7, and 8, which may include one or more MBSFN subframes. At 4910, a coexistence gap may correspond to frames 2 and 3, which may include one or more MBSFN subframes. At 4902, LTE transmission 4900 may be silenced or paused, which may allow other RATs to transmit and/or coexist with LTE transmission 4900. At 4906 and 4908, LTE transmission 4900 may transmit. For example, LTE transmission 4900 may transmit during frame 0, 1, 4, 5, and 9.

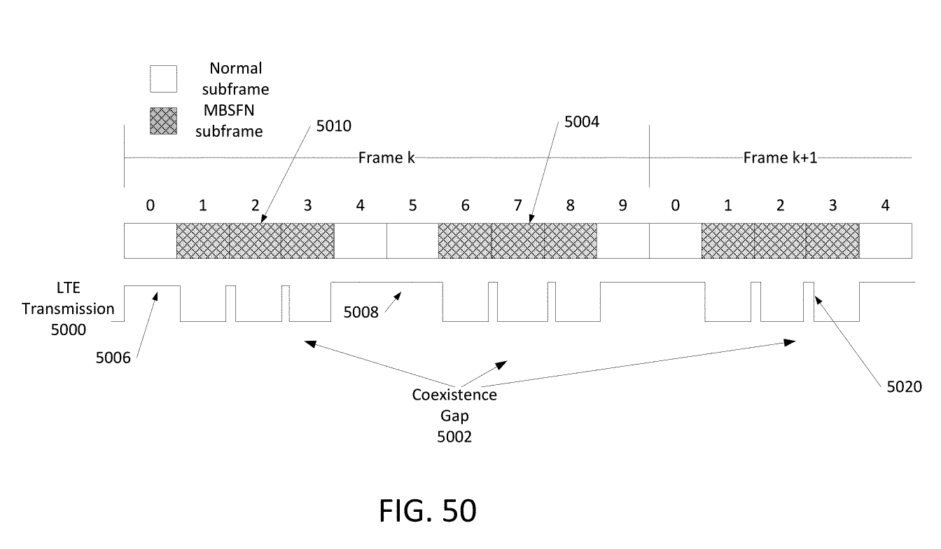

FIG. 50 depicts a coexistence gap pattern for a 40% duty cycle. A coexistence gap may be provided at 5002 for LTE transmission 5000. At 5004, a coexistence gap may correspond to frames 6, 7, and 8, which may include one or more MBSFN subframes. At 5010, a coexistence gap may correspond to frames 1, 2, and 3, which may include one or more MBSFN subframes. At 5002, LTE transmission 5000 may not transmit, which may allow other RATs to transmit and/or coexist with LTE transmission 5000. At 5006 and 5008, LTE transmission 5000 may transmit. For example, LTE transmission 5000 may transmit during frame 0, 4, 5, and 9.

In FIGS. 47-50, other subframes may be chosen as MBSFN subframes from the set of 1, 2, 3, 6, 7, 8 which may be the allowable MBSFN subframes for FDD. A coexistence gap may be chosen to be consecutive to increase the chances of the other RAT, such as Wi-Fi, taking the channel and transmitting without interference. This rule may drive the selection of the gap configuration.

In FIGS. 48-50, the coexistence gap may be interrupted by a short LTE transmission of two symbols, such as at 4820 in FIG. 48, at 4920 in FIG. 49, and at 5020 in FIG. 50. This transmission may be due to MBSFN subframes that may transmit the first two OFDM symbols that may correspond to the non-MCH channels (e.g. the PDCCH). Reference symbols, PHICH, and PCFICH may be transmitted in this case. Transmission of reference symbols, PCFICH, and PHICH may have a minimal effect on Wi-Fi. It may be small enough in duration so that Wi-Fi may still able gain access to the channel if needed. Since PDCCH messages may allocate downlink resources that may not be transmitted during these OFDM symbols, a reduction in power from the LTE system may occur which may lessen the impact of interference to Wi-Fi when the two OFDM symbols may be transmitted while Wi-Fi may be in the middle of transmitting a packet.

Interference caused by the first two symbols may be reduced by not transmitting PHICH. To prepare for a subframe that may have the transmission of two OFDM symbols in the middle of a coexistence gap (e.g. subframes 2, 3, 7 and 8 in the 40% duty in FIG. S0), the eNB may not schedule an uplink transmission on the UL component carrier that may have been scheduled by the DL component carrier on which the gaps may be configured. This may be performed with efficient use of the BW on the UL by scheduling coexistence gaps on the UL component carrier in a timed fashion with MBSFN subframes on the DL component carrier so that there may not be a request to transmit PHICH on the DL component carrier.

When used in the context of carrier aggregation with the licensed band, or carrier aggregation with another DL component carrier in the dynamic shared spectrum bands where coexistence gaps may not be requested on that component carrier, the eNB may schedule DL transmissions on the component carrier with the MBSFN coexistence gaps from the other component carrier using cross-carrier scheduling. The eNB may not send PHICH on the DL component carrier containing the MBSFN coexistence gaps.

Gaps in TDD Systems may be provided using MBSFN subframes and non-scheduled UL. In TDD systems, both UL and DL transmissions may occur on the same component carrier or channel and TDD UL/DL configurations may have fewer potential subframes that may be used as MBSFN subframes. DL HARQ timing may considered when generating gaps. For TDD, the allowable subframes for MBSFN subframes may be subframes #3, 4, 7, 8, 9. However, in a TDD UL/DL configuration, if any of these subframes may be an UL subframe, it may not be considered an MBSFN subframe.

To increase the flexibility of defining coexistence gaps, non-scheduled uplink subframes may be used. DL HARQ timing may be redefined, or may be kept and DL transmissions in subframes may not be allowed.

Non-scheduled UL subframes may include subframes where the eNB may not allow UL transmissions by a UE, even though these subframes may be defined as UL subframes in the TDD UL/DL configuration. The eNB may ensure that CQI/PMI/RI and SRS may not be transmitted by a UE in these subframes. These subframes may be considered silent/blank, and may be used as subframes that may be part of the coexistence gap. By combining MBSFN subframes and non-scheduled UL subframes, coexistence gap patterns may be defined for one or more of the TDD UL/DL configurations.

Coexistence gaps may be provided for UL/DL configurations. For a TDD UL/DL configuration, a gap pattern for a high duty cycle may be provided. A gap pattern for a high duty cycle may be used by the LTE system when there may be little or no Wi-Fi traffic on the channel. The gap pattern may include some gap time to allow for measurements and detection of any system which may try to access the channel. A gap pattern for a medium duty cycle may be provided. A gap pattern for a medium duty cycle may be used by the LTE system when there may be Wi-Fi traffic on the channel and the LTE and Wi-Fi systems may share the medium. A gap pattern for a low duty cycle may be provided. A gap pattern for a low duty cycle may be used when the LTE system may not be heavily loaded and most of the channel time may be used by the Wi-Fi system.

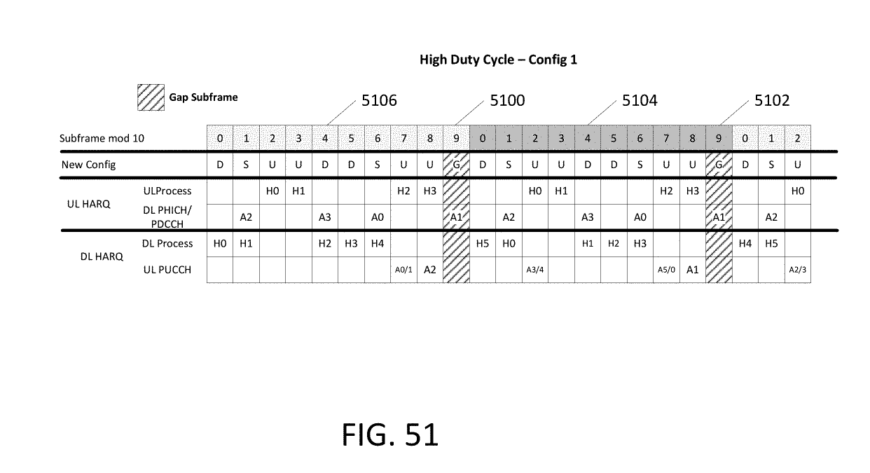

A gap pattern may be provided for TDD UL/DL Configuration 1. FIG. 51 depicts a high duty cycle gap pattern for TDD UL/DL Configuration 1. At 5100 and at 5102, a coexistence gap may be created by configuring subframe 9 as an MBSFN subframe. The coexistence gap may include of symbols 3-14 of subframe 9 of one or more frames, which may yield approximately a 90% duty cycle. The first two symbols of subframe 9 may be used for the LTE system to transmit PHICH and reference symbols, and may not be considered as part of the gap. Subframe 4 may have also been used to create the coexistence gap at 5104 and at 5106 by using it as the MBSFN subframe. Subframe 9 may allow for defining the high-duty cycle coexistence gaps for other TDD UL/DL configurations in a similar manner. Defining a coexistence gap in subframe 4 may result in Wi-Fi interference that may affect SIB 1, which may be transmitted in the subsequent subframe (subframe 5).

The UL HARQ processes/timing may not be affected by the introduction of subframe 9 as a gap subframe, since HARQ ACK that may be sent on PHICH in this subframe may still be transmitted. As a result, the number of UL processes may be unaffected. For the DL HARQ, the timing of DL HARQ ACK/NACK relative to DL transmission may be the same as in Rel-8/10. Since subframe 9 may not be used for DL transmission by the eNB, the ACK/NACK that may have been previously sent by the UE in subframe 3 may no longer be needed.

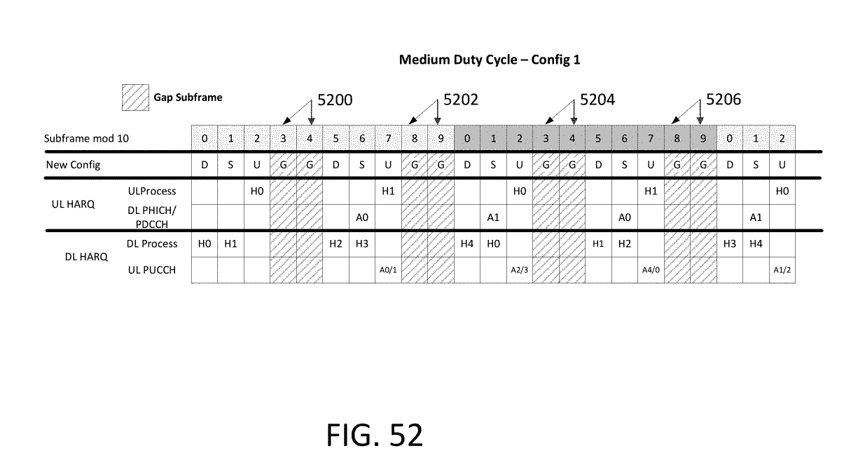

FIG. 52 depicts a medium duty cycle gap pattern for TDD UL/DL Configuration 1. A medium duty cycle may include a coexistence gap that may be created by having subframes 4 and 9 configured as MBSFN subframes, and having subframes 3 and 8 to be non-scheduled UL subframes. This may result in a coexistence gap configuration with approximately a 60% duty cycle. UL transmissions may not be scheduled by the eNB in subframes 3 and 8. The number of UL HARQ processes may be reduced from 4 to 2. There may not be a change in the DL HARQ timing with respect to LTE. DL transmissions that may send ACK in subframes 3 and 8 may be prevented from doing so as they may fall in a coexistence gap.

Other potential configurations may be possible. For example, a 50% duty cycle configuration may be created by adding subframe 7 in the gap and considering this subframe as a non-scheduled UL subframe. ACK/NACK FOR DL HARQ may not be sent in subframe 7. DL transmissions that occur in subframes 0 and 1 may have their ACK/NACK moved to subframe 2, which may change the timing of the HARQ for this configuration, or may be prevented from transmitting in subframes 0 and 1. However, SIB/MIB and synchronization information may be sent in these subframes.

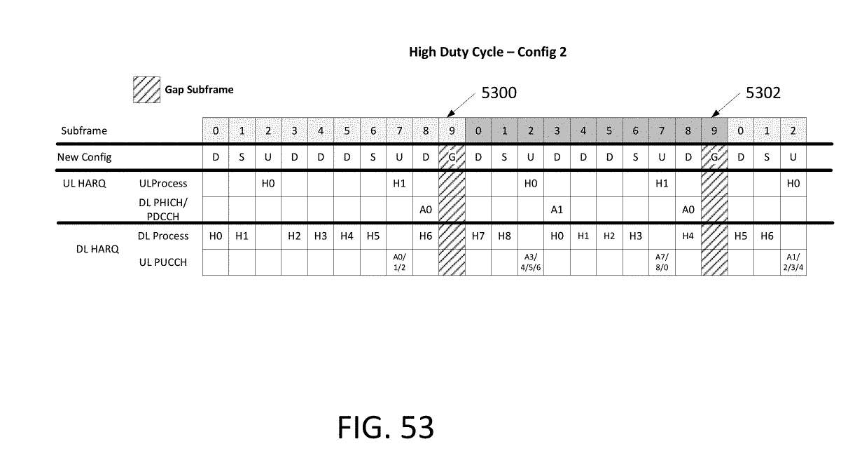

A gap pattern may be provided for TDD UL/DL Configuration 2. FIG. 53 depicts a high duty cycle gap pattern for TDD UL/DL Configuration 2. A coexistence gap may be created at 5300 and 5302 by configuring subframe 9 as an MBSFN subframe. The coexistence gap may include symbols 3-14 of subframe 9 of one or more frames, which may yield a 90% duty cycle. The first two symbols of subframe 9 may be used for the LTE system to transmit PHICH and reference symbols, and may not be considered as part of the gap. Subframe 3, 4, or 8 may have also been used to create the coexistence gap by using it as the MBSFN subframe.

The UL HARQ processes/timing may not be affected by the introduction of subframe 9 as a gap subframe, since there may not be HARQ ACK that may be sent on PHICH in this subframe. The number of UL processes may be unaffected. For the DL HARQ, the timing of DL HARQ ACK/NACK relative to DL transmission may be the same as in Rel-8/10. Since subframe 9 may not be used for DL transmission by the eNB, the ACK/NACK that was previously sent by the UE in subframe 7 of the subsequent frame may not be needed.

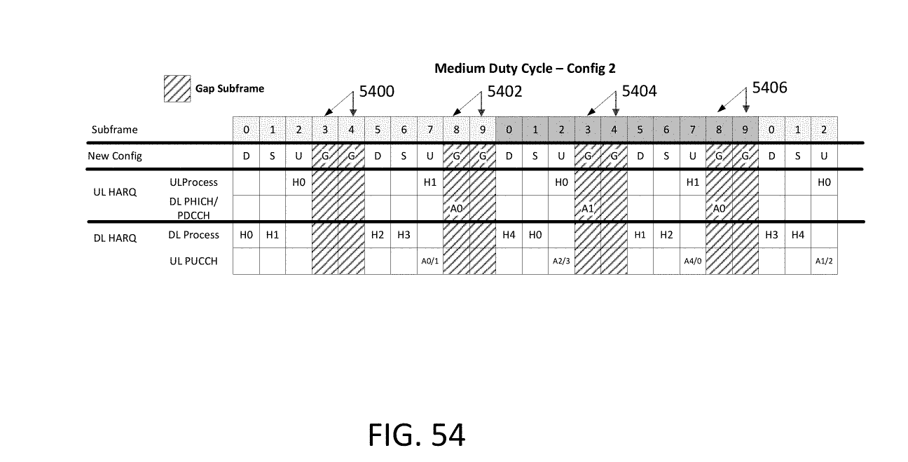

FIG. 54 depicts a medium duty cycle gap pattern for TDD UL/DL Configuration 2. The medium duty cycle may include a coexistence gap at 5400, 5402, 5404, and/or 5406 created by having subframes 3, 4, 8, and 9 configured as MBSFN subframes. This may result in a coexistence gap configuration with approximately a 60% duty cycle. There may not be a change in the DL HARQ timing. Since no UL subframes may have been removed from the original configurations, there may not be a change to the timing or number of processes for the UL HARQ. No ACK/NACK opportunities may have been removed. There may not be a change to the DL HARQ timing.

There may be a number of other configurations. For example, a configuration that may yield approximately a 50% duty cycle configuration may be created by adding subframe 7 in the gap and considering this subframe as a non-scheduled UL subframe. An ACK/NACK may not be sent in subframe 7 DL HARQ. The DL transmissions that may occur in subframes 0 and 1 may have their ACK/NACK moved to subframe 2 of the subsequent frame, which may change the timing of the HARQ for this configuration; subframes 0 and/or 1 may not be used for DL data transmissions. SIB/MIB and synchronization information may still be sent in these subframes however.

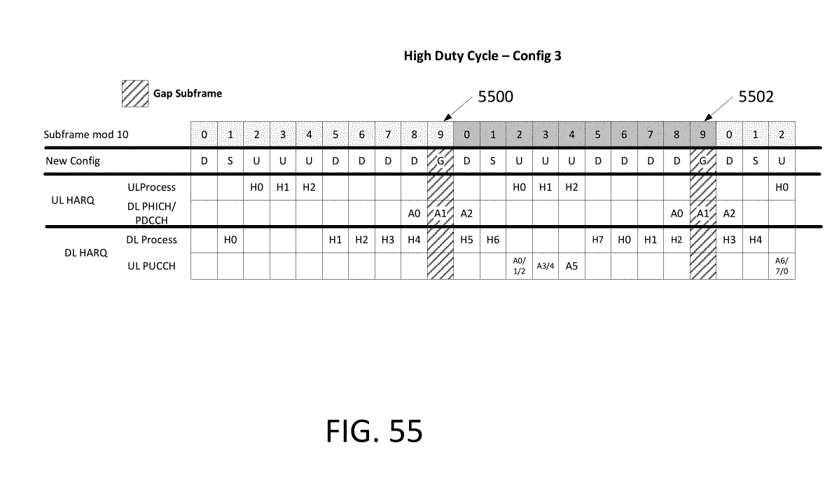

Duty cycles may be provided for TDD UL/DL Configuration 3. FIG. 55 depicts a high duty cycle gap pattern for TDD UL/DL Configuration 3. A coexistence gap may be created at 5500 and/or at 5502 by configuring subframe 9 as an MBSFN subframe. The coexistence gap may include symbols 3-14 of subframe 9 of one or more frames, which may yield approximately a 90% duty cycle.

The UL HARQ processes/timing may not be affected by the introduction of subframe 9 as a gap subframe, since HARQ ACK that may be sent on PHICH in this subframe may still be transmitted. As a result, the number of UL processes may be unaffected. For the DL HARQ, the timing of DL HARQ ACK/NACK relative to DL transmission may be the same as in Rel-8/10. Since subframe 9 may not be used for DL transmission by the eNB, the UE may not need to send HARQ ACK in subframe 4.

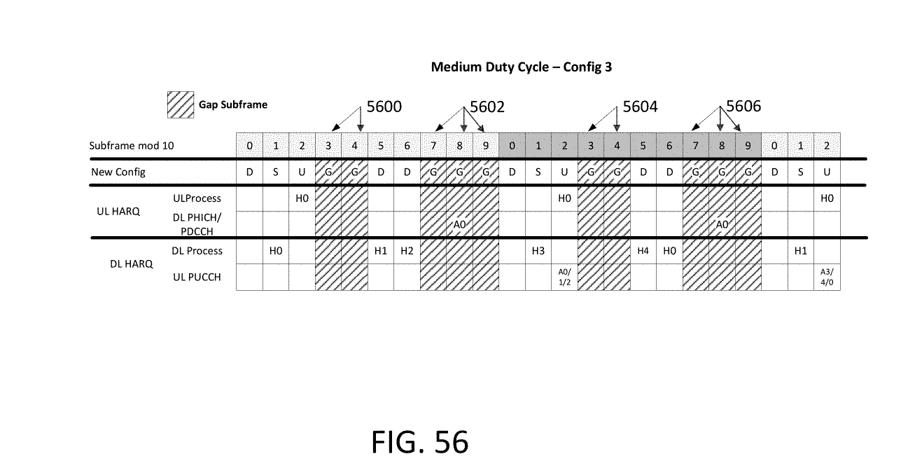

FIG. 56 depicts a medium duty cycle gap pattern for TDD UL/DL Configuration 3. A medium duty cycle may include a coexistence gap that may be created at 5600, 5602, 5604, and/or 5606 by having subframes 7, 8, and 9 configured as MBSFN subframes, and having subframes 3 and 4 configured as non-scheduled UL subframes. This may result in a coexistence gap configuration with approximately a 50% duty cycle. There may not be a change in the DL HARQ timing. Subframe 0 may not be used to transmit DL data. SIB/MIB and synchronization information may still be transmitted on this subframe. DL data may be transmitted in subframe 0, but an ACK/NACK may not be sent for this process by the UE. The eNB may assume a NACK for this DL transmission and may transmit a redundancy version for the same transport block at the next available opportunity for the DL HARQ process. The UE may then use the data received for both redundancy versions to decode the transport block before sending the ACK/NACK to the second transmission. Although not shown in FIG. 56, a DL HARQ process may be used in subframe 0.

Transmission of data in the DL may be allowed in subframe 0 by changing the DL HARQ timing compared to the current Rel-8/10 timing and by sending the ACK/NACK for DL transmissions in subframe 0 using the ACK/NACK resources in uplink subframe 2.

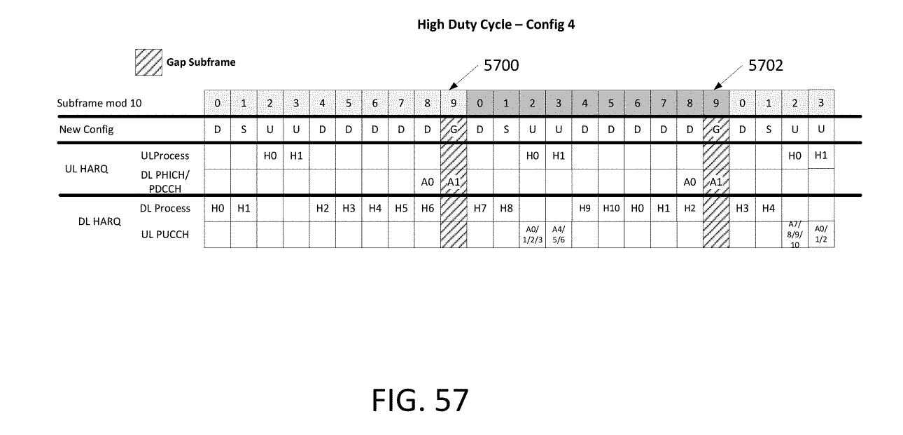

A gap pattern may be provided for TDD UL/DL Configuration 4. FIG. 57 depicts a high duty cycle gap pattern for TDD UL/DL Configuration 4. A coexistence gap may be created at 5700 and/or 5702 by configuring subframe 9 as an MBSFN subframe. The coexistence gap may include of symbols 3-14 of subframe 9 of one or more frames, which may yield approximately a 90% duty cycle.

The UL HARQ processes/timing may not be affected by the introduction of subframe 9 as a gap subframe, since HARQ ACK that may be sent on PHICH in this subframe may still be transmitted. The number of UL processes may be unaffected. For the DL HARQ, the timing of DL HARQ ACK/NACK relative to DL transmission may be the same as in Rel-8/10. Since subframe 9 may not be used for DL transmission by the eNB, the UE may send fewer ACK/NACK in subframe 3.

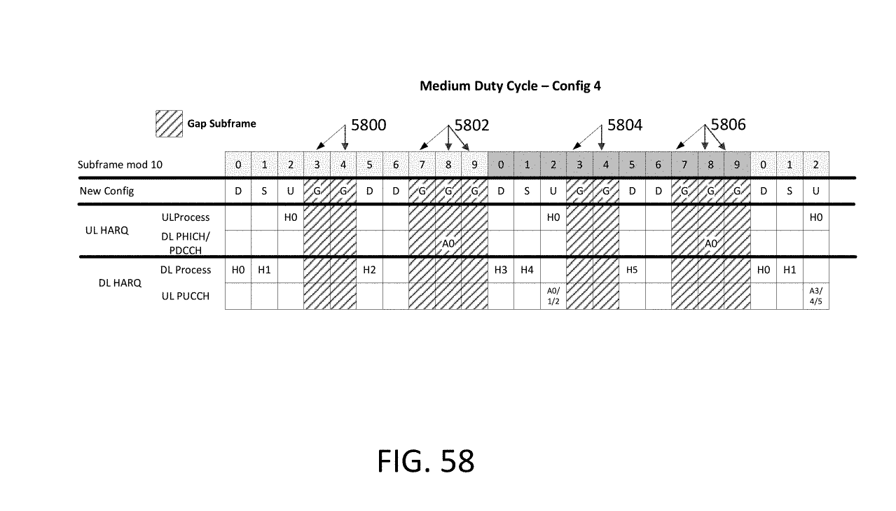

FIG. 58 depicts a medium duty cycle gap pattern for TDD UL/DL Configuration 4. A medium duty cycle may include a coexistence gap that may be created at 5800, 5802, 5804, and/or 5806 by having subframes 4, 7, 8, and 9 configured as MBSFN subframes, and by having subframe 3 configured as a non-scheduled UL subframe. This may result in a coexistence gap configuration with a 50% duty cycle. There may not be a change in the DL HARQ timing. Subframe 6 may not be used to transmit DL data. SIB/MIB and synchronization information may still be transmitted on this subframe. DL data may transmitted in subframe 6, but that an ACK/NACK may not be sent for this process by the UE. For example, A DL HARQ process may be used in subframe 6. The eNB may assume a NACK for this DL transmission and may transmit a new redundancy version for the same transport block at the next available opportunity for the DL HARQ process. The UE may use the data received for both redundancy versions to decode the transport block before sending the ACK/NACK to the second transmission.

Transmission of data in the DL may occur by changing the DL HARQ timing compared to the current Rel-8/10 timing and sending the ACK/NACK for DL transmissions in subframe 6 using the ACK/NACK resources in uplink subframe 2.

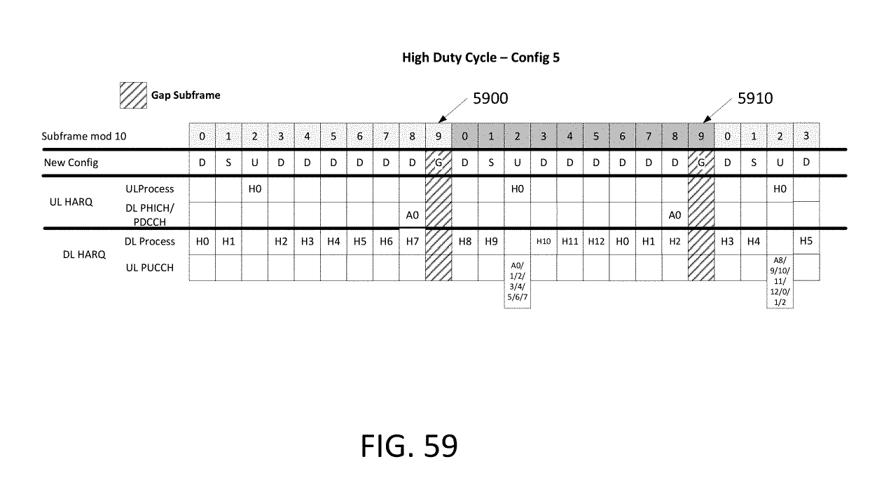

A gap pattern may be provided for TDD UL/DL Configuration 5. FIG. 59 depicts a high duty cycle gap pattern for TDD UL/DL Configuration 5. The coexistence gap may be created at 5900 and 5910 by configuring subframe 9 as an MBSFN subframe. The coexistence gap may include of symbols 3-14 of subframe 9 of a frame, which may yield approximately a 90% duty cycle.

The UL HARQ processes/timing may be not affected by the introduction of subframe 9 as a gap subframe, since there may not be a HARQ ACK that may be sent on PHICH in this subframe. The number of UL processes may be unaffected. For the DL HARQ, the timing of DL HARQ ACK/NACK relative to DL transmission may be the same as in Rel-8/10. Since subframe 9 may not be used for DL transmission by the eNB, the UE may send fewer ACK/NACK in subframe 2.

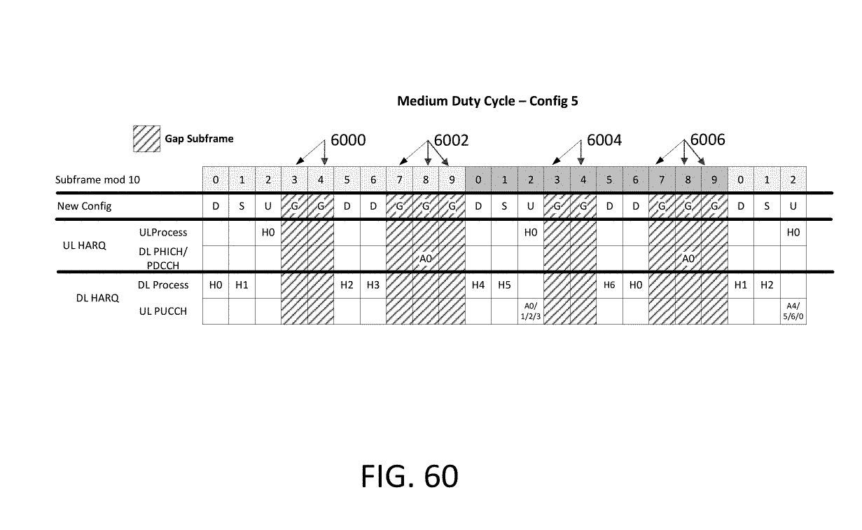

FIG. 60 depicts a medium duty cycle gap pattern for TDD UL/DL Configuration 5. A medium duty cycle may include a coexistence gap at 6000, 6002, 6004, and/or 6006 that may be created by having subframes 3, 4, 7, 8, and 9 configured as MBSFN subframes. This may result in a coexistence gap configuration with approximately a 50% duty cycle. There may not be a change in the DL HARQ timing with respect to LTE release 8/9. Since UL subframes may not have been removed, there may not be a change to the timing or number of processes for the UL HARQ. ACK/NACK opportunities may not have been removed as UL subframes may not have been removed. There may not be a change to the DL HARQ timing.

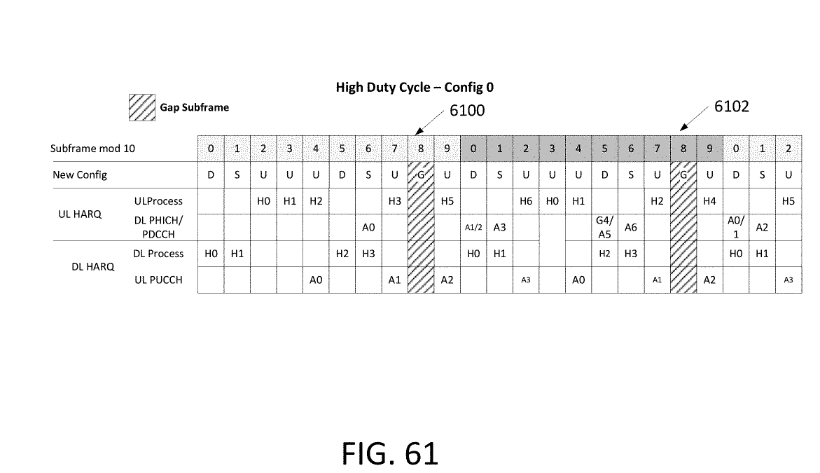

A gap pattern may be provided for TDD UL/DL Configuration 0. FIG. 61 depicts a high duty cycle gap pattern for TDD UL/DL Configuration 0. A coexistence gap may be provided at 6100 and/or 6102. Potential MBSFN subframes (such as 3, 4, 7, 8, and 9) may be UL subframes and may not be configured as MBSFN subframes. There may be fewer impacts to the HARQ and/or efficiency of DL by removing an UL subframe that may not carry HARQ ACK. A configuration may be provided by creating a coexistence gap at 6100 and/or 6102 by configuring subframe 8 as a non-scheduled UL subframe to yield a duty cycle that may be approximately 90%. Subframe 3 may also have been chosen to yield an equivalent solution.

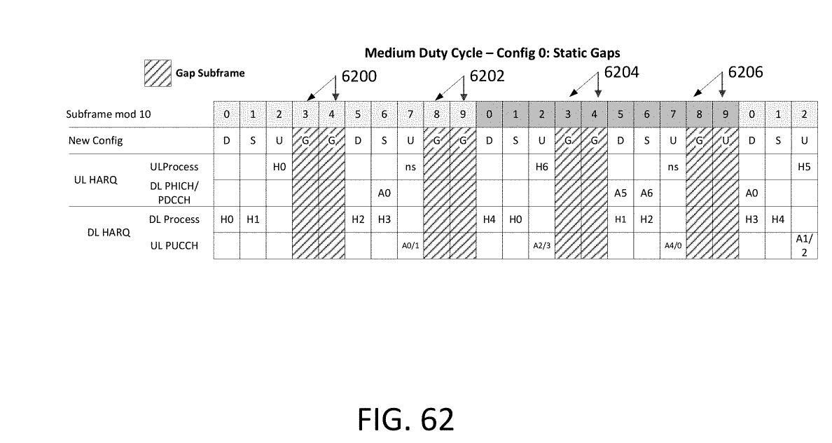

FIG. 62 depicts a medium duty cycle gap pattern for TDD UL/DL Configuration 0. A coexistence gap may be provided at 6200, 6202, 6204, and/or 6206. In TDD UL/DL configuration 0 the UL HARQ processes may have a route trip time (RTT) greater than 10. For a UL HARQ process x that may be transmitted in a given UL subframe in a frame, that same HARQ process may not be transmitted in the same subframe for the following frame.

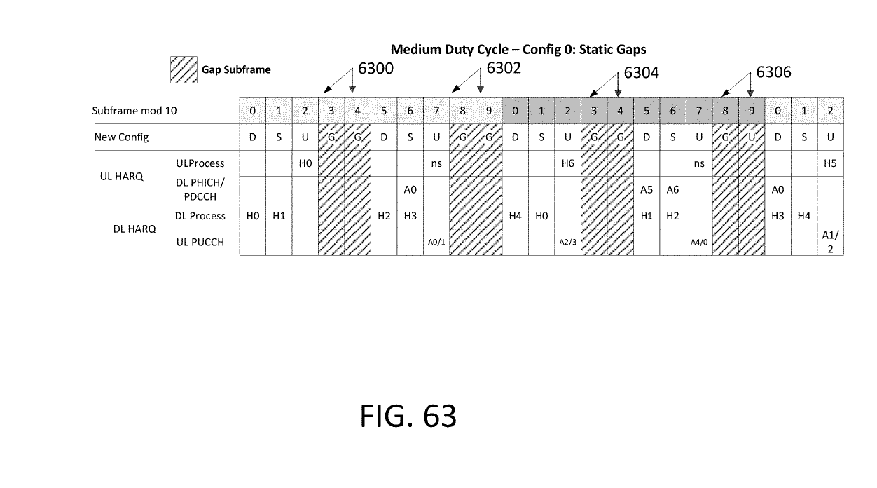

FIG. 63 depicts another medium duty cycle gap pattern for TDD UL/DL Configuration 0. Synchronous HARQ may be supported in the UL and a set of UL subframes may be allowed to be part of the gap and configured as non-scheduled UL subframes. This may be done, for example, by removing a number of UL HARQ processes, maintaining coexistence gaps in fixed locations on a frame by frame basis, and delaying UL HARQ process retransmissions until they may be scheduled to occur on non-gap subframes.

Static gaps, whose location may not move from one frame to the next, may be defined by removing a set of HARQ processes, and then allowing those HARQ processes to transmit when they coincide with a non-gap subframe. As shown at 6300, 6302, 6304, and 6306, subframes 3, 4, 8, and 9 may be configured as non-scheduled UL subframes. In the UL, the 7 HARQ processes (H0 to H6) may be cut down to 3 (H0, H5, H6). The numbering of the HARQ processes is arbitrary, and that the HARQ processes that may be chosen to remain in the configuration may be based on their relative transmit times and not their label or associated number.

Based on the current timing of UL HARQ processes in Rel-8, the subframe used for a process moves from one UL subframe to the next available UL subframe in the next frame. For example, process H0 may transmit in subframe 2 for one frame, and may transmit in subframe 3 (the next available UL subframe) in the next frame. The UE may avoid retransmitting on a process when that process may be scheduled to retransmit in a subframe that may be part of the coexistence gaps, such as the coexistence gaps at 6300, 6302, 6304, and 6306. To avoid retransmission, when a transport block has been sent by the UE on a process, the eNB may ACK the receipt of the transport block regardless of whether the transport block was received. This may avoid a retransmission by the UE in the next opportunity for that process (which may coincide with a gap). The eNB may trigger retransmission by the UE by using a grant where the NDI (New Data Indicator) may not have been toggled. The resulting HARQ timing may be seen in FIG. 63. For example, HARQ process 0 may transmit in UL subframe 2 in frame 1. If the transport block may be received by the UE in error, the eNB may send an ACK to this transport block, and may send a grant in subframe 0 of frame 4 with the NDI field not toggled. This may trigger retransmission in subframe 7 of frame 4 for the same transport block.

DL HARQ may behave in the same way as in the TDD UL/DL configurations (1-5) described herein where the DL HARQ timing remains unchanged.

The configuration shown in FIG. 63 may be used where the delay of UL traffic may not be unacceptable, or that the system may be aggregated with another component carrier that has a smaller UL RTT. For example, a Rel-10 component carrier in the licensed bands or an dynamic shared spectrum band component carrier that may not rely on coexistence gaps.

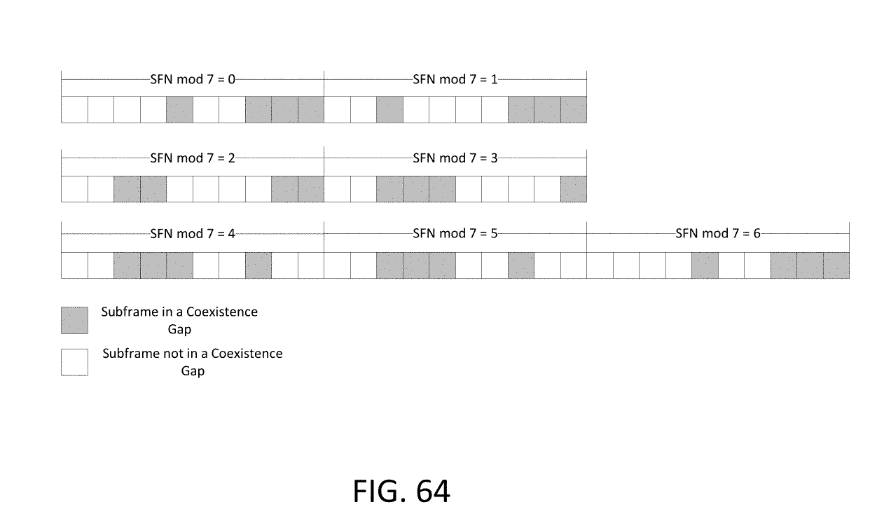

FIG. 64 depicts another medium duty cycle gap pattern for TDD UL/DL Configuration 0. Synchronous HARQ may be supported in the UL and a set of UL subframes may be allowed to be part of the gap and configured as non-scheduled UL subframes. A number of UL HARQ processes may be removed and the coexistence gap configuration may be created on a frame-by-frame basis by ensuring that the remaining HARQ processes coincides with an UL subframe that may not be part of the coexistence gap.

Coexistence gaps may be defined so as not to disrupt or collide with the HARQ processes that may remain after reducing the number of UL HARQ processes. Since the HARQ processes may return to being transmitted a given subframe following a certain number of frames, the coexistence gap pattern may vary from one frame to the next, but may have a periodicity (or may repeat itself after a certain number of frames). A gap pattern may be seen in FIG. 64 that may have a periodicity of 7 subframes. For example, all frame SFN(x) mod 7 may have the same coexistence gap pattern.

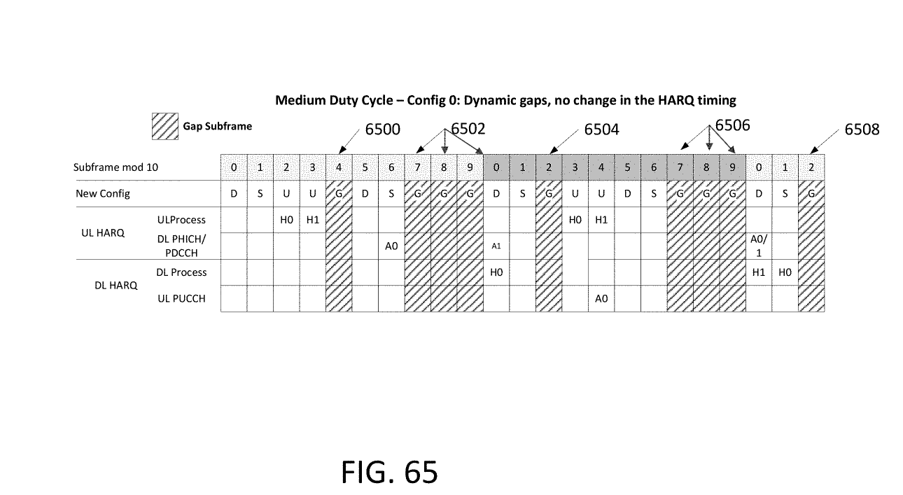

There are a number of possibilities to deal with the DL HARQ. FIG. 65 depicts another medium duty cycle gap pattern for TDD UL/DL Configuration 0 where there may not be a change in DL HARQ timing. Coexistence gaps may be provided at 6500, 6502, 6504, 6506, and 6508. The eNB may avoid making any transmissions which may request ACKs in the UL subframes that may fall in a coexistence gap subframe. The restrictions may change from subframe to subframe, however, the DL HARQ timing may remain as it is in Rel-8 LTE. Several DL subframes that may not be a part of a coexistence gap may not be used to transmit DL data. SIB/MIB and synchronization may still be sent. The DL data may be transmitted in these DL subframe (i.e. a DL HARQ process may be used in subframe 6), but an ACK/NACK may not be sent for these processes by the UE. In that case, the eNB may assume a NACK for this DL transmission and may transmit a new redundancy version for the same transport block at the next available opportunity for the DL HARQ process. The UE may then use the data received for both redundancy versions to decode the transport block before sending the ACK/NACK to the second transmission.

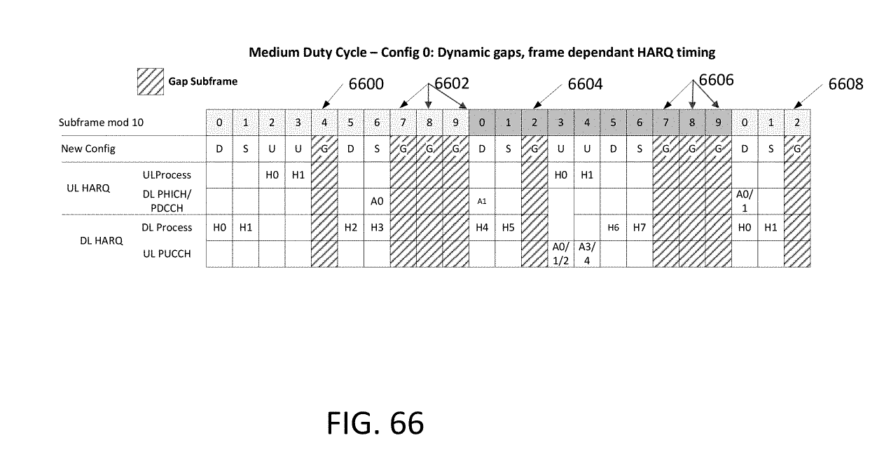

FIG. 66 depicts another medium duty cycle gap pattern for TDD UL/DL Configuration 0 where DL HARQ timing may be frame dependent. Coexistence gaps may be provided at 6600, 6602, 6604, 6606, and 6608. DL HARQ timing may be changed with respect to Rel-8 LTE to allow DL transmission on a DL subframe that may not be part of the coexistence gap. The DL HARQ timing rules may vary from one frame to another with the same 7-frame periodicity as the gap pattern itself.

A gap pattern may be provided for TDD UL/DL Configuration 6. TDD UL/DL configuration 6 may have the same property of UL RTT>10 as configuration 0. A coexistence gap may be defined similar to that of that of configuration 0. Coexistence gaps and TDD HARQ timing may be defined as disclosed herein with regards to configuration 0.

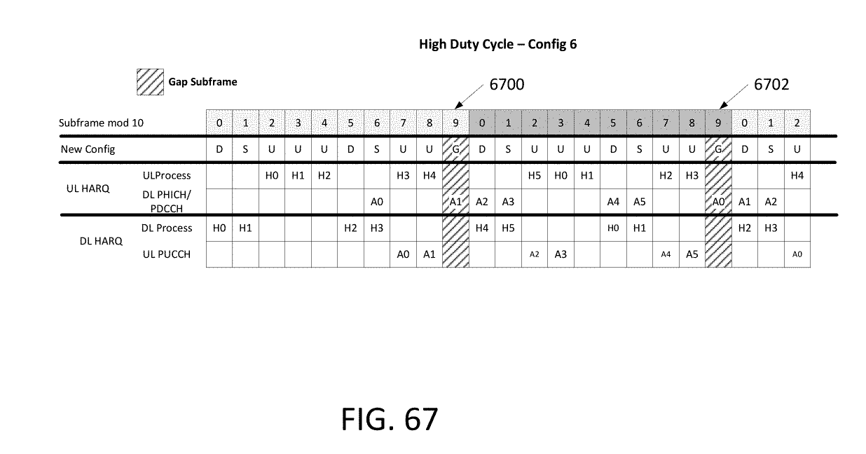

FIG. 67 depicts a high duty cycle gap pattern for TDD UL/DL Configuration 6. Subframe 9 may be configured as an MBSFN subframe. This may be done, for example, to provide a coexistence gap at 6700 and/or 6702.

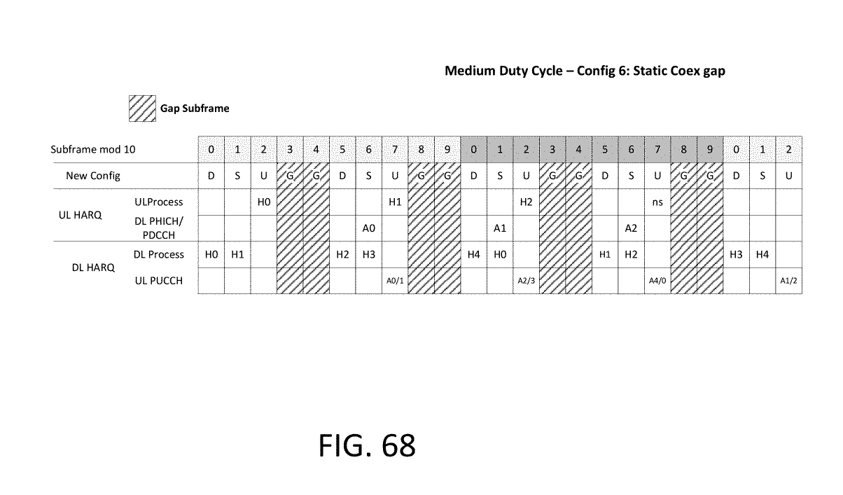

As with UL/DL configuration 0, a number of methods may be used when dealing with UL HARQ RTT>10. FIG. 68 depicts a medium duty cycle gap pattern for TDD UL/DL Configuration 6 where there may not be a change in DL HARQ timing. As shown in FIG. 67, the duty cycle gap pattern for TDD UL/DL Configuration 6 may be similar to that of TDD UL/DL configuration 0, which is shown in FIG. 63. Referring again to FIG. 67, coexistence gaps may be provided at 6800, 6802, 6804, and/or 6806.

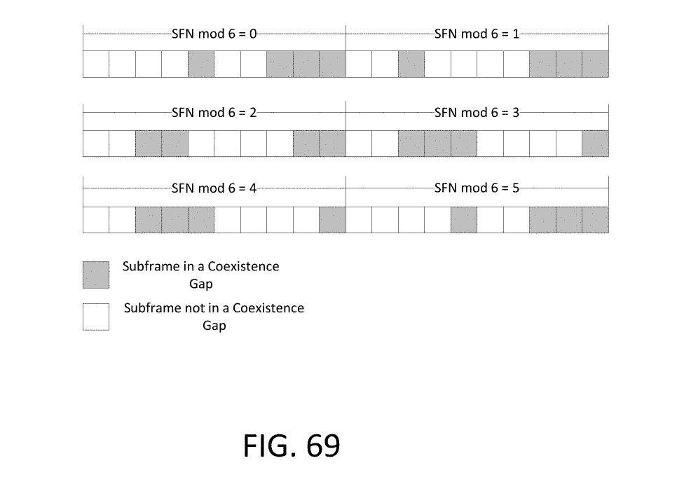

FIG. 69 depicts another medium duty cycle gap pattern for TTD UL/DL Configuration 6. As in the case of TDD UL/DL configuration 0, a duty cycle gap pattern for TTD UL/DDL Configuration 6 may include defining a gap pattern that may change from one frame to another, but may be periodic after a certain number of frames. The period in the case of TDD UL/DL configuration 6 may be 6 frames, so frames with SFN mod 6 may have the same gap configuration.

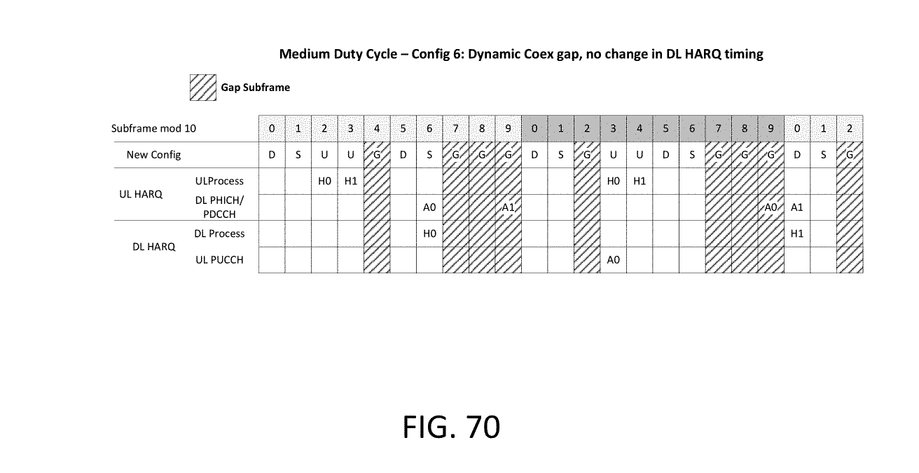

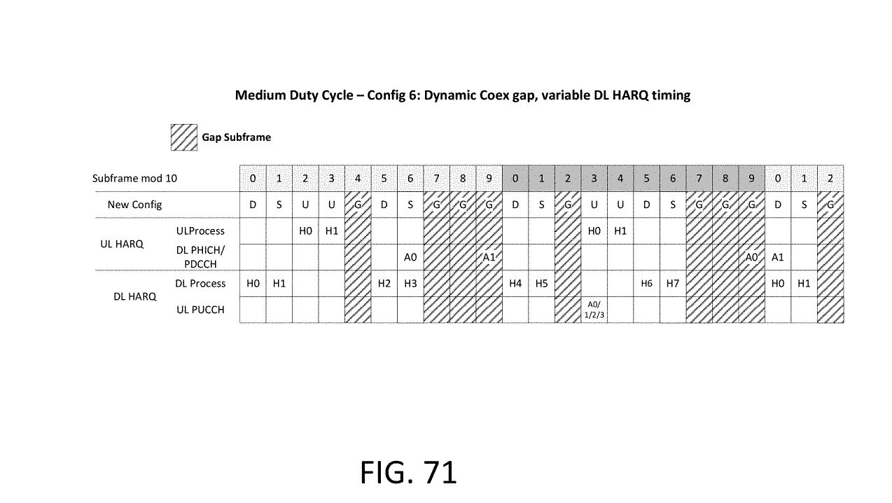

A number of options for DL HARQ timing may be used for a medium duty cycle gap pattern for TDD UL/DL Configuration 6 where there may not be a change in DL HARQ timing. FIG. 70 and FIG. 71 show two options for DL HARQ timing that may be applied to TDD UL/DL configuration 6. FIG. 70 depicts a medium duty cycle configuration for TDD UL/DL Configuration 6 where there may not be a change in DL HARQ timing. FIG. 71 depicts a medium duty cycle configuration for TDD UL/DL Configuration 6 where DL HARQ timing may be frame dependent. FIG. 70 may be similar and may be use similar rules disclosed herein for TDD UL/DL configuration 0, such as FIG. 65. FIG. 71 may be similar and may be use similar rules disclosed herein for TDD UL/DL configuration 0, such as FIG. 66.

Although not shown in FIG. 70 and FIG. 71, a DL data may be transmitted in DL subframes that may not have a HARQ process assigned to them but may not be in a coexistence gap (e.g. these DL subframes may not have a HARQ ACK/NACK that may be possible for them), but that an ACK/NACK may not sent be for this process by the UE. The eNB may assume a NACK for this DL transmission and may transmit a new redundancy version for the same transport block at the next available opportunity for the DL HARQ process. The UE may use the data received for both redundancy versions to decode the transport block before sending the ACK/NACK to the second transmission.

Almost blank subframes may be used for coexistence gaps. The UEs receive the pattern of the Almost Blank Subframes through RRC signaling. During an Almost Blank Subframe, a UE may not measure the cell specific reference signals which may be transmitted during the Almost Blank Subframe. To avoid interference to Wi-Fi system and the potential of the Wi-Fi system backing off, the cell specific reference signals may be sent by the eNB with reduced power during the almost blank subframes.

Coexistence Gaps may be provided during UL subframes. Coexistence gaps may be created by the eNB through the absence of scheduling of uplink traffic for a certain number of consecutive subframes. These non-scheduled uplink subframes may coincide with subframes in which no UEs may have been scheduled to transmit sounding reference signals (SRS) in the uplink.

If the interference from secondary users (SUs) may be localized, the eNB may use the UL channel estimates to identify which UEs may suffer from interference from SU. The eNB may create gaps in the LTE transmission in an area, by not scheduling UL transmissions for the UEs. The eNB may ensure that these gaps in UL transmission may not overlap with SRS transmissions from the UEs that may be affected by the secondary user interference.

Control channel enhancements may be provided for Wi-Fi interference avoidance. The MBSFN and ABS schemes for gap creation may use MBSFN subframes or ABS subframes in LTE as the coexistence gaps to enable Wi-Fi to transmit on the channel. When doing so, the Wi-Fi may incur some interference on the LTE system during the first few OFDM symbols during that the LTE system may like to regain access to the channel at the end of the coexistence gap. There may be scenarios where a coexistence gap may include of multiple successive MBSFN subframes and the PDCCH or PHICH in one of those MBSFN subframes may be used to send an UL grant or UL HARQ ACK/NACK.

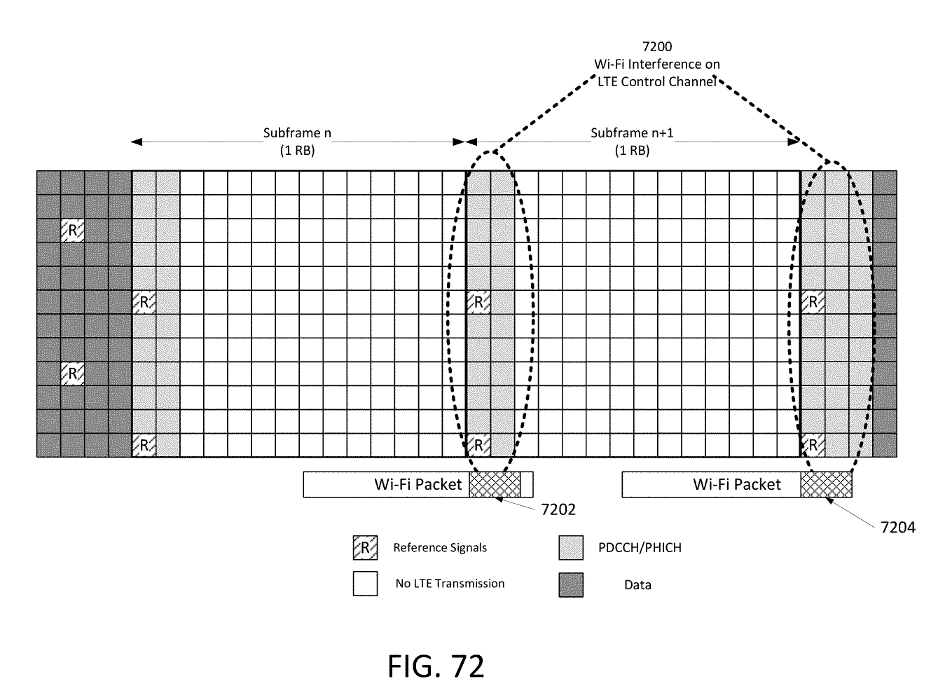

FIG. 72 depicts interference on a control channel from Wi-Fi. FIG. 72 may illustrate the locations of the control channel that would have the highest likelihood to suffer from Wi-Fi interference in the scenario where the coexistence gap may include of two subsequent MBSFN subframes and the subframe immediately following the gap may be a DL subframe. As shown at 7200, the two symbol control channel in MBSFN subframe n+1 and the control channel in subframe n+2 may have interference due to Wi-Fi packets at 7202 and 7204, which may have started transmission within the gap and may have extended into either control channel.

This same interference problem may exist with other methods for gap creation (e.g. transparent frames) in the subframe that follows the coexistence gap. The methods described herein may be applicable to those scenarios as well.

As shown in FIG. 72, the subframes where the control channel may suffer interference from the Wi-Fi system may include:
A downlink subframes that may follow a coexistence gap and that may be used to transmit control in the form of DL allocations, UL grants, etc.
A MBSFN subframes that may be used for coexistence gaps (not including when they may be the first or only subframe of a gap) and where the TDD UL/DL configuration may allow for UL grants or UL HARQ ACK to be transmitted in these MBSFN subframes.

These subframes may be referred to as control channel interference potential (CCIP) subframes.

The physical channels/signals that may occur within the two control symbols in the MBSFN subframe, or within the up to 3 symbols of a DL subframe which follows the gap may be PCFICH, reference symbol (RS), PDCCH, PHICH, or the like.

The PCFICH may indicate the length of the control channel region (1, 2, or 3) of the current subframe. To avoid potential interference with PCFICH, the control channel region for CCIP subframes may be statically or semi-statically set by the system so that they may not send PCFICH. Based on the TDD UL/DL configuration, the CCIP subframes may be known by the eNB and the UE without signaling beyond the TDD UL/DL configuration and the duty cycle. As a result, the length of the control channel region may be fixed for these subframes. For example, the convention may be used whereby MBSFN subframes that may be CCIP subframes may use a control region that may be 2 OFDM symbols long and the non-MBSFN subframes that may be CCIP may use a control region that may be 3 OFDM symbols long, regardless of the settings of other values in RRC. The length of the control region for non-CCIP subframes may be determined by the PCFICH. The system may set the length of the control region for DL subframes (both CCIP and non-CCIP) to a value (e.g. 2 for MBSFN and 3 for non-MBSFN). Separate semi-static signaling through RRC may be used to set the length of the control region for the CCIP subframes, while another RRC IE may set the value for the non-CCIP.

The length of the control region for CCIP subframes may be set statically or semi-statically, and so the PCFICH in the CCIP subframes may not be needed. Resource elements that may be assigned to the PCFICH in these subframes may be reassigned to PHICH or PDCCH as described herein. The UE procedures for decoding the control channels for CCIP subframes may take into account that resource elements that may be decoded for PCFICH may be decoded for PDCCH or PHICH instead. If the subframe in question may be a non-CCIP subframe, the UE may decode PCFICH to determine the length of the control channel. If the subframe in question may be a CCIP subframe, the UE may assume a fixed or semi-static length for the control channel region. The resource elements that may normally be reserved for PCFICH in this subframe may be part of PHICH or PCFICH.

Resource elements associated with PCFICH may remain unused (transmitted with zero power) and resulting power may be re-allocated to other resource elements within the same OFDM symbol.

The reference symbols (RSs) transmitted within the control channel region of the CCIP subframes may also suffer from interference from the Wi-Fi systems. Such interference may skew the calculation of CQI that is performed by the UE. It should also be noted that for LTE Rel-10, CQI calculations do not consider MBSFN subframes as valid subframes.

A UE may take into account the presence of potential Wi-Fi interference in these RSs when performing CQI calculations. The UE may maintain a number of CQI measurements. For example, CQI measurements may be performed on RSs where there may a high likelihood of interference from Wi-Fi (e.g. CCIP subframes and non-CCIP subframes that may be MBSFN subframes that fall in a gap). This CQI measurement may exclude the first MBSFN subframe of a gap, which may not have interference. As another example, CQI measurements may be performed on other RSs (where interference from Wi-Fi may be less likely).

The CQI measurements performed on the RSs with high likelihood of interference may be used as a measurement to quantify the amount of Wi-Fi traffic on the channel by, for example, comparing this CQI value with the CQI value computed using the other RSs. The difference in these two CQI values may be used as an indication for the amount of Wi-Fi traffic on a channel. Scheduling decisions may be based on the CQI value determined from the non-interference RSs. The UE may report both CQI values (the interference RS based and non-interference RS based) to the eNB to enable scheduling decisions and to trigger decisions that may be related to the amount of Wi-Fi interference (e.g. changing the operating channel or changing the coexistence duty cycle).

Methods herein may be used to avoid the interference caused by Wi-Fi on the PDCCH and/or PHICH of the LTE system.

Robustness of the control channel may be provided. For example, PHICH robustness may be provided. The robustness of PHICH may be increased to allow it to be decoded despite the presence of Wi-Fi interference. In this case, the amount of resources assigned to a UE for a PHICH may be increased. This may be done, for example, by mapping two or more PHICH resources to a UE. For a UL grant that may request to be ACK/NACK′d with PHICH in a CCIP subframe, the eNB may use two or more PHICH resources to transmit the ACK/NACK. The PHICH resources may be used to increase the coding of the PHICH channel, or transmit the coded ACK/NACK multiple times to increase the probability of detection at the UE. An UL grant to a UE may allocate two PHICH resources for transmission of the ACK/NACK. This may be extended so that three or more PHICH resources may be used for the ACK/NACK to that UE.

A PHICH resource may be allocated to a UE by assigning two PHICH groups for transmission by that UE. Currently in LTE, a single PHICH group assigned to the UE is a function of the resource block assigned in the UL grant to that UE and the demodulation reference signal (DMRS) used by the UE, as defined in the following equation:

n_{PHICH}^{group}=(I_{PRB}_{_}_{RA}+n_{DMRS})mod N_{PHICH}^{group}+I_{PHICH}N_{PHICH}^{group}

As disclosed herein, to assign an additional PHICH group to be used by a UE, the above equation may be extended to assign a UE with two consecutive PHICH groups. The equations dictating the PHICH groups assigned to a UE may be as follows:

n_{PHICH1}^{group}=(I_{PRB}_{_}_{RA}+n_{DMRS})mod N_{PHICH}^{group}+I_{PHICH}N_{PHICH}^{group}

n_{PHICH2}^{group}=I_{PRB}_{_}_{RA}+n_{DMRS})mod N_{PHICH}^{group}+I_{PHICH}N_{PHICH}^{group}+1

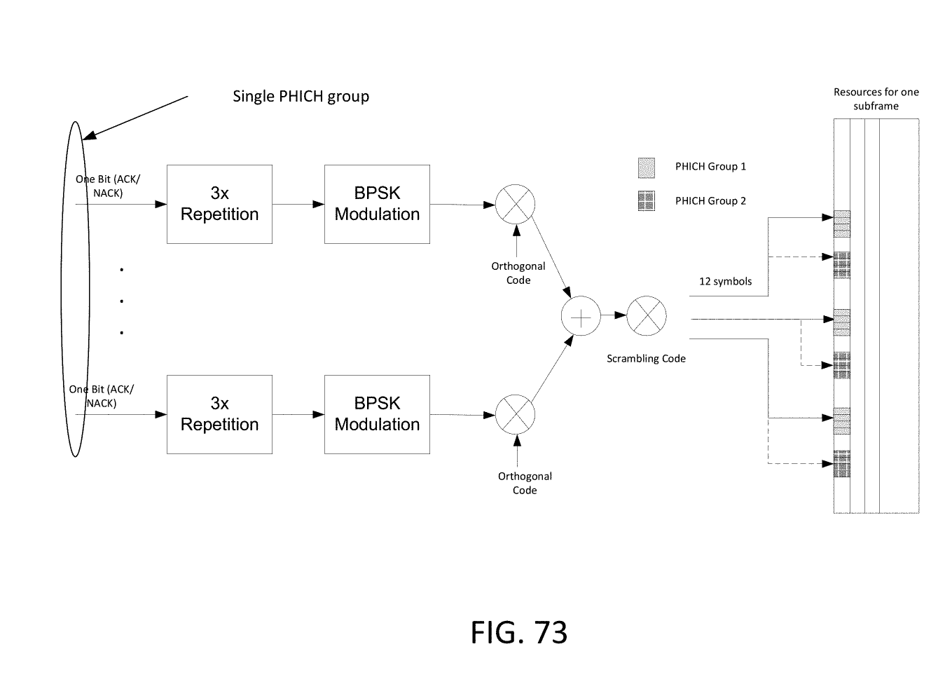

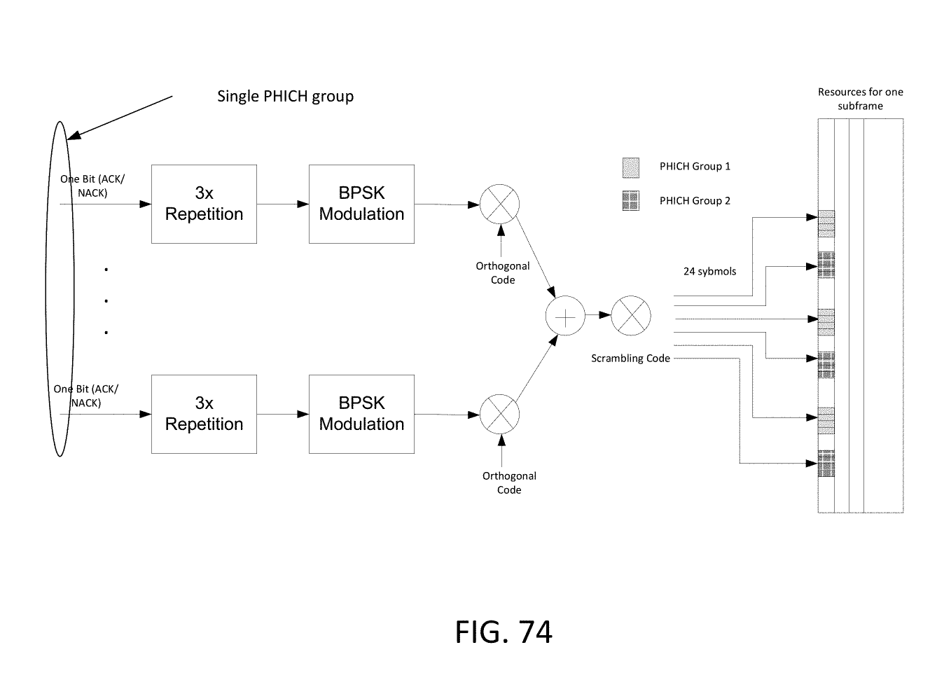

With two groups assigned to a UE (using the above equations) the eNB may have 24 OFDM symbols or resource elements that may be used to transmit the ACK/NACK to a UE for a given UL grant. A number of approaches may then possible from the point of view of the eNB. For example, FIG. 73 depicts coded PHICH that may be repeated over two PHICH groups. As shown in FIG. 73, the eNB may repeat the 12-symbol scrambled PHICH (which may include the ACK/NACK of UEs assigned to the same PHICH group) and may send the repeated value on the second PHICH group. As another example, FIG. 74 depicts increase coding of PHICH, which may use a 24-symbol scrambling code. As shown in FIG. 74, the eNB may double the size of the scrambling code (from 12 used today to 24) to increase the coding that may be applied to the data transmitted in the PHICH group. The resulting 24 symbol PHICH may be assigned to the two PHICH groups given in the above equations.

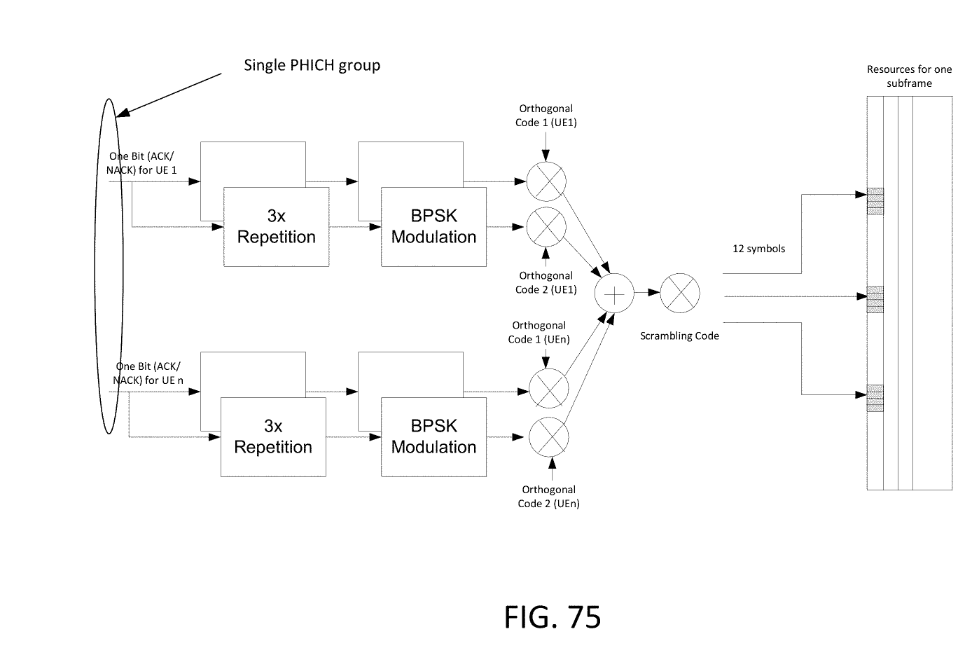

Another method to increase the number of PHICH resources used to transmit ACK/NACK may be to keep the same PHICH group but send the ACK/NACK to a UE using two different orthogonal codes. FIG. 75 depicts increasing PHICH robustness using two orthogonal codes per UE. The UE may receive the same coded ACK/NACK but with two orthogonal codes, which may provide redundancy. The equation for the PHICH group number may remain the same, but the two orthogonal codes may be used for a UE, given by the following equation:

n_{PHICH}^{seq}=(└I_{PRB}_{_}_{RA}/N_{PHICH}^{group}┘+n_{DRMS}+1)mod 2N_{SF}^{PHICH}

Although examples described herein for increasing PHICH robustness in CCIP subframes may be described as being applied to CCIP subframes, that is just an example of the applicability of the methods. The methods may also be applicable for other subframes for UEs that may operate on the dynamic shared spectrum (DSS) bands.

PDCCH Robustness may be provided using preconfigured PDCCH parameters. PDCCH in CCIP subframes that may be MBSFN subframes may be used to schedule UL grants or to signal adaptive retransmissions. CCIP subframes, which may not be MBSFN subframes (such as the first subframe following a gap, if it is a downlink subframe) may be used for UL grants and DL allocations, sending power control messages, or the like. Interference caused by Wi-Fi on CCIP subframes may cause missed DL allocations and UL grants, which may reduce the efficiency of the LTE resources and may lead to decreased LTE throughput and increased latency.

Preconfigured PDCCH parameters for DL allocations and UL grants for a UE may be used to improve the robustness of PDCCH during CCIP subframes. While the grants themselves may continue to be made during the CCIP subframes, many of the parameters associated with the grant may be set in the PDCCH of non-CCIP subframes that may occur prior to the subframe where the grant or allocation may take effect.

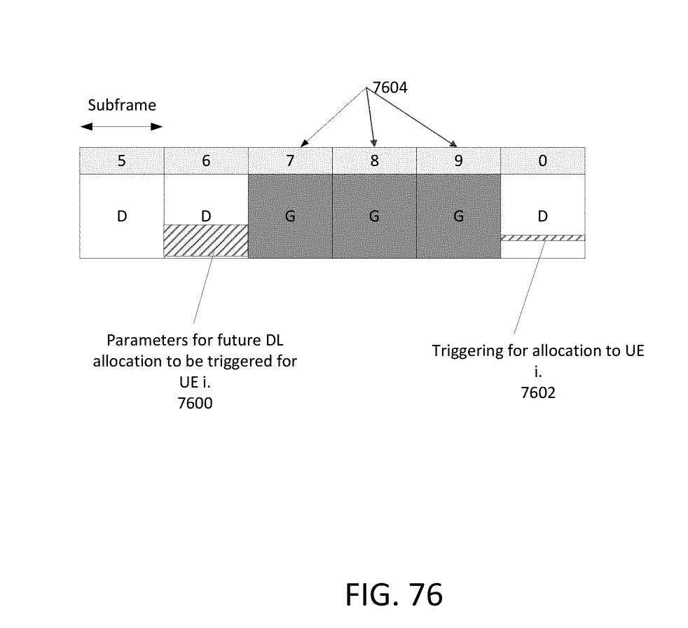

FIG. 76 depicts a preconfigured PDCCH that may be used for a TDD UL/DL configuration. For example, FIG. 76 illustrates the mechanism of pre-defined parameters for TDD UL/DL configuration 4 when using MBSFN subframe method for gap definition and a medium duty cycle configuration. In this configuration, at 7604, a gap may be defined in subframes 7, 8, and 9. Subframe 0 may be a CCIP subframe. At 7600, DL allocations made to UEs in subframe 0 may be made by configuring some of the parameters associated with the DL allocation using a separate DCI message sent in subframe 6. Since subframe 6 is a non-CCIP subframe, the PDCCH in this subframe may be more reliable and potentially free of Wi-Fi interference. Since most of the data in the DL allocation to be made in subframe 0 has been sent to the UE, the DCI message which the DL allocation in subframe 0 may carry little data and may be encoded with a larger amount of redundancy while keeping the same effective coded PDCCH. At 7602, an allocation to the UE may be triggered.

Signaling pre-configured parameters to a UE may be done for a grant or allocation that may be sent on a CCIP subframe. The configuration may also be defined in such a way that the preconfigured parameters that may be in a non-CCIP subframe may be valid for CCIP allocations/grants that may follow the preconfiguration, until the next preconfiguration, or until preconfiguration may be turned off through signalling by the eNB.

The parameters associated with a grant/allocation that may be preconfigured may depend on the implementation. The following table illustrates an embodiment that may split the information present in DCI format 1A (for downlink assignments) and DCI format 0 (for UL assignments) into parameters to be sent with the preconfiguration DCI message and parameters to be sent with the grant/allocation message:

| Format 1A Parameters | | Format 0 Parameters | |
|---|---|---|---|
| Preconfiguration DCI | DL Allocation DCI | Preconfiguration DCI | UL Grant DCI |
| Message | Message | Message | Message |
| Format 0/1A Indication | Redundancy Version | Format 0/1A Indication | Redundancy Version |
| Resource Block Assignment | New-data indicator | Hopping flag | New-data indicator |
| Modulation and Coding | HARQ Process Number | Resource block assignment | |
| Scheme | | Modulation and Coding | |
| PUCCH Transmit power | | Scheme | |
| control | | | |
| Downlink Assignment Index | | | |

The preconfiguration message may be sent with the existing DCI format that may otherwise be used to send the actual grant/allocation. A flag or identifier may be used to indicate that the grant allocation may not apply to the current subframe but rather for the next CCIP subframe. The flag may use a RNTI for a UE to specify the semi-static or one-shot preconfiguration of grant/allocation parameters. For the DCI message that may trigger the grant/allocation, a shorter DCI format (e.g. format 1C) may be used with flags to signal the presence of a triggering DCI format. A DCI format may also be created for triggering the grant/allocation message that may be large enough to hold the information bits from allocation/grant message in the table above. To prevent increasing the number of blind decodings, in a CCIP subframe, a UE may search for format 1C or for this DCI format for grants and allocations as other formats allowing power control commands may also be transmitted. In other words, for CCIP subframes, the UE may decode format 1C in the UE search space.

To decode preconfigured information the UE may decode DCI messages using blind decoding on non-CCIP subframes. The UE may receive preconfigured information in a DCI format encoded with a RNTI that may indicate that this DCI message may be for sending preconfigured information. DCI formats with the RNTI to signal preconfigured information may be of the same length as Rel8/10 DCI formats. However, the contents may include corresponding fields for the preconfiguration DCI format that may exist in their current form and may be decoded by the UE to obtain the preconfiguration information (e.g. the resource block assignment for the grant in the CCIP subframe may be obtained by the corresponding field in format 0 DCI format sent in the non-CCIP subframe). The fields in the preconfiguration DCI message that contained the information may be sent with the allocation/grant and may be used to send timing information that may be related to that allocation/grant.

On CCIP subframes, a UE that may have received some preconfigured information that may apply to this CCIP subframe may perform blind decoding in the UE search space for the shorter DCI format (e.g. format 1C) or a DCI format that may trigger the grant or allocation. In the case where format 1C may be received, the UE may search for format 1C using the C-RNTI. When the DCI message may be found, the UE interprets this DCI message. The fields in the DCI format corresponding to the information in the grant/allocation message (e.g. redundancy version) may be found in the same location as currently sent in DCI format 1C. The other fields in the DCI format may be unused, or may contain additional coding transmitted by the eNB to improve the robustness of the information.

Some of the unused fields in the DCI format for the grant may be used to signal to the UE that this grant may correspond to a grant having a previously transmitted pre-configuration message. In this case, the UE may determine whether it missed the pre-configuration message or any change in the pre-configuration (e.g. the grant may contain a short counter to maintain an ID associated with the pre-configuration message). If the UE receives a grant and realizes it may not have properly received the pre-configuration message, it may inform the eNB and the eNB may transmit the pre-configuration DCI message on the next available opportunity. The UE may inform the eNB of this error condition by sending this information when sending the NACK to the data. The UE may also transmit this information using a dedicated signal for this on the PUCCH (e.g. the reuse of some of the SR resources to signal the receipt of a CCIP grant without the decoding/reception of the pre-configuration message that goes with it).

The above procedure may be modified to have the grant (using format 1C) transmitted in the common search space using the C-RNTI.

PDCCH robustness may be provided using an increased aggregation level. To ensure PDCCH robustness during the CCIP subframes, the eNB may artificially increase the aggregation level to send PDCCH during the CCIP subframes. The eNB may measure (through periodic CQI measurements) the aggregation level to transmit a DCI format to a specific UE while maintaining a PDCCH error rate. When the eNB is faced with transmitting a DCI format on a CCIP subframe, it may increase the aggregation level used to transmit on the PDCCH of the CCIP subframe.

Based on the method for RS interpretation and CQI measurement described herein, the UE may report separate CQI measurements to the eNB: one on RSs that may have little impact from Wi-Fi interference, and another on RSs that may be likely to be affected by Wi-Fi interference. The CQI measurements from RSs that may not be affected by Wi-Fi may be used to determine an aggregation level to be used. This aggregation level may then be increased by a number (e.g. from aggregation level L=2 to aggregation level L=8) to be determined by the eNB. The eNB may use some indication of the number of Wi-Fi systems accessing the channel, which may be derived from the difference between the two CQI measurements reported by the UE or by information that may be reported from an external coexistence function or database that may have knowledge of secondary systems using the specific channel in the DSS.

HARQ procedures may be modified to avoid Wi-Fi interference. PDCCH may replace PHICH. When decoding PHICH, NACK-to-ACK errors may be a concern. As the SINR decreases due to the presence of Wi-Fi on the channel, the likelihood of a NACK-to-ACK error may increases.

ACK/NACK may be sent to UL HARQ transmissions using the PDCCH to avoid the NACK-to-ACK errors. If HARQ ACK/NACK may be sent using PDCCH, a NACK-to-ACK error may require a false positive for blind decoding. A false positive for a low-SINR UE may have a bit error probability of Pₑ=0.5 is on the order to 10⁻⁵. This value may represent the decoding of a CRC. The false positive in question may be interpreted as an ACK, which may mean that data sent using PDCCH may include the information to tie the message with an ACK for the UL transmission in question. For this reason, replacement of PHICH by PDCCH for the CCIP subframes may result in a robust mechanism for avoiding NACK-to-ACK errors that may be used to avoid excessive performance degradation due to Wi-Fi interference.

In replacing PHICH by PDCCH for the CCIP subframes, the control channel region may not use PHICH resource elements. As a result, the control channel region for the CCIP subframes may include RSs and resource elements available for PDCCH. An eNB may send HARQ ACK/NACK for UL transmission by a UE using an UL grant via PDCCH. The UE may use a procedure for HARQ ACK/NACK decoding during a CCIP subframe (for non-CCIP subframes, the UE may simply follow a procedure for PHICH/PDCCH decoding).

For HARQ ACK/NACK decoding during a CCIP subframe, if the UE is expecting HARQ ACK/NACK on a CCIP subframe, it may expect this HARQ ACK/NACK on the PDCCH. Since PHICH may not be present, the PDCCH resources may be defined in the control channel region as there may be not be resources allocated to PHICH. If the UE detects an UL grant where the NDI is not be toggled, this may represent a NACK and the UE may retransmit the transport block according to the assignment and MCS in the grant. If the UE detects an UL grant where the NDI is toggled, this may represent an ACK and a subsequent UL grant for the same process number. Depending on the resource block and MCS value assigned, this may indicate, if a value for the resource assignment and/or MCS may be used, that the decoded message may serve as an ACK and may not specify a new grant. If the resource assignment and MCS includes an acceptable value, this may indicate that the decoded message may be interpreted as an ACK and a new grant for the process number.

A HARQ ACK that may not include new grants may be sent with a new DCI format or an existing DCI format (e.g. format 1C) whose fields may be modified to support sending a single bit ACK/NACK. This may allow a single bit ACK to be sent using a shorter DCI format. A NACK signaling a non-adaptive retransmission for this process may also be sent using the shorter DCI format.

The UE may perform fewer blind decodings during CCIP subframes that may be also MBSFN subframes. The eNB may use a subset of the search space aggregation levels (e.g. aggregation level L=8) on a CCIP subframe. CCIP subframes that may also be MBSFN subframes, may not require decoding for DCI formats that may specify DL assignments or power control messages. The number of blind decodings may be decreased, for example, to 2.

Control channel resources may be defined in the data space of a previous subframes. A mechanism for avoiding interference on CCIP subframes may be provided by sending the control channel (PDCCH, PHICH, or both) in the data portion of subframes that may occur prior to the CCIP subframes (e.g. prior to the gap). The control channel resources in these subframes may apply to operations (grants, allocation, etc) that may apply to the CCIP subframes.

The use of PDCCH in CCIP subframes through semi-persistent scheduling may be avoided. A method for avoiding interference on PDCCH in CCIP subframes may be provided by ensuring that allocations and grants made for these subframes may be done using semi-persistent scheduling. The signaling to start and stop semi-persitent scheduling may be sent on non-CCIP subframes. A UE may signal the eNB when a semi-persistent grant may be unused through a signal on the PUCCH, or by sending this signal in the grant on the PUSCH itself. This may avoid having the eNB decode the PUSCH incorrectly when the UE may not have data to send in the semi-persistent grant that may have been made for the CCIP subframe.

To provide a greater flexibility for grants that may be made using semi-persistent scheduling, the maximum number of resource blocks that may be for the grants scheduled with semi-persistent scheduling may be relaxed.

A number of methods may be provided to force Wi-Fi off a channel. This may be done, for example, to avoid interference between Wi-Fi and PDCCH/PHICH by having the LTE system transmit prior to the control channel on the CCIP subframe. The Wi-Fi system may defer prior to the start of the LTE control channel. As the amount of LTE transmission that may occur prior to the control channel increases, the probability that this may cause Wi-Fi to defer may also increase. Remaining interference from Wi-Fi may be due to Wi-Fi systems that may have started to transmit in the coexistence gap and whose packet length may be long enough to span the LTE transmission prior to the control channel in the CCIP subframe and the control channel itself.

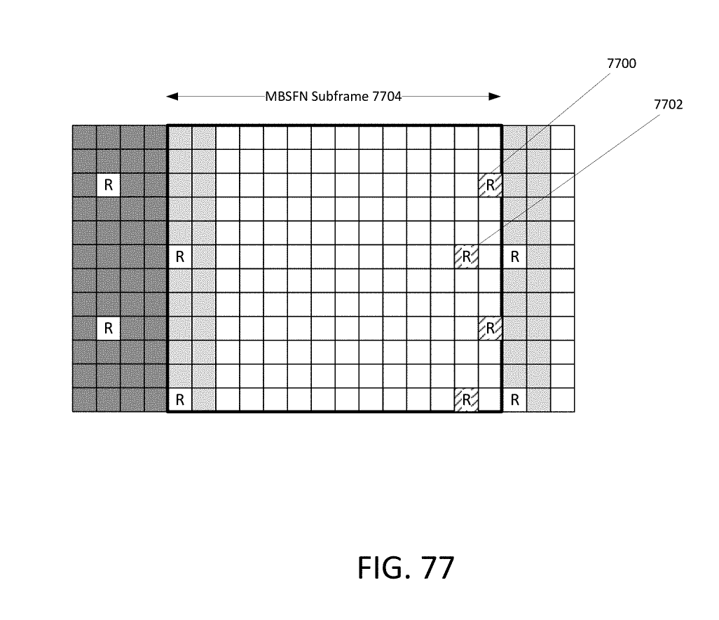

Interference may be avoided, for example, by having an LTE system transmit a reference signal at the end of an MBSFN subframe that may perceive a CCIP subframe. FIG. 77 depicts a reference signal that may be used to force Wi-Fi off a channel. Reference symbols may be transmitted near or at in the last few OFDM symbols of a MBSFN subframe. For example, as shown in FIG. 77, reference symbols 7700 and 7702 may be transmitted in MBSFN subframe 7704 to force Wi-Fi off a channel.

Transmission by the LTE system may be more effective in forcing Wi-Fi off the channel if the transmission may be made by a UE in the UL direction. The eNB may select a UE based on its location in order for the UE to transmit in the UL direction prior to the control channel in the CCIP subframe. The UE may be chosen based on its position. The eNB may schedule an UL SRS transmission by the UE on the subframe prior to the CCIP subframe.

Wi-Fi may operation using MBSFN or ABS based gaps. When an LTE system uses MBSFN or ABS sub-frames to create coexistence gaps, there may be the potential for interference between the coexisting LTE and Wi-Fi systems. The Wi-Fi system may perform a number of methods to improve the coexistence with LTE during the MBSFN and ABS sub-frames.

As described herein, during the first 2 OFDM symbols of a MBSFN sub-frame, an LTE system may interfere on Wi-Fi transmissions. This may occur, for example, due to the transmission of CRS (cell specific reference symbols), PHICH and PDCCH. A number of actions may be performed to mitigate the impact of CRS interference as the CRS may be transmitted at a higher power compared to PHICH and PDCCH. A number of actions may also be performed to mitigate the impact of Wi-Fi packet transmission on CRS.

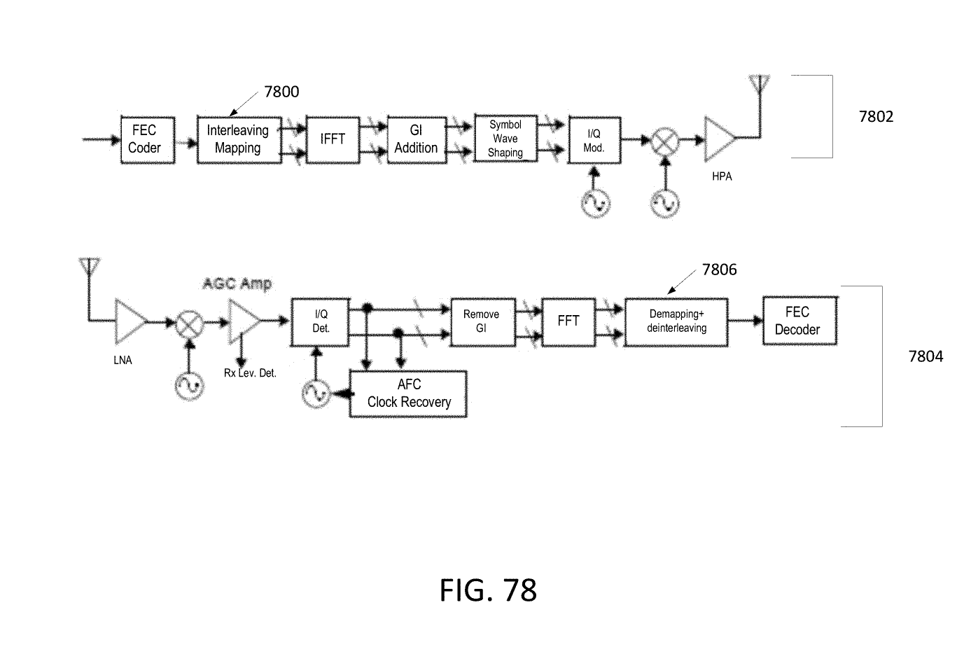

FIG. 78 depicts an example block diagram of a Wi-Fi OFDM physical (PHY) transceiver, such as transmitter 7802, and receiver, such as receiver 7804. Increasing the robustness to interference from the RS symbols may be similar to increasing the robustness to bursty interference. Interleaving and/or mapping entities, such as at 7800 and 7806, may be used to increasing robustness to interference.

For 802.11n, the OFDM symbol duration may be a function of the channel spacing, and the values may be 4.0 us, 8.0 us and 16.0 us for 20 MHz, 10 MHz and 5 MHz channel spacing, respectively. The OFDM symbol duration for the LTE system may be 71.4 us, which may include a guard period for a cyclic prefix. The transmission of LTE reference symbols over a LTE OFDM symbol may impact multiple Wi-Fi OFDM symbols. In 802.11a/g/n, the interleaving/mapping function may be performed for an OFDM symbol.

To reduce the impact of the CRS interference on Wi-Fi while maintaining the per OFDM symbol interleaving/mapping design of the Wi-Fi PHY, a interleaver/mapper (deinterleaver/demapper), such as 7800 or at 7806, may account for the location of a CRS symbols. For example, the first interleaver permutation may skip the subcarrier locations that may map to the location of the CRS symbols. The second (and third, if used) permutation of the interleaver may not be changed.

When a Wi-Fi system may be operating in the same band as an LTE system, it may transmit zero symbols at the frequency location that may be associated with the CRS symbols, which may avoid the interference of Wi-Fi on the LTE CRS.

An interleaver (or deinterleaver), such as at 7800 and/or 7806, may account for the location, such as in frequency domain, of the CRS, the Wi-Fi system may know the location of the CRS symbols. A number of scenarios may be possible depending on the coordination between the coexisting systems; for example if there may be coordination between LTE and Wi-Fi, or if there may not be coordination between LTE and Wi-Fi.

An interleaver/mapper may be provided for coordinated LTE and Wi-Fi. LTE and Wi-Fi systems may use a coordinated coexistence method, for example, by accessing a common coexistence database. This may, for example, allow the Wi-Fi system to request a location index for the CRS and/or an LTE coexistence scheme type, such as ABS, MBSFN, or the like. The location index may be a function of the Cell ID and may indicate a frequency range that may be occupied by the CRS.

If the LTE system may use an ABS or MBSFN based coexistence scheme, the Wi-Fi AP may use the signaled location index of the CRS of the LTE system and may configure the interleaver to skip the sub-carriers corresponding to the CRS location.

The interference from the LTE CRS may be mitigated by determining a configuration of the interleaver. This information may be signaled to one or more stations (STA) that may be associated to an AP to enable the STA to use the interleaver settings.

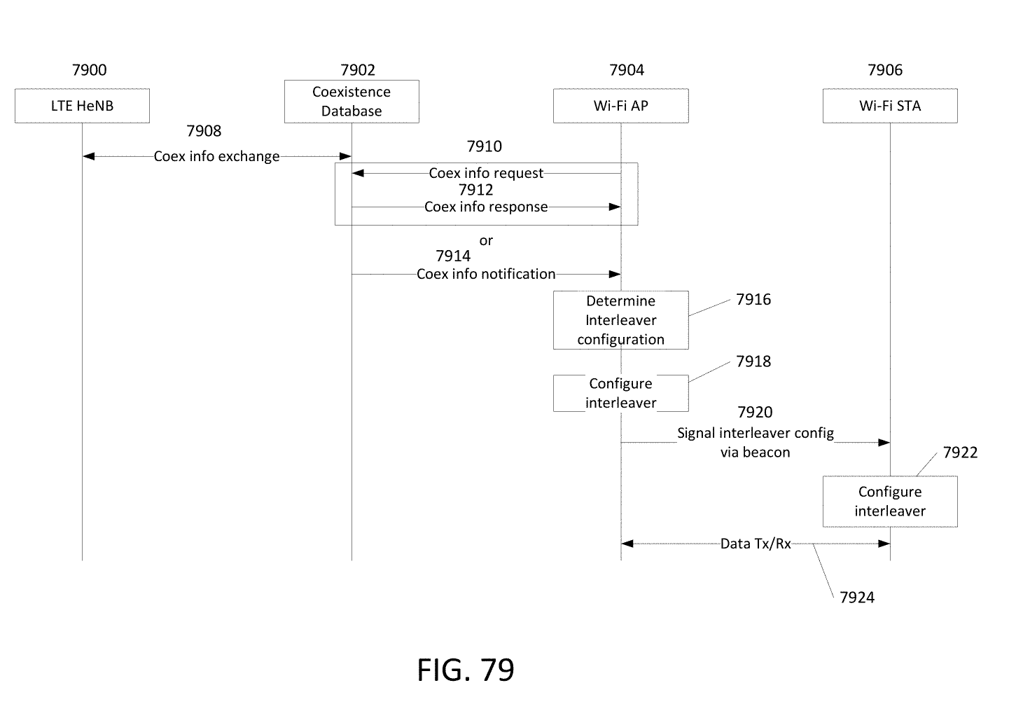

The AP may use a beacon transmission to send the interleaver configuration to an STA attached to the AP. FIG. 79 depicts an example flow diagram for interleave configuration.

At 7900, LTE HeNB may exchange coexistence information with coexistence database 7902. Information related to the location of the CRSs may be maintained by coexistence database 7902. When a Wi-Fi AP, such Wi-Fi AP 7904, may start operating on a channel, or when this information may change in the coexistence database, the Wi-Fi AP may retrieve the information. For example, Wi-Fi AP 7904 may retrieve the information example, through a Coex. info request/response at 7910 and 7912, or a Coex. info notification at 7914. The Coex.info notification at 7914 may be sent by coexistence database 7902. Wi-Fi AP 7904 may use this information to configure the interleaver and may send the configuration to one or more STAs it may communicate with via the beacon.

At 7910, Wi-Fi AP may determine an interleave configuration. At 7918, Wi-Fi AP 7904 may configure an interleaver. At 7920, Wi-Fi AP 7904 may signal an interleave configuration via a beacon to Wi-Fi STA 7906. At 7922, Wi-Fi STA 7906 may configuration an interleaver. At 7924, data may be transmitted and/or received between Wi-Fi STA 7906 and Wi-Fi AP 7904.

Although a coexistence database may be used in FIG. 79 to store coexistence information, the coexistence information may be maintained by and exchanged with a coexistence entity or coexistence manager that may be an information server.

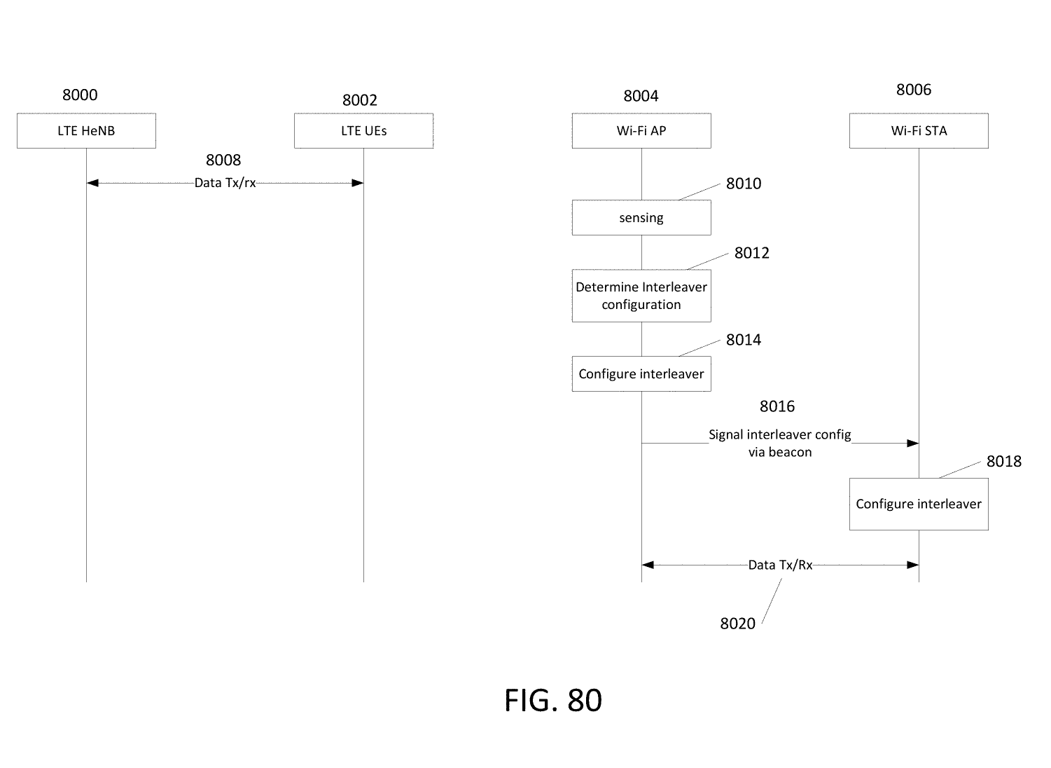

FIG. 80 depicts another example flow diagram for interleaver configurations. An interleaver/mapper may be provided for non-coordinated LTE and Wi-Fi.

If no coordination between the LTE and Wi-Fi system exists, the Wi-Fi may determine the location of the CRS in order to configure the interleaver. Sensing may be used to determine the location of the CRS. If the CRS location may not be determined by the AP, the a default interleaver may be used. The interleaver configuration may signaled to the STA using the beacon.

If the CRS location cannot be determined by the AP, an the interleaver may be configured for frequency hopping. For example, the interleaver may be configured to hop between the possible locations of the CRS. During a hop, the packet ACK/NACK rate may be measured. Hopping may continue if the configurations may result in comparable ACK/NACK rates, or the interleaver may be configured for the pattern that results in a low error rate.

As shown in FIG. 80, LTE HeNB 8000 and LTE UEs 8002 may transmit and/or receive data at 8008. There may not be communication between the LTE and Wi-Fi systems. Wi-Fi AP 8004 may performing sensing at 8010 to, for example, determine a location of a CRS, which may belong to the LTE system. At 8012, Wi-Fi AP 8004 may determine an interleaver configuration. At 8014, an interleaver may be configured. At 8016, Wi-Fi AP 8004 may signal an interleaver configuration via a beacon to Wi-Fi STA 8006. At 8018, Wi-Fi STA may configure an interleaver. At 8020, data may be transmitted and/or received between Wi-Fi AP 8004 and Wi-Fi STA 8006.

Transmissions may be scheduled in a dynamic shared spectrum band using a coexistence gap between uplink and downlink subframes of a time division duplexing (TDD) communication link. The coexistence gap may be reserved for transmissions by other devices or other networks in the same frequency band and/or transmissions by another radio access technology. For example, the coexistence gap may be reserved for transmissions by a WiFi-based device. A coexistence gap schedule may be dynamically adjusted in frames having uplink and downlink subframes. For example, the coexistence gap schedule may be dynamically adjusted in an LTE-based frame having uplink and downlink subframes while an uplink/downlink switchpoint may be adjusted in the LTE-based frame.

An eNode B may reserve the coexistence gap by scheduling in the uplink of the communications link a contiguous gap in transmission. The coexistence gap may include one or more blank subframes, or one or more almost blank subframes of an LTE-based frame. The coexistence gap may be scheduled between a first and second guard periods of subframes of the LTE-based frame. This may include, for example, scheduling the coexistence gap as a duration between the first and second guard periods, or scheduling the coexistence gap to begin after a downlink pilot timeslot (DwPTS) of a first special frame and to end before an uplink pilot timeslot (UpPTS) of a second special frame.

A plurality of frames may include coexistence gaps such that a LTE-based frame may be a coexistence frame that may include a coexistence gap, a non-coexistence frame that may not include a coexistence gap, or the like. During a coexistence gap, no data, control, or reference symbols may be transmitted.

A coexistence pattern may be established from a composite of the coexistence frames and the non-coexistence frames. The coexistence pattern may be set over a group of LTE-based frames to achieve a duty cycle for the coexistence gaps. A wireless transmit/receive unit (WTRU) may receive duty cycle information via a network access point. A duration of the coexistence gap may be scheduled between the uplink subframes and the downlink subframes based on the received duty cycle information.

Receiving of the duty cycle information may include receiving the duty cycle information using a Media Access Control (MAC) Control Element (CE) that may indicate the duration of the coexistence gap. Receiving of the duty cycle information may include receiving subframe type information including a type of subframes of an LTE-based frame that may be associated with the co-existence gap.

The scheduling of transmissions may include scheduling long term evolution-based (LTE-based) transmissions by a wireless transmit/receive unit (WTRU), a network access point, an eNodeB, or the like. Scheduling of the transmissions may include determining, for one or more frames, a position of the coexistence gap in an LTE-based frame. Scheduling of the transmissions may include scheduling LTE-based transmissions during one of the uplink subframes of an LTE-based frame; the downlink subframes of the LTE-based frame, exclusive of scheduling any transmissions during the coexistence gap; or the like.

Reception of LTE-based transmissions may be scheduled during the remaining one of the uplink subframes of the LTE-based frame, or the downlink subframes of the LTE-based frame, exclusive of scheduling any transmissions during the coexistence gap. The scheduling of a coexistence gap may coincide with a guard period of a subframe.

The coexistence gap may be included at a transition portion between the downlink subframes and the uplink subframes of the LTE-based frame. A duration of the LTE-based frame may be a period of 10 ms, a variable duration based on a duration of the coexistence gap of the LTE-based frame, or the like.

The downlink subframes and the uplink subframes may be scheduled asymmetrically such that a number of downlink subframe in the LTE-based frame may not be equal to a number of uplink subframes in the LTE-based frame. The coexistence gap may be scheduled to span at least one portion of a plurality of consecutive LTE-based frames. An expanded duration LTE-based guard period may be scheduled as the coexistence gap of the LTE-based frame while a duration of the LTE-based frame may be maintained. A portion or all of the subframes of the LTE-based frame may be scheduled as the coexistence gap such that transmissions may not occur during the scheduled portion or all of the subframes.

The Coexistence gap may be spread over different sets of subframes, which may be responsive to a change in an uplink/downlink configuration. A WTRU may receive a duration indication associated with an LTE-based frame and the scheduling of transmissions may be based on the received duration indication associated with the LTE-based frame.

An eNodeB may set a duration indication that may be associated with an LTE-based frame based on an amount of WiFi traffic associated with the LTE-based frame. The eNodeB may sent the duration indicate to a WTRU. The scheduling of the transmissions may be based on the sent duration indication associated with the LTE-based frame. Setting of the duration indication may include selecting, by the eNodeB, a duration of the co-existence gap such that a sum of durations of a downlink pilot timeslot (DwPTS), an uplink pilot timeslot (UpPTS), and the coexistence gap may be equal to a duration of N subframes. Sending of the duration indication may sending the duration indication associated with the duration of the coexistence gap using a Physical Downlink Control Channel (PDCCH) and/or the DwPTS prior to a start of the co-existence gap.

A method of managing transmissions associated with different radio access technology (RAT) communication devices may be provided. A WiFi-based communication device may sense a channel to be unused, if a distributed inter-frame space (DIFS) sensing period of a WiFi RAT may coincide with a coexistence gap of an LTE RAT. The WiFi-based communication device may transmit on the unused channel at least during the coexistence gap.

A method for scheduling transmissions of a time division duplexing (TDD) communication link may be provided. A coexistence gap may be scheduled between uplink and downlink subframes of LTE-based frames for the TDD communication link. The LTE-based frames may include Nth frames in a series of LTE-based frames.

A method for managing transmissions of different networks with overlapping coverage may be provided. Transmissions may be scheduled using a coexistence gap between uplink and downlink subframes of a time division duplexing (TDD) communications link.

A method for using a shared channel in a dynamic shared spectrum may be provided. A coexistence pattern may be determined. The coexistence pattern may include a coexistence gap that may enable a first radio access technology (RAT) and a second RAT to operate in a channel of a dynamic shared spectrum. The first RAT may not be a carrier sense multiple access (non-CSMA) system and the second RAT may be a carrier sense multiple access (CSMA) system. For example, the first RAT may be a long-term evolution (LTE) system and the second RAT is a Wi-Fi system. The coexistence gap may provide an opportunity for the second RAT to use the channel without interference from the first RAT. The coexistence pattern may include an ON period associated with the first RAT.

A signal may be sent in the channel via the first RAT based on the coexistence pattern. For example, a signal may be transmitted during the ON period. As another example, a signal may be sent by performing per cell discontinuous transmission using the coexistence pattern.

The first RAT may be silenced based on the coexistence pattern to allow the second RAT to gain access to the channel. For example, the first RAT may be silenced during the coexistence gap. As another example, a non-CSMA system may be silenced during the coexistence gap to allow a CSMA system to gain access to the channel. Silencing the first RAT based on the coexistence pattern may provide time division multiplexing for the first RAT and the second RAT, wherein the second RAT may not be aware of the coexistence gap.

Determining a coexistence pattern may include determining a period of the coexistence pattern, determining a duty cycle for the coexistence pattern, and/or determining an ON period and the coexistence gap using the period of the coexistence pattern and the duty cycle for the coexistence pattern.

A method for using a shared channel in a dynamic shared spectrum may be provided. It may be determined whether a channel may be available during a coexistence gap. This may be done, for example, by sending whether the first RAT may be transmitting on the channel. The coexistence gap may enables a first radio access technology (RAT) and a second RAT to operate in a channel of a dynamic shared spectrum. A packet duration to minimize interference to the first RAT may be determined. A packet based on the packet duration may be sent in the channel using the second RAT when the channel may available. For example, a packet may be sent in the channel using the determined packet duration.

A method for adjusting a coexistence pattern may be provided. A traffic load in a channel of a dynamic shared spectrum band for a first radio access technology (RAT) may be determined. An operational mode indicating whether the second RAT is operating on the channel may be determined. A coexistence gap pattern that may enable the first RAT and a second RAT to operate in the channel of a dynamic shared spectrum band may be determined. A duty cycle for the coexistence gap pattern may be set using at least one of the traffic load, the operational mode, or the coexistence gap.

The duty cycle may be set to a percentage when the operational mode indicates that the second RAT may be operating on the channel and the traffic load may be high. The duty cycle may be set to a maximum when the operational mode indicates that the second RAT may not be operating on the channel and the traffic load may be high. The duty cycle may be set to a maximum when the operational mode indicates that the second RAT may be operating non-cooperatively on the channel or the traffic load may be high. The duty cycle may be set to a minimum when the traffic load may not be high. The duty cycle may be set to a percentage when the traffic load may not be high.

A method for using a shared channel in a dynamic shared spectrum may be provided. A coexistence pattern may be determined. The coexistence pattern may include a coexistence gap that enables a first RAT and a second RAT to operate in a channel of a dynamic shared spectrum band may be determined. The first RAT may be a non-CSMA system and the second RAT may be CSMA system.

The coexistence pattern may be sent to a wireless transmit/receive unit (WTRU). A signal may be sent in the channel via the first RAT during a time period outside of the coexistence gap. The coexistence pattern may enable the WTRU to enter a discontinuous reception period to save power during the coexistence gap. The coexistence pattern may enable the WTRU to avoid performing channel estimation on a cell specific reference (CRS) location during the coexistence gap. The coexistence pattern may enable the WTRU to defer transmission in the channel using the second RAT outside of the coexistence gap.

A method for using a shared channel in a dynamic shared spectrum may be provided. A time-division duplex uplink/downlink (TDD UL/DL) configuration may be selected. One or more multicast/broadcast single frequency network (MBSFN) subframes may be determined from downlink (DL) subframes of the TDD UL/DL configuration. One or more non-scheduled uplink (UL) subframes may be determined from the uplink (UL) subframes of the TDD UL/DL configuration.

A coexistence gap may be generated using the one or more non-scheduled UL subframes and the MBSFN subframes. The coexistence gap may enable a first radio access technology (RAT) and a second (RAT) to coexist in a channel of a dynamic shared spectrum. The coexistence gap may be generated by determining a number of gap subframes needed to generate the coexistence gap for the duty cycle, selecting the gap subframes from the one or more non-scheduled UL subframes and MBSFN subframes, and/or generating the coexistence gap using the selected number of gap subframes.

The coexistence gap may be sent to a WTRU. A duty cycle may be determined based on the traffic of the first RAT and the second RAT. The duty cycle may be sent to the WTRU to notify the WTRU of the coexistence gap.

A wireless transmit/receive unit (WTRU) for sharing a channel in a dynamic shared spectrum band may be provided. The WTRU may include a processor that may be configured to receive a coexistence pattern, the coexistence pattern may include a coexistence gap that enables a first radio access technology (RAT) a second RAT to operate in a channel of a dynamic shared spectrum band, and send a signal in the channel via the first RAT based on the coexistence pattern.

The processor may silence the first RAT based on the coexistence pattern to allow the second RAT to gain access to the channel. This may occur, for example, during the coexistence gap. The coexistence gap may provide an opportunity for the second RAT to use the channel without interference from the first RAT. The processor may be configured to send a signal in the channel via the first RAT based on the coexistence pattern by transmitting the signal during the ON period.

An access point for using a shared channel in a dynamic shared spectrum may be provided. The access point may include a processor that may be configured to determine whether a channel may be available during a coexistence gap that enables a first radio access technology (RAT) and a second RAT to operate in a channel of a dynamic shared spectrum. The processor may be configured to determine a packet duration to minimize interference to the first RAT. The processor may be configured to send a packet based on the packet duration in the channel using the second RAT when the channel is available. The processor may be configured to determine whether the channel is available during the coexistence gap by sensing whether the first RAT is transmitting on the channel. The processor may be configured to send a packet in the channel using the second RAT when the channel is available by sending a packet in the channel using the determined packet duration.

An enhanced node-B (eNode-B) for adjusting a coexistence pattern may be provided. The eNode-B may include a processor. The eNode-B may determine traffic load in a channel of a dynamic shared spectrum band for a first radio access technology (RAT). The eNode-B may determine an operational mode indicating whether the second RAT is operating on the channel. The eNode-B may determine a coexistence gap pattern that enables the first RAT and a second RAT to operate in the channel of a dynamic shared spectrum band. The eNode-B may set a duty cycle for the coexistence gap pattern using at least one of the traffic load, the operational mode, or the coexistence gap.

A WTRU may be provided for using a shared channel in a dynamic shared. The WTRU may include a processor that may be configured to receive a coexistence pattern. The coexistence pattern may include a coexistence gap that may enable a first RAT and a second RAT to operate in a channel of a dynamic shared spectrum band. The processor may be configured to send a signal in the channel via the first RAT during a time period outside of the coexistence gap. The WTRU may enter a discontinuous reception period to save power during the coexistence gap. The WTRU may avoid performing channel estimation on a cell specific reference (CRS) location during the coexistence gap.

A WTRU for using a shared channel in a dynamic shared spectrum may be provided. The WTRU may include a processor. The processor may be configured to receive a duty cycle, and select a time-division duplex uplink/downlink (TDD UL/DL) configuration using the duty cycle. The processor may be configured to determine one or more multicast/broadcast single frequency network (MBSFN) subframes from downlink (DL) subframes of the TDD UL/DL configuration, and determine one or more non-scheduled uplink (UL) subframes from the uplink (UL) subframes of the TDD UL/DL configuration. The processor may be configured to determine a coexistence gap using the one or more non-scheduled UL subframes and the MBSFN subframes that may enable a first RAT and a second RAT to coexist in a channel of a dynamic shared spectrum.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1.-54. (canceled)

55. An eNodeB for using a shared spectrum, the eNodeB comprising:
a memory; and;
a processor, the processor configured to:
determine an ON/OFF time pattern for a secondary cell (SCell), the ON/OFF time pattern comprising an SCell OFF-state to ensure a first radio access technology (RAT) and a second RAT can coexist within the SCell; and
send a signal, via the SCell, to a wireless transmit/receive unit (WTRU) using the ON/OFF time pattern for the SCell.

56. The eNodeB of claim 55, wherein the signal is a discovery signal.

57. The eNodeB of claim 55, wherein the processor is further configured to sense that the second RAT is being used within the SCell.

58. The eNodeB of claim 55, wherein the signal includes a master information broadcast (MIB).

59. The eNodeB of claim 55, wherein the processor is further configured to prevent a transmission using the first RAT during the Scell OFF-state.

60. The eNodeB of claim 55, wherein the ON/OFF time pattern for the SCell further comprises a SCell ON-state.

61. The eNodeB of claim 60, wherein the processor is configured to send the signal to the WTRU using the ON/OFF time pattern for the SCell by sending the signal during the SCell ON-state.

62. The eNodeB of claim 55, wherein the processor is further configured to determine whether data is to be sent to the WTRU via the first RAT.

63. The eNodeB of claim 55, where in the processor is further configured to send the ON/OFF time pattern for the SCell to the WTRU.

64. An eNodeB for using a first radio access technology (RAT) in a channel of a shared spectrum, the eNodeB comprising:
a memory; and
a processor, the processor configured to:
determine that a second RAT is being used within a cell;
determine an ON/OFF time pattern for a cell, the ON/OFF time pattern comprising an OFF-state to ensure the first RAT and the second RAT can coexist within the cell; and
send a signal to a wireless transmit/receive unit (WTRU) via the first RAT using the ON/OFF time pattern for the cell.

65. The eNodeB of claim 64, wherein the processor is further configured to send the ON/OFF time pattern to the WTRU.

66. The eNodeB of claim 64, wherein the signal is a first signal, and the processor is further configured to determine that the first RAT is being used within the cell by sensing that a second signal was sent in the channel of the shared spectrum via the first RAT.

67. The eNodeB of claim 64, wherein the first RAT is Wi-Fi and the second RAT is long-term evolution (LTE).

68. The eNodeB of claim 64, wherein the signal is a discovery signal.

69. The eNodeB of claim 64, wherein the signal includes a master information broadcast (MIB).

70. A wireless transmit/receive unit (WTRU) for using a channel in a shared spectrum, the WTRU comprising:
a memory, and;
a processor, the processor configured to:
determine an ON/OFF time pattern for the secondary cell (SCell), the ON/OFF time pattern comprising an SCell OFF-state to ensure a first radio access technology (RAT) and a second RAT can coexist within the SCell;
receive a signal, via the SCell, from an eNodeB using the ON/OFF time pattern for the SCell.

71. The WTRU of claim 70, wherein the signal is a discovery signal.

72. The WTRU of claim 70, wherein the signal includes a master information broadcast (MIB).

73. The WTRU of claim 70, wherein the processor is configured to prevent a transmission using the first RAT during the Scell OFF-state.

74. The WTRU of claim 70, wherein the ON/OFF time pattern for the SCell further comprises a SCell ON-state.
